(19) United States
(12) Patent Application Publication
(10) Pub. No.: US 2004/0233303 A1
(43) Pub. Date: Nov. 25, 2004

(54) Electronic camera

(75) Inventors: Tsuyoshi Okutani, Tokyo (JP); Masahiro Shirono, Sagamihara-shi (JP)

Correspondence Address: SCHULTE ROTH & ZABEL LLP, ATTN: JOEL E. LUTZKER, 919 THIRD AVENUE, NEW YORK, NY, 10022, US

(73) Assignee: Kyocera Corporation, Kyoto-shi (JP)

(21) Appl. No.: 10/786,754

(22) Filed: Feb. 25, 2004

(30) Foreign Application Priority Data
Feb. 25, 2003 (JP) 2003-047012
Mar. 18, 2003 (JP) 2003-073211
Jun. 26, 2003 (JP) 2003-183632
Jun. 26, 2003 (JP) 2003-183623
Jun. 30, 2003 (JP) 2003-187038
Jun. 30, 2003 (JP) 2003-186884
Jun. 30, 2003 (JP) 2003-187205
Jun. 30, 2003 (JP) 2003-187392

(51) Int. Cl. H04N 5/262

(52) U.S. Cl. 348/240.3

(57) ABSTRACT

In order to offer an electronic camera having such a strength and a thickness as capable of shoving in a breast pocket of a dress shirt or in a hip pocket of jeans and such a lightness as make one no sense of discomfort when it is put in these places or a handbag, and yet having a zoom mechanism of high magnification, an electronic camera is made thin by defining an outer diameter of the lens to a thickness of the display unit disposed on the operation unit, a memory, a battery and a control circuit board, supporting a casing on a lens frame through which a guide shaft is pierced so as to move the lens back and forth, and disposing a cam for moving the zoom lens at the side of a lens system.

### BACKGROUND OF THE INVENTION

1. Field of the Invention

The present invention relates to an electronic camera, particularly to a thin and light electronic camera capable of mounting an optical zoom having high magnification. Further, the present invention relates to an optical zoom mechanism and camera having a power mechanism such as a cam or a lead screw which moves an optical system for zooming and an optical zoom mechanism having a rate reducing device provided to an interlocking system for a motor which drives the power mechanism. The present invention relates to a cam apparatus which converts a rotational motion to a linear motion through a cam groove and to a camera zooming by moving an optical system using the cam apparatus. Further, the present invention relates to an image capturing apparatus provided to an optical instrument such as an electronic camera and to a camera.

2. Description of the Related Art

An electronic camera having an image capturing element such as a CCD and recording an image in digital form does not require to develop or to print like a conventional camera using a photographic film. A captured image can be seen instantly with this type of camera. In addition, an image capturing element such as CCD is smaller than a conventional photographic film, despite a number of pixels for an element increases year after year whereby a camera body itself can be advantageously made smaller.

Therefore, a camera having such a strength and a thickness as capable of shoving in a breast pocket of a dress shirt or in a hip pocket of jeans and such a lightness as make one no sense of discomfort when it is put in these places or a handbag, and yet having a zoom mechanism of high magnification is desired to appeal.

However, a type of camera wherein a photographic lens is protruded from a camera main body such as a camera, in which a conventional photographic film is used, is difficult to define a thickness of the camera thinner than a definite thickness because of a zooming mechanism and a thickness of a lens, even if a sinking barrel type is adopted, wherein lenses are placed in a main body except when photographing operation.

The zoom lens is made so as to vary a focus of a whole lens by moving along a direction of an optical axis a lens group or lens groups more than one of a plurality of lens groups disposed on a same optical axis. As a technique for controlling the movement of the lens group when zooming, it is popularly practiced that a cam plate which engages the moving lens group is provided and the lens group is moved while more than two lens groups are correlated as lens groups are moved in dependence upon a shape of a cam by rotating the cam plate with a hand or a motor.

As a conventional cam mechanism of this type, a cylinder shaped cam, hereinafter referred to as a ring cam, is coaxially provided around an outer periphery of a lens barrel and a lens group is moved by rotating the cam ring around the axis as the lens group is engaged with the cam ring. Besides a zooming technique by a cam mechanism, there is another technique in which a lead screw is provided along the optical axis of a lens barrel and a lens group engaged with the lead screw is moved along the optical axis by rotating the lead screw around the axis.

Accordingly, as mentioned above, in case a lens is disposed in front of a camera main body and a cam ring is provided around an outer periphery of a lens barrel, even if a protruded portion is avoided by sinking all the lenses into the camera main body when the power is off, a thickness of a camera can not be made thinner than a height of the cam ring or a total thickness of an added thickness of all plural lenses in a lens group along the optical axis. Further, since a zoom lens uses plural groups of lenses, more necessary lenses increase as magnification becomes higher so that a total thickness of these lenses makes a thickness of camera main body along the optical axis considerably thick, which results in difficulty of making the camera thin.

When the cam ring is disposed around the outer periphery of the lens barrel, a length in diameter direction of the lens becomes large, which results in enlarging the whole apparatus so that an obstacle to designing a thin camera arises. However, a camera withheld from thickening owing to high magnification of a camera appears. For example, in a camera of sinking barrel type in which a plurality of lens groups are placed in the camera body, a structure of the camera is such that when protruded lens groups is stored by switching off the main power source, a lens group A of a middle portion among a plurality of lens groups which move within the limits of the optical axis is transferred beyond the limits of the optical axis to be stored in the camera main body and a lens group of an object side is stored in the camera main body within the limits of the optical axis. Thus, a thickness along the direction of the optical axis can be reduced thin by transferring the lens group A of a middle portion beyond the limits of the optical axis.

However, since a lens group of a camera in which a lens group A of a middle portion is transferred beyond the limits of the optical axis is transferred beyond the limits of the optical axis, a structure for ensuring an accuracy of the optical system becomes complicated and a number of parts increases for transferring a lens group beyond the limits of the optical axis, which leads to additional cost. In a type of camera in which a middle lens group or a lens barrel is sunk into a camera main body by putting the power source off, a photo opportunity is lost because a definite time is necessary until the camera is ready to take a photograph for protruding a group of lenses when a main power source is on.

In a camera in which a lead screw is disposed along an optical axis of a lens barrel, it is possible to make the camera smaller since a space in the vicinity of the lens barrel decreases by reducing parts such as a cam ring as compared to a camera using a cam mechanism.

However, a camera of this type is usually provided with a plurality of lens groups in a direction parallel to a display unit which display a photographic image and with a reflecting board or a prism for converting the direction of the optical axis at an angle of 90 degrees between a lens and a lens behind a first lens at a side of an object, whereby an object is photographed in a direction orthogonal to the display panel of the display unit, so that a number of parts is reduced to attain downsizing. On the other hand, new parts such as the reflecting board or the prism increase and the structure becomes complicated, which leads to a weight increase and cost increase of the camera, so that the camera can not be made so remarkably thinner or smaller as compared to a camera with a cam mechanism.

In order to solve such problems accompanied by making a camera thin and high magnification, an art described in Japanese patent publication No. 2931907 is proposed. According to the proposed art, an image capturing unit containing a photographic lens and an image capturing element, and a camera main body provided with a display unit such as LCD are mounted rotatably whereby the image capturing unit is rotated in a direction of photographing with respect to the camera main body at a time of photographing and the image capturing unit is stored in the camera main body at a time of non photographing by rotation. Thus, by rotating the image capturing unit with respect to the camera main body, the image capturing unit can be stored in a direction parallel to the display unit so that a thickness of in a direction orthogonal to the display unit of the camera main body can be made thin.

Though there is no description concerning a zoom mechanism in such a thin body type camera, Japanese laid open patent publication No. JP1992-158632 (FIG. 2) or Japanese laid open patent publication No. JP1995-23259 (FIG. 2), for example, discloses that a whole length of an optical system is stored in a camera as a direction of an optical axis of the optical system is coincided with a longitudinal direction or a lateral direction of the camera main body. That is, in a camera disclosed on Japanese laid-open patent publication No. JP1992-158632, a photographic window is disposed on a down side face of a camera main body in which an openable upper lid is provided to a display unit like a type of a pocket book, an incident light from the photographic window is reflected with a reflecting mirror provided at an angle of 45 degrees to enter into a lens system whose optical system is arranged in a longitudinal direction or a lateral direction of the camera main body and further the light is entered into an image capturing element disposed on a side of the photographic window by reflecting with a reflecting mirror disposed at an angle of 45 degrees. In a camera disclosed on Japanese laid-open patent publication No. JP1995-23259, a display unit is disposed on one face of a pocket book type main body and a photographic lens is provided in a main body in which a photographic window is disposed in a direction of the thickness as an optical axis is defined in a direction parallel to a longitudinal direction of the main body.

However, as a camera disclosed on Japanese laid-open patent publication No. JP1992-158632 has a display unit on the backside of a photographic window for a photographic optical system; the display unit is visible when the photographic system is targeted to an object at an eye-level. Nevertheless, when a photographer wants to photograph him/herself, an object near land surface or over heads of a lot of people, he/she needs to guess a photographing range. Further, as a camera disclosed on Japanese laid-open patent publication No. JP1995-23259 has a display unit whose plane coincides with a direction of the optical axis of the photographic optical system, it is convenient when the camera is targeted to an object under or upper than eye-level but it is difficult to confirm a photographing range with the display unit.

Many recent cameras have a viewfinder having a zooming function or a flash unit besides a zooming function of a photographic lens. Zooming is performed by moving a zoom lens with a power mechanism with a motor-driven cam or lead screw.

For example, as a zooming structure of a photographic lens, a cylindrical cam for zooming is disposed at a lateral position of a photographic lens and a cam pin of the photographic lens is inserted into a cam groove of the cam for zooming so as to drive in conjunction therewith.

Further, a zoom motor is disposed forward or backward to the cam for zooming and rate reducing device is dispose between the motor and the cam so as to reduce a motor out put with the rate reducing device, transfer to the cam and rotate the cam.

The rate reducing device has a lot of rate reducing gears besides a first rate reducing gear which engages a motor pinion. A last rate reducing gear engages a gear provided to the came for zooming.

Various kinds of cam apparatuses are used for such zooming function (see Japanese laid-open patent publication No. JP2002-72043).

FIG. 45 is a perspective illustration of a driving mechanism for zooming 10. Though the drawing shows a first lens group 11 and a second lens group 12, the driving mechanism has a third lens group besides them and zooming is actually performed with the first, third lens groups.

The driving mechanism for zooming 10 has a boss (a bearing portion) 11b provided at a lens frame 11a of the first lens group 11 and a guide shaft 13 pierced to a boss 12b (a bearing portion) provided at a lens frame 12a of the second lens group 12 so as to move the first and the second lens group 11, 12 as sliding through the guide shaft 13.

Each of lens frames 11a, 12a has a hole portion (unshown) at the position opposite to boss 11b or 12b, through which the slide shaft 14 is pierced whereby the first and the second lens group 11,12 is prevented to rotate. The above mentioned guide shaft 13 and the slide shaft 14 fixed so that one end is fixed to a front fixing frame 15 and another end is fixed to a rear fixing frame 16.

Meanwhile, the above mentioned boss 11b has a protruded cam pin (a cam groove inserting member) 1c and boss 12b a protruded cam pin (a cam groove inserting member) 12c, which are contacted while pressing to a first cam plane 17a and a second cam plane 17b respectively.

The pressing function of the cam pin 11c or 12c is derived from a tensile force of a coil spring 18 which is fastened to tighten between a lens frame 11a and 12a. That is, the coil spring 18 is a spring for tensile force, one end of which is fixed to the lens frame Ha, another end of which to the lens frame 12a and gives a spring force in a direction for approaching these lens frames 11a and 12a each other whereby the cam pin 11c and the cam pin 12c press the first cam plane and the second cam plane respectively.

The cam for zooming 17 is rotated through a rate reducing device by a motor 19 and the cam pin 11c, 12c are driven along the first and second cam plane 17a, 17b whereby the first lens group and the second lens group move along a direction of the optical axis for zooming.

A camera which zooms a viewfinder optical system using the above mentioned cam for zooming 17 is already publicly known (see Japanese laid open patent publication JP1998-161194).

FIG. 46 shows a driving mechanism for zooming 110 provided with a cam for zooming 111 having a first cam groove 111a and a second cam groove 111b. In the driving mechanism for zooming, the cam pin 11c of the first lens group 11 and the cam pin 12c of the second lens group 12 are plunged in to the first cam groove 111a and the second cam groove 111b respectively.

Thus, as the cam pins 11c, 12c are driven in concordance with rotation of the cam for zooming 111, zooming is performed by moving the first lens group 11 and the second lens group 12 along a direction of the optical axis. Other structure of the driving mechanism for zooming 110 is the same as that of a driving mechanism for zooming 10 shown in FIG. 45.

A camera having zooming function is provided with a lens barrel which is advanced and retreated corresponding to zooming, whereby a focus of photographic lens varies, as is widely known (see Japanese laid-open patent publication JP2002-72043).

More particularly, a lens barrel comprises a moving frame which holds a zoom lens, a cam frame and a fixed frame combined altogether, wherein the moving frame is advanced and retreated along the optical axis by driving a cam pin provided on the moving frame with a cam groove of the cam frame. The cam frame, which is rotated, has an interlocking gear mechanism and a motor in a portion of the lens barrel as a driving unit.

A so called electronic camera in which an image capturing element is disposed at an image focus position of a photographic lens and photographic data generated by the image capturing element are stored in a memory is widely known. The electronic camera of this type has an image capturing element attached to the fixed frame of the lens barrel (see Japanese laid open patent publication JP1990-71678).

More particularly, a standard plane is formed on a fixed frame portion which is around the image focus portion of the photographic lens. And the image capturing element is fixed to a metallic plate with adhesive.

The metallic plate has a flange portion projecting from both sides of the image capturing element. The flange portion is superposed on the standard plane and fixed with screws on the fixed frame. In many electronic cameras, an image capturing element is fixed with the above mentioned configuration to a lens barrel.

### SUMMARY OF THE INVENTION

One of the objects of the present invention is to make an image capturing apparatus such as electronic camera thinner.

In order to attain the above object, according to the present invention, in an electronic camera comprising an operation unit having a display unit and an image capturing unit provided with a flash unit and a photographic zoom lens, the image capturing unit connected rotatably by a hinge mechanism and transmitting an image signal to the display unit, an image capturing apparatus is characterized in that an outer diameter of the lens is defined to a thickness of the display unit disposed on the operation unit, a memory, a battery and a control circuit board, a casing is supported on a lens frame through which a guide shaft is pierced so as to move the lens back and forth as well as a cam for moving the zoom lens is disposed at the side of a lens system so that camera is made thinner.

According to the present invention, An optical zoom mechanism comprises a zoom lens, a holding frame which holds the zoom lens, a rotational axis rod having gears at the both end thereof, a first group of rate reducing gears which engage the gear at one end of the rotational axis rod, a second group of rate reducing gears which engage the gear at another end of the rotational axis rod, a motor which drives the second group of rate reducing gear and a cam body driven by the first rate reducing gears whereby zooming is performed by moving the holding frame with the cam body.

Further according to the present invention, in a cam apparatus having a spiral cam grooves for moving an object with a cam driving force which is generated by cam driving a cam groove inserting member inserted in the cam groove, a cam apparatus comprises one cam body having one cam plane of a cam groove, another cam body having another cam plane confronting said one cam plane, which is provided non-rotatably to the cam body so as to be able to slide, and a forcing device contacting a cam groove inserting member by pressing one cam body and/or another cam body.

Yet further according to the present invention, in a cam apparatus having first and second spiral cam grooves for moving an object with a cam driving force which is generated by cam driving a cam groove inserting member inserted in each cam groove, a cam apparatus comprises a cam base body in which sliding portions having a smaller diameter than that of a middle portion of a cylinder are formed at both ends of the cylinder, an approximately vertical plane of a stepped portion between one sliding portion and the middle portion of the cylinder is defined as one cam plane of the first cam groove and an approximately vertical plane of a stepped portion between the other sliding portion and the middle portion of the cylinder is defined as one cam plane of the second cam groove; a first cam frame having another cam plane confronting the one cam plane of the first cam groove and provided non-rotatably so as to be able to slide on one sliding portion; a second cam frame having another cam plane confronting the one cam plane of the second cam groove and provided on the other sliding portion non-rotatably so as to be able to slide; and a forcing device which contacts a cam groove inserting member which is inserted to the cam groove formed by the first and the second cam frames and the cam base body on to the cam plane by pressing the first and the second cam frames.

### BRIEF DESCRIPTION OF THE DRAWINGS

FIG. 1 is an over all view of an electronic camera in one embodiment of the present invention.

FIG. 2 is a perspective illustration of an electronic camera in one embodiment of the present invention, which shows a photographing state in case a lens is targeted to an object.

FIG. 3 is a perspective illustration of an electronic camera in one embodiment of the present invention, which shows a photographing state in case a lens is targeted to a photographer, him or herself.

FIG. 4 is an illustration of an electronic camera in one embodiment of the present invention, which shows a held state in case a lens is targeted to an object.

FIG. 5 is a perspective illustration in one embodiment of the present invention, which shows a mounted state of inner devices in an operation unit 102, whose cover is opened, of an electronic camera 100 and image capturing devices such as a flash unit, condenser and CCD in an image capturing unit 101.

FIG. 6 is perspective illustrations in one embodiment of the present invention of an electronic camera 100, which shows a view of the uncovered state without a display unit 105 (A) of an operation unit 102 and a backside view (B) of an operation unit 102.

FIG. 7 is drawings in one embodiment of the present invention, which shows an elevational view of the uncovered state from front side in FIG. 5 without a display unit 105 (A), an elevational view from left side in FIG. 5(B) and a sectional view from left side in FIG. 5 of an operation unit 102 of an electronic camera 100.

FIG. 8 is a perspective illustration in one embodiment of the present invention of an electronic camera, which shows an image capturing unit without an upper cover.

FIG. 9 is an exploded view of an image capturing unit in one embodiment of the present invention of an electronic camera.

FIG. 10 is an exploded view of a lens system of an image capturing unit in one embodiment of the present invention of an electronic camera.

FIG. 11 is a schematic drawing in one embodiment of the present invention of an electronic camera, which illustrates a configuration of an image capturing element of an image capturing unit.

FIG. 12 is a schematic drawing in one embodiment of the present invention of an electronic camera, which illustrates a configuration of a rear fixing frame to which an image capturing element of an image capturing unit is attached.

FIG. 13 is a perspective illustration of a cam for zooming in a zooming mechanism.

FIG. 14 is an explanatory drawing in one embodiment of the present invention of an electronic camera, which illustrates a cam driving mechanism for zooming of an image capturing unit

FIG. 15 is a cross sectional drawing in one embodiment of the present invention of an electronic camera, which shows a cam driving mechanism for zooming.

FIG. 16 is an explanatory drawing of a focus mechanism.

FIG. 17 is a drawing in one embodiment of the present invention of an electronic camera, which shows a second embodiment of a cam for zooming.

FIG. 18 is a cross sectional drawing in one embodiment of the present invention of an electronic camera, which shows a second embodiment of a cam driving mechanism for zooming of a zoom cam in an image capturing unit.

FIG. 19 is a cross sectional drawing in one embodiment of the present invention of an electronic camera, which shows an driving mechanism using a cam for zooming 25 of an image capturing unit in a third embodiment.

FIG. 20 is a partially enlarged cross sectional drawing in one embodiment of the present invention of an electronic camera, which shows an driving mechanism using a cam for zooming 25 of an image capturing unit in a third embodiment.

FIG. 21 is cross sectional drawings in one embodiment of the present invention of an electronic camera, which show other embodiments in case a cam plane slanting position of a first or a second cam groove 40, 41 is varied in a cam for zooming of an image capturing unit of a third embodiment.

FIG. 22 is a schematic drawing in one embodiment of the present invention of an electronic camera, which shows another example of a driving mechanism using a cam for zooming 25 of an image capturing unit of a third embodiment.

FIG. 23 is a schematic drawing in one embodiment of the present invention of an electronic camera, which shows another example of a driving mechanism using a cam for zooming 25 of an image capturing unit of a third embodiment.

FIG. 24 is a perspective illustration in one embodiment of the present invention of an electronic camera 100, which shows a hinge mechanism connecting an image capturing unit 101 to an operation unit 102.

FIG. 25 is a perspective illustration showing a connecting portion in which a hinge mechanism is mounted to an image capturing unit 101 and an upper cover 307 and inner component members of an operation unit 102 are removed.

FIG. 26 is a perspective illustration of a decomposed hinge mechanism shown in FIG. 24.

FIG. 27 is a perspective illustration showing one embodiment of a driving mechanism for zooming in an electronic camera having a zoom apparatus as a cam for zooming.

FIG. 28 is a front elevational view of the above driving mechanism for zooming.

FIG. 29 is a perspective illustration of a driving mechanism for zooming, which shows a constitutive part of a cam for zooming.

FIG. 30 is a perspective illustration of a cam for zooming.

FIG. 31 is an exploded perspective illustration of a cam for zooming.

FIG. 32 is a camera plan view of showing as an example of an electronic camera having a driving mechanism for zooming.

FIG. 33 is a camera front elevational view of an electronic camera shown in FIG. 32.

FIG. 34 is a camera rear elevation view of an electronic camera shown in FIG. 32.

FIG. 35 is a camera front elevational view showing an example of a photographing state of the electronic camera shown in FIG. 32.

FIG. 36 is a perspective illustration of an optical system absorption part of the electronic camera shown in FIG. 32 when a rear case is removed.

FIG. 37 is a transverse sectional view of the above optical system absorption part.

FIG. 38 is an exploded perspective illustration of the above optical system absorption part.

FIG. 39 is a perspective illustration of a driving mechanism for zooming provided to the above optical system absorption part.

FIG. 40 is an exploded perspective illustration of a cam for zooming provided to the driving mechanism for zooming shown in FIG. 39.

FIG. 41 is a perspective illustration of a rate reducing device having the driving mechanism for zooming shown in FIG. 39.

FIG. 42 is a perspective illustration of an optical system installed part showing an image capturing unit and a mounting structure of the image capturing unit.

FIG. 43 is a perspective illustration of an optical system installed part showing a mounted state of an image capturing unit.

FIG. 44 is a perspective illustration of an optical system installed part showing a state that an image capturing unit together with a circuit board is actually mounted.

FIG. 45 is a perspective illustration of a driving mechanism for zooming as a prior art.

FIG. 46 is a perspective illustration of a driving mechanism for zooming similar to FIG. 45 as another prior art.

FIG. 47 is an enlarged partial sectional view of a configured portion of a cam groove with a cam pin of a conventional cam for zooming.

### DESCRIPTION OF THE PREFERRED EMBODIMENT

The invention will now be described in detail by way of example with reference to the accompanying drawings. It should be understood, however, that the description herein of specific embodiments such as to the dimensions, the kinds of material, the configurations and the relative disposals of the elemental parts and the like is not intended to limit the invention to the particular forms disclosed but the intention is to disclose for the sake of example unless otherwise specifically described.

### First Embodiment

In order to comply with recent needs for a thin and high magnification of a camera, further improvement is necessary. Accordingly, in a following embodiment it is an object to describe a camera having such a strength and a thickness as capable of shoving in a breast pocket of a dress shirt or in a hip pocket of jeans and such a lightness as make one no sense of discomfort when it is put in these places or a handbag, and yet having a zoom mechanism of high and precise magnification.

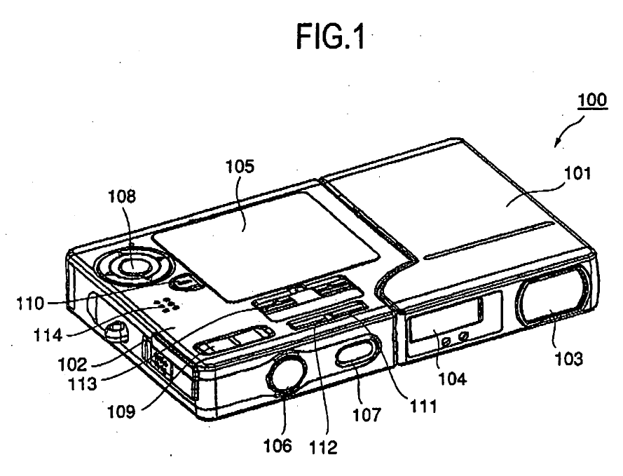

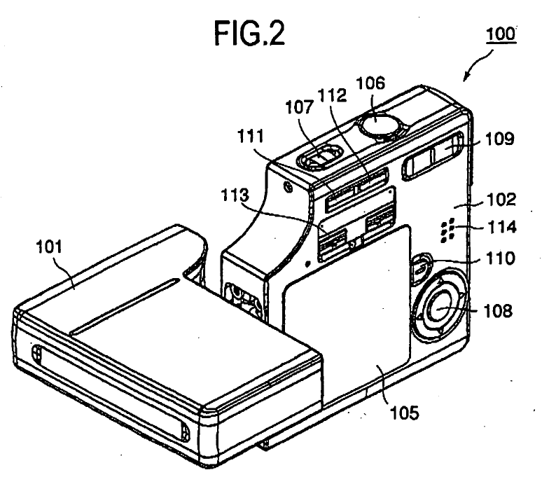

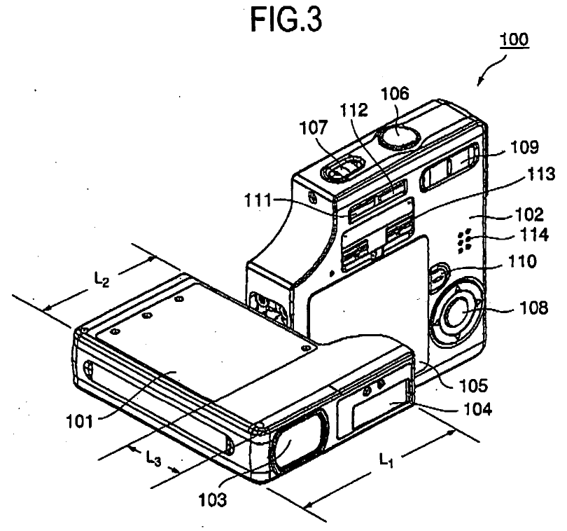

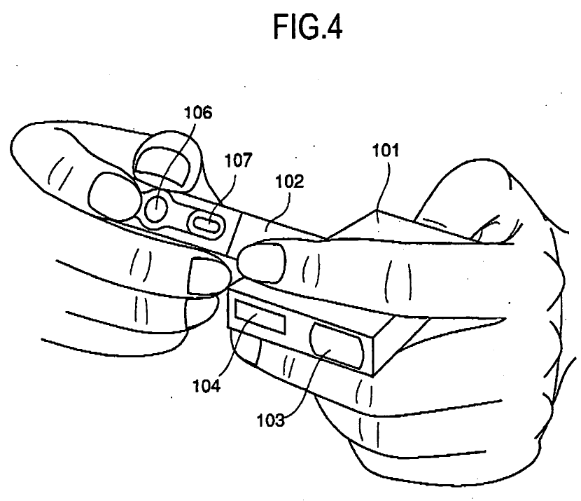

FIG. 1 is an over all view of an electronic camera in this embodiment. FIG. 2 is an illustration of an electronic camera in this embodiment, which shows a photographing state in case a lens is targeted to an object. FIG. 3 is an illustration of an electronic camera in this embodiment, which shows a photographing state in case a lens is targeted to a photographer, him or herself. FIG. 4 is an illustration of an electronic camera in this embodiment, which shows a held state in case a lens is targeted to an object

In the drawings, 100 is an electronic camera in this embodiment. 101 is an image capturing unit, 102 is an operation unit, 103 is a photographic lens window, 104 is a flash unit window such as a strobe, 105 is a display uni using such as LCD, 106 is a shutter button, 107 is a power button, 108 is a selection and decision key for selecting a function or an item which is displayed on the display unit 105 comprising a cross key and a decision key, 109 is a zoom key which bids optical system zooming and a menu button which changes on and off of a camera mode menu respectively. 111 is a display button, which changes on and off of display contents and light, and 112 is a scene button, which changes a display content of the display unit 105 to a scene selecting screen page respectively. 113 is a mode selecting button which select modes such as an aperture priority mode, a shutter priority mode, sports mode for photographing rapidly moving objects, a macro mode for photographing near objects, strobe control of enforced flashing of strobe or flashing halt, movie shooting and movie play back. 114 is a speaker.

In an electronic camera 100 in this embodiment, as shown in FIG. 1-3, display unit 105, general operational buttons for photographing 106-113 are disposed on the operation unit 102 side to which the image capturing unit 101 is connected rotatably by a hinge mechanism. The photographic lens window 103 is disposed on one side of the image capturing unit 101 and the flash unit window 104 is disposed on side of the operation unit 102. The operational buttons for photographing 106-113 are provided on the operation unit 102 so as not to project from the surface of the outer cover of the operation unit 102 whereby making one no sense of discomfort or getting stucked when shoving in a breast pocket of a dress shirt or in a hip pocket of jeans. Further, the shutter button 106 is positioned so as to be operable with a pointing finger when the camera 100 is held with a right hand. Further, the shutter button 106 is positioned so as to be operable with a pointing finger when the camera 100 is held with a right hand. The zoom key 109, the selection and decision key 108, the menu button 110, and the mode selecting button 113 are likewise disposed within the reaching distance for a thumb finger when the camera 100 is held with a right hand whereby operationality is upgraded. The buttons 106, 109 which are used mainly for photographing are disposed apart from the display unit 105 so that fingers don't touch the display unit 105.

In the camera 100 of this embodiment, while the display unit 105 is pointed at a photographer so as to be always visible, the image capturing unit 101 is pointed at an object as shown in FIG. 2 or the photographing lens window 103 is pointed at a camera operator him or herself by reversely rotating the image capturing unit as shown in FIG. 3, whereby self photographing is possible. Further, in the electronic camera 100 of this embodiment, when a length L1 between the end of the photographic window 103 side and the end of the flash unit window 104 side of the image capturing unit 101 be, for example, a length between a tip of a forefinger of a left hand and near a second arthrosis of the finger, and a length of a reverse side of the photographic lens window be L2, a thickness L3 along a direction of an optical axis of a portion of the flash unit window 104 corresponding to the portion L1-L2 is a thickness of a forefinger and the portion is roundly flared to the operation unit 102 side (see FIG. 3). Thus, a space for disposing operational buttons at the right side of the display unit 105 of the operation unit 102 is secured, whereby the electronic camera can be made small and of a good operationality. A distance between the photographic window 103 and a rotational center of the hinge mechanism is greater than a distance between an end of a reverse side to the photographic window 103 and the rotational center of the hinge mechanism.

Thus, when a photographer photographs by pointing the photographic lens window 103 at him or herself a length between a display screen of the display unit and the photographic lens window 103 becomes great. Therefore, when a photographer recognizes a display screen from a gap between photographic lens window 103 and the display screen by slanting the display unit 105 with respect to a visible direction of the photographer, the photographer obtains a good visibility of the whole screen as the gap is long owing to the long distance between the display screen and the photographic lens window 103.

When the electronic camera 100 is used, a power button 107 is pushed to activate the power and each button is operated. Any mode is selected by the menu button 110 with the mode selecting button 113 such as a photographing condition of an aperture priority mode or of a shutter priority mode, a sports mode photographing a body moving rapidly, a macro mode which photographs near objects, a strobe control of enforced flashing or flashing halt, and a movie shooting or movie play back. An item is selected by the selection and decision key 108 comprising a cross key and decision key and decided by pushing a center decision button as needed after displaying a variety of menus such as a size of an image, a photographic sensitivity, and a photometry method on the display unit 105 by pushing the menu button 110.

When the photographic window is pointed at a object as shown in FIG. 2, the operation unit 102 is held with a right hand as shown in FIG. 4 and a portion of L3 (see FIG. 3) of the image capturing unit 101 having a length of L1 (see FIG. 3) is held with a fore finger and a middle finger and the photographic window 103 is pointed at the object. After a predetermined magnification is determined by operating the zoom key 109 of the image capturing unit 101 with a thumb of the right hand while seeing a object displayed on the display unit 105, the shutter button 106 is pushed with a forefinger of the right hand to automatically determine exposure and focus so that a captured image signal by a built-in image capturing element such as CCD is stored in a built-in memory. By photographing in this way, since a distance between the photographic lens window 103 of the image capturing unit 101 and the rotational center of the hinge mechanism is greater than a distance between the rotational center of the hinge mechanism and an end of a reverse side to the photographic window 103, a lens unit is largely rotated so that the image capturing unit can be rapidly pointed at an object and the camera 100 can be held tightly.

After thus photographing, when a mode is turned to a playback mode with a mode selecting button 113, an image signal stored in the memory is displayed on the display unit 105 and captured images can be sequentially displayed on the display unit by operating the cross key of the selection and decision key 108. In case of a movie shooting mode, a movie signal is stored in a memory and is played back together with sound at the same time from the speaker 114 by selecting a necessary scene with the scene button 112.

A configuration of the operation unit 102 is explained as follows.

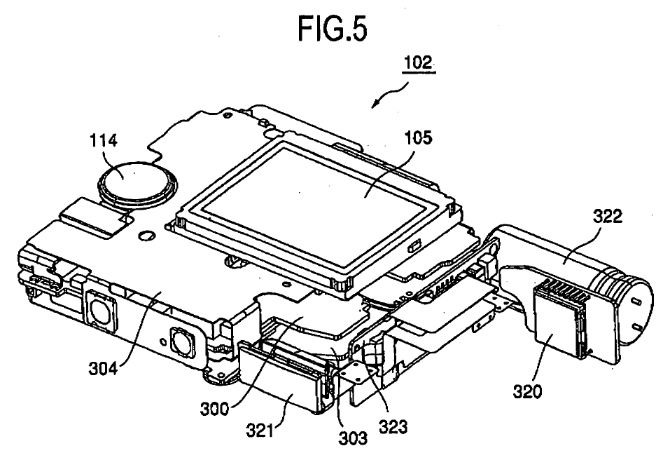

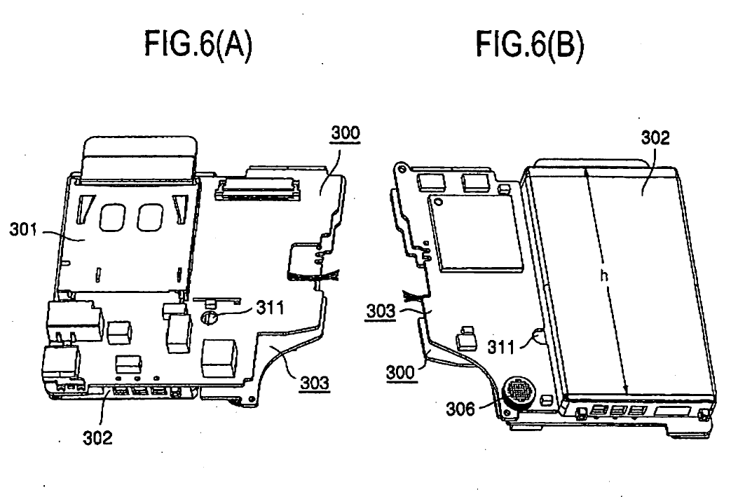

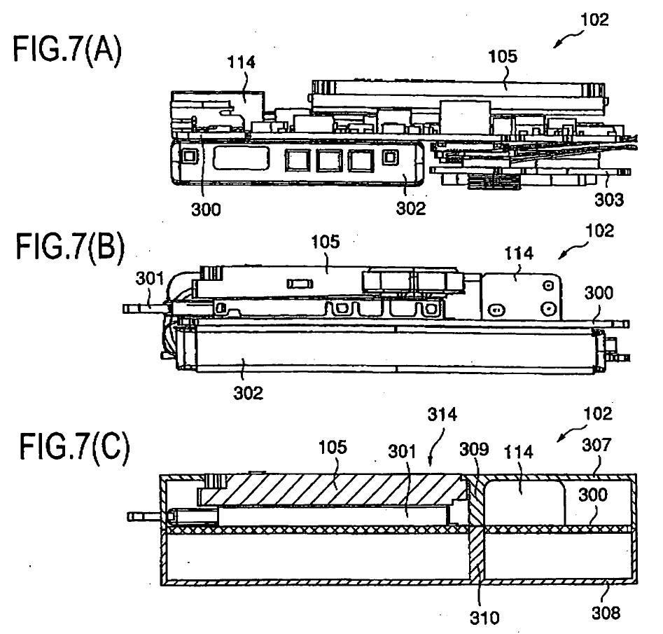

FIG. 5 is a perspective illustration in one embodiment of the present invention, which shows a mounted state of inner devices in an operation unit 102, whose cover is opened, of an electronic camera 100 and image capturing devices such as a flash unit, condenser and CCD in an image capturing unit 101. FIG. 6 is perspective illustrations in one embodiment of the present invention of an electronic camera 100, which shows a view of the uncovered state without a display unit 105 (A) of an operation unit 102 and a backside view (B) of an operation unit 102. FIG. 7 is drawings in one embodiment of the present invention, which shows an elevational view of the uncovered state from front side in FIG. 5 without a display unit 105 (A), an elevational view from left side in FIG. 5(B) and a sectional view from left side in FIG. 5 of an operation unit 102 of an electronic camera 100.

In this drawing, 300 is a main circuit board; 301 is a memory slot in which a memory card storing an image signal is received; 302 is a battery; 303 is a sub circuit board controlling the image capturing unit 101; 304 is a flexible board for mode control; 306 is a microphone, 307 is an upper cover; 308 is a under cover; 309 and 310 are pole braces for supporting approximately center part of the main circuit board 300 provided between the upper cover 307 and the under cover 308; 320 is an image capturing element of the image capturing unit 101 side such as a CCD; 321 is a flash unit of the image capturing unit 101 side such as a strobe; 322 is a condenser for the flash unit of the image capturing unit 101 side such as a strobe; and 323 is a print circuit board for the flash unit.

In an electronic camera 100 of this embodiment, the speaker 114 and the buttons such as the shatter button 106, the power button 107, the section and decision key 108, the zoom key 109, the menu button 110, the display button 111, scene button 112, and the mode select button 113 shown in FIG. 1 are attached on the upper cover 307 of the operation unit 102 shown in a sectional view of FIG. 7(C). A window for the display unit 105 shown in FIG. 5 is also provided and the flexible circuit board for mode control 304 is disposed around the display unit 105. The memory slot 301, which receives a memory card for storing an image signal is provided in the upper side under the flexible circuit board 304 for mode control and the display unit 105 and a main circuit board 300 having a thin battery 302 is provided in the lower side as shown in FIG. 6(B). These are stacked together as shown in FIG. 7(B). Further, the sub circuit board 303 is disposed at the lateral side of the battery 302 under the main circuit board 300 for controlling the image capturing unit as shown in FIG. 6 and FIG. 7(A).

The main circuit board 300 is positioned with positioning portions provided to corners of the under cover 308 and held between the upper and under covers while the pole brace 310 of the upper and under cover 307, 309 is let through the hole 311 provided at the center of the main circuit board 300 as shown in FIG. 7(C) so as to be supported flexibly with respect to a deflection of the case. That is, in case the whole electronic camera 100 is made thin and it is shoved into a breast pocket of a dress shirt or a hip pocket of jeans notwithstanding that a CPU and others which control the whole electronic camera are mounted on the main circuit board 300, a big deflection force is exerted to the case consisting of the upper cover 307 and the tinder cover 308. Accordingly, if a main circuit board 300 having a CPU and others is fixed with a screw or the like to a case, the main circuit board is deflected by a deflection force, leading to a trouble that the solder mounted CPU is peeled off in a worst case. Therefore, in the present embodiment, the deflection force is released by holding the approximately center portion of the board with the poles 309, 310 as the corners of the main circuit board 300 are only positioned.

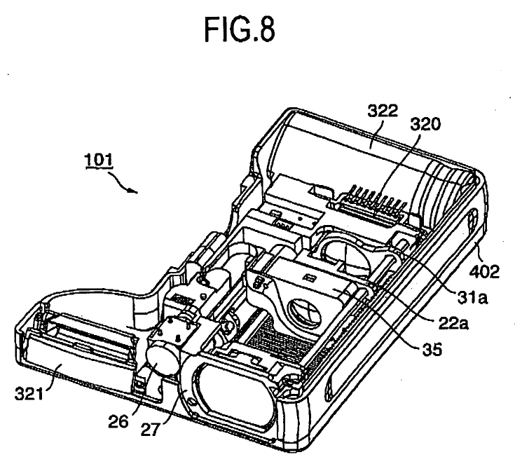

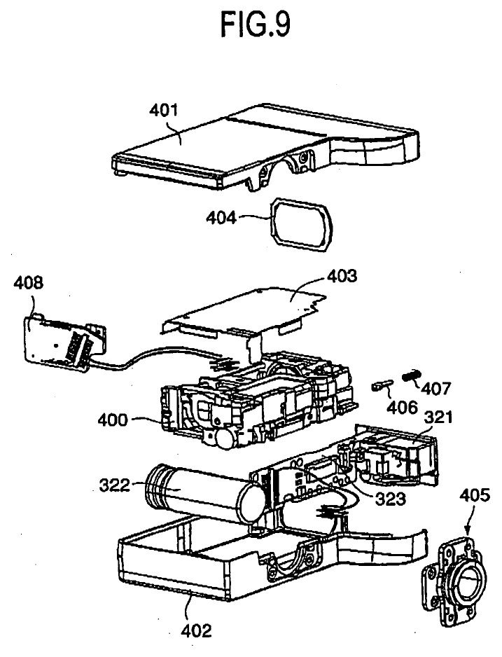

Next, a configuration of the operation unit 102 is explained as follows. FIG. 8 is a perspective illustration in one embodiment of the present invention of an electronic camera, which shows an image capturing unit without an upper cover. FIG. 9 is an exploded view of an image capturing unit in one embodiment of the present invention of an electronic camera. In the drawings, 400 is a lens unit containing a driving mechanism for zooming; 401 is a under cover of the image capturing unit; 402 is a upper cover of the same; 403 is a cover plate for covering so as not to enter dirt in the optical system when mounting lens unit 400; 404 is a lens window in which the photographic lens window is installed; 405 is a hinge mechanism so as to be capable of rotating the image capturing unit 101 with respect to the operation unit 102; 406 is a push pin to press a cam for zoom mentioned later with a pressing force of a coil spring 407; and 408 is an image capturing element unit.

In the image capturing unit 101 of the electronic camera 100 of this embodiment, as explained in FIG. 3 above, when a length L1 between the end of the photographic window 103 side and the end of the flash unit window 104 side of the image capturing unit 101 be, for example, a length between a tip of a forefinger of a left hand and near a second arthrosis of the finger, and a length of a reverse side of the photographic lens window be L2, a thickness L3 along a direction of an optical axis of a portion of the flash unit window 104 corresponding to the portion L1-L2 is a thickness of a forefinger and the portion is roundly flared to the operation unit 102 side.

In the image capturing unit 101 of the electronic camera 100 of this embodiment, a height of a lens frame of a lens group comprising a zoom lens of the lens unit 400 is restricted to an approximate value of the sum of the display unit 105 disposed in the operation unit 102, the memory slot 301 which receives a memory card storing an image, the main circuit board 300 and the battery 302; a generally disc shaped shutter is configured to as a quadrangular shape having the same height as the lens frame letting the outer circumference of these lens frame and shutter be a supporting plane of the case comprising the upper and under covers. Further, a total length of the zoom lens along the optical axis is restricted to a height of battery 302 as shown in FIG. 6(B); a driving mechanism for zoom lens and a control circuit board 323 of a flash unit 321 in the image capturing unit 101 and others are disposed in a lateral space of the optical system; and electrical components such as a condenser for the flash unit 322 are disposed in a back space opposite to the photographic lens window 103 of the optical system.

Thus, a total length of the optical system does not vary even when the power of the electronic camera 100 is on and off by restricting a total length of the zoom lens along the optical axis to a height h of the battery 302 in FIG. 6(B) and disposing the driving mechanism for the zoom lens to a side of the optical system. As a lens is unnecessary to be drawn and stored every time when the power is on and off like a conventional camera, photographing is possible as soon as the control system is operated so that a photographing opportunity is never missed. In case lens groups increase owing to high magnification, it is possible to add up lens groups utilizing the space opposite to the photographic lens window 103 where electric components such as the condenser for the flash unit 322 are disposed.

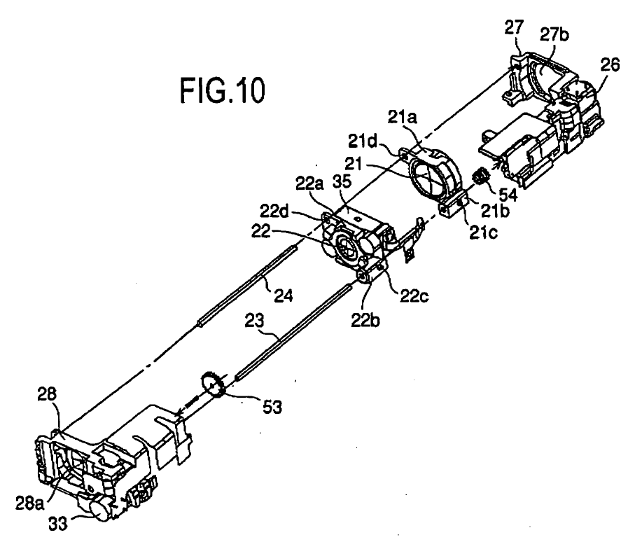

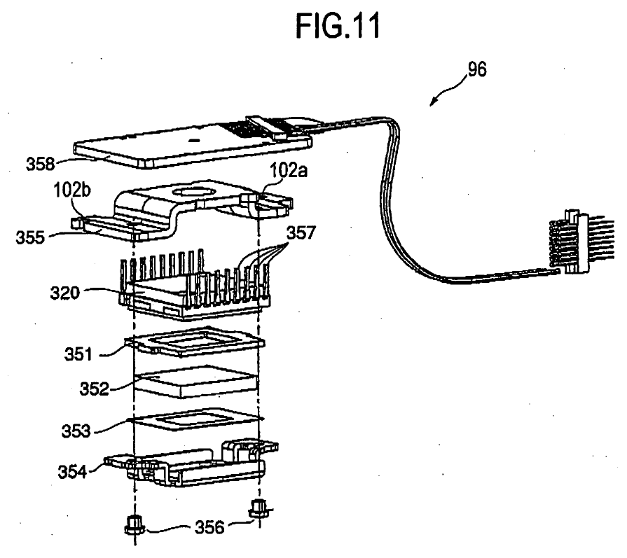

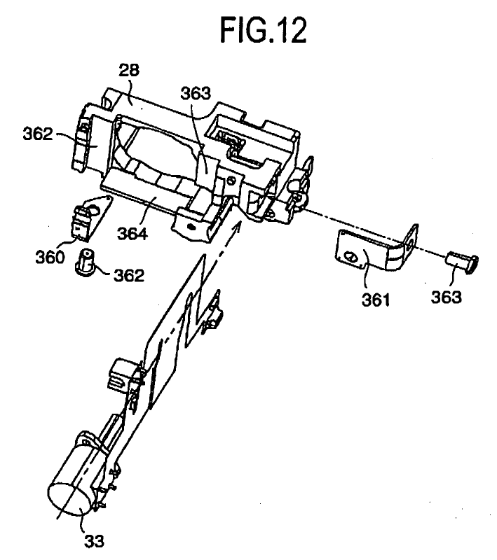

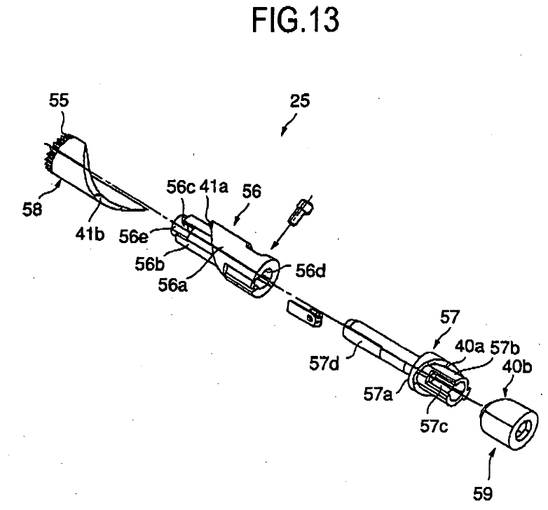

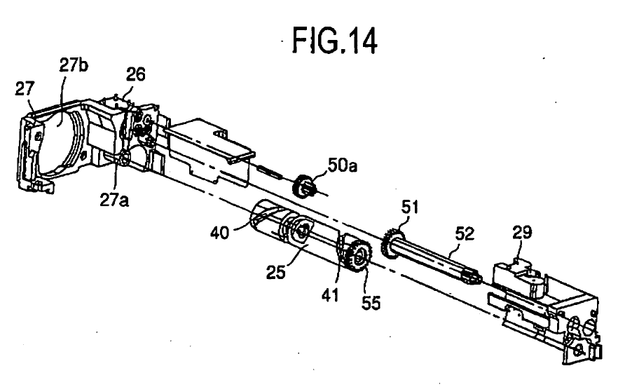

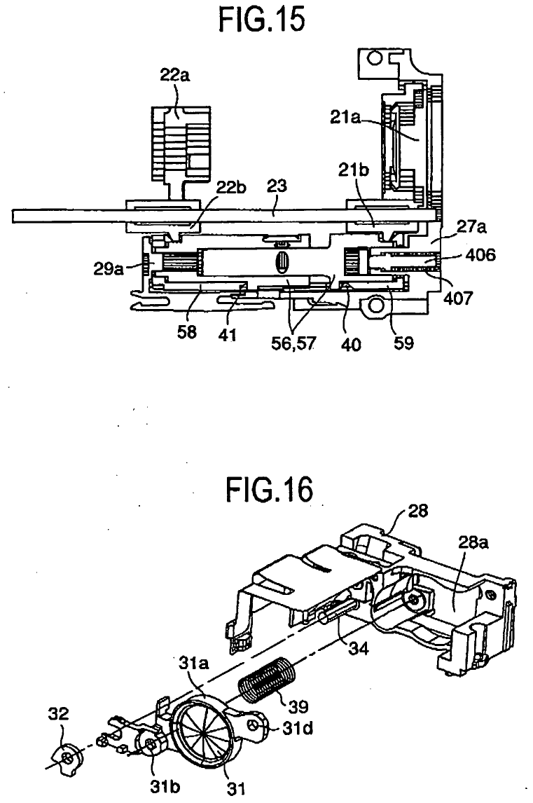

Next, referring to FIG. 10-16, a lens unit 400 of a image capturing unit 101 having a driving mechanism for zoom is explained in this embodiment of a electronic camera 100. FIG. 10 is an exploded view of a lens system of an image capturing unit in one embodiment of the present invention of an electronic camera. FIG. 11 is a schematic drawing in one embodiment of the present invention of an electronic camera, which illustrates a configuration of an image capturing element of an image capturing unit; FIG. 12 is a schematic drawing in one embodiment of the present invention of an electronic camera, which illustrates a configuration of a rear fixing frame to which an image capturing element of an image capturing unit is attached; FIG. 13 is a perspective illustration of a cam for zooming in a zooming mechanism; FIG. 14 is an explanatory drawing in one embodiment of the present invention of an electronic camera, which illustrates a cam driving mechanism for zooming of an image capturing unit; FIG. 15 is a cross sectional drawing in one embodiment of the present invention of an electronic camera, which shows a cam driving mechanism for zooming; and FIG. 16 is an explanatory drawing of a focus mechanism.

21 is a first lens group; 21a is a lens frame of a first lens group 21; 21b is a boss (bearing portion) provided on the lens frame 21a; 21c is a cam pin provided on the boss 21b; 22 is a second lens group; 22a is a lens frame of the second lens group; 22b is a boss (bearing portion) provided on the lens frame 22a; 22c is a cam pin provided on the boss 22b; 23, 24 is a guide shaft, one end of which is fixed to a front fixing frame 27 and another end of which is fixed to a rear fixing frame 28; 25 is a cam for zooming; 26 is a motor for zooming; 27 is a front fixing frame; 27a is a bearing portion; 27b is a window hole through which an object image light is passed; 28 is a rear fixing frame; 28a is a window hole through which an object image light is passed and right behind the window hole of a rear fixing frame 28, an image capturing element unit 408 comprising such as CCD shown in FIG. 9 is mounted; 29 is a supporting fixing frame (FIG. 14); 29a is a bearing portion provided on the supporting fixing frame 29(FIG. 15); 31 is a third lens group which is moved by a lead screw 34 rotated with a motor for focusing 33 (FIG. 10) provided on the rear fixing frame (FIG. 16); 31a is a lens frame of the third lens group 31; 31b is a boss provided on the lens frame 31a having a hole through which the guide shaft 23 is pierced; 32 is a nut screw which advances and retreats the third lens group 31 by moving with the lead screw 34 rotated by the motor for focusing 33(FIG. 10); 35 is a shutter unit; and 39 is a spring for preventing from a play of the third lens group. If the motor for zooming 26 and a motor for focusing 33 are disposed at the same place piling on top of another, two magnetic fields generated by two magnetic coils of the motors affect each other so that erroneous activation occurs. To avoid the occurrence, two motors are disposed at the both ends along the optical axis in the optical system as shown in FIG. 10.

In FIGS. 13 and 14, 40 is a first cam groove of the cam for zooming 25; 40a is one cam plane of the first cam groove; 40b is another cam plane; 41 is a second cam groove of the cam for zooming 25; 41a is one cam plane; 50a is another cam plane; 52 is a zoom shaft for communicate a driving force to a gear 55 of the cam for zooming 25 by engaging a gear provided on the shaft of the motor for zooming 26; 56 is a cam for zooming (1); 57 is a cam for zooming (2); 58 is a cam for zooming (3); 59 is a cam for zooming (4).

In the electronic camera 100 of this embodiment, a zoom lens of the image capturing unit 101 comprises, as shown in an exploded view of FIG. 10, a first lens group 21, a second lens group 22, and a third lens group 31 for focusing shown in FIG. 16 provided on the portion of the rear fixing frame 28 in FIG. 10 as photographic lenses wherein zooming and focusing is performed with these first to third lens groups. A guide shaft 23 is pierced through a boss (a bearing portion) 21b provided on the lens frame 21a of a first lens group 21, a boss (a bearing portion) 22b provided on the lens frame 22a of a second lens group 22, and a boss (a bearing portion) 31b provided on the lens frame 31a of a third lens group 31 for focusing shown in FIG. 16. A guide shaft 24 is further pierced through a hole 21d, 22d or 31d provided at the positions each opposite to the boss 21b, 22b or 31b so that the first to the third lens groups can advance and retreat along the optical axis as being held by the guide shafts 23, 24. A cam for zooming 25 shown in FIGS. 13 and 14 is disposed on the lateral side of the first and the second lens groups to advance and retreat the first and the second lens groups, preventing to reduce the thinness of the electronic camera 100 itself by the driving system of the zoom lens.

Thus, since the camera is tried to be made thin by restricting an outer diameter of the lens to a thickness of the sum of each thickness of LCD, a memory, a battery or a control circuit board indispensable to recognition and record of images for a electronic camera, by deposing the cam for moving the zoom lens at the lateral side of the lens system, letting the lens move back and forth by defining the lens frame as a supporting plane of the case and by piercing the guide shaft through the lens frame, these components do not become thicker than the sum of the thickness of LCD, a memory, a battery and a control circuit board, whereby the electronic camera can be configured very thin.

In an electronic camera 100 of this embodiment, an image capturing element unit 408 comprising a CCD is, as shown in FIG. 11, has a CCD rubber 351 for protecting the CCD, low pass filter 352, a CCD mask 353, a low pass filter holder 351 at the object side of an image capturing element 320 such as CCD, which are fixed with a screw 356 to a CCD plate 355 made from rigid material, and leads of the image capturing element 320 soldered with a print circuit board 358 is fixed with a spring to a rear fixing frame 28 as shown in FIG. 12. That is, in FIG. 12, 360 is a leaf spring which restricts a direction of up and down for the image capturing element unit 408 configured as shown in FIG. 11, and 361 is also a leaf spring which restricts a direction of left and right. These leaf springs fixes the image capturing element unit 408 configured as shown in FIG. 11 on a standard plane 362, 363, 364 of the rear fixing frame 28.

Though it is a general practice that a image capturing element 320 is fixed with a screw to a case side in this type of electronic camera, in case a camera is made thin like this embodiment of the electronic camera 100, each member is thin and deflection of the case arises, an image may be affected due to propagation of the deflection. Accordingly, the low pass filter and others are integrated to be fixed with leaf springs 361, 362 so that mounting becomes simplified and an image is not affected eve if a deflection force is applied to the case.

In the driving mechanism for zooming configured as above, the first and second-lens group 21, 22 moves for zooming along the guide shaft 23, 24 by driving rotatably the cam for zooming 25 with the motor for zooming 26; and the third lens group 31 moves for focusing by moving the nut screw with the lead screw 34 (FIG. 16) driven rotatably with the motor for focusing 33. The third lens group moves even when zooming.

A cam pin 21c as a member for inserting into the cam groove 40 and a cam pin 22c as a member for inserting into the cam groove 41 is projectingly formed on the boss 21b and the boss 22b of the first lens group 21 and the second lens group 22 respectively. Meanwhile, the cam for zooming 25 is a cylindrical cam having a first cam groove 40 and a second cam groove 41 as shown in FIG. 14. As shown in FIG. 13, the cam for zooming comprises a cylindrical cam for zooming (1) 56, a cam for zooming (2) 57, a cylindrical cam for zooming (3) 58, (4) 59 fitting to both ends of the cam for zooming (1) 56 and the cam for zooming (2) 57 so as to be capable of sliding, a push pin 406 and a coil spring 407 shown in FIG. 15 pressing the cam for zooming (3) 58 and the cam for zooming (4) 59 in a direction of approaching each other.

The cam for zooming (2) 57 has a shaft portion 57d having a smaller diameter made by D-cutting, the shaft portion being able to insert into a hole 56d which receives the D-cut portion. Further, the cam for zooming (1) 56 and the cam for zooming (2) 57 have a sliding portion 56b and 57b respectively having a smaller diameter at the opposite side of middle portion 56a, 57a. Stepped portions between the middle portions 56a, 57a and the sliding portions 56b, 57b are formed as one cam plane 40a and one cam plane 41a for forming the first cam groove 40 and the second cam groove 41. The cam for zooming (1) 56 and the cam for zooming (2) 57 have long holes 56c, 57c into which unshown protruded portions provided on the cam for zooming (3) 58 and the cam for zooming (4) 59 are inserted so as to be able to slide, whereby the cam for zooming (3) 58 and cam for zooming (4) 59 are rotated together with the cam for zooming (1) 56 and the cam for zooming (2) 57. A stepped portion 56e formed on the end portion of the cam for zooming (1) 56 is for restricting moving the cam for zooming (3) 58. Each end circumferential portion of the cam for zooming (3) 58 and the cam for zooming (4) 59 has another cam plane 40b for forming the first cam groove 40 and another cam plane 41b for forming the second cam groove 41.

The D-cut shaft portion 57d of the cam for zooming (2) 57 formed in a manner mentioned above is fit into the hole 56d which receives a D-cut portion provided to the cam for zooming (1) 56. The cam for zooming (3) 58 is fitted to the sliding portion 56 of the cam for zooming (1) 56 and the cam for zooming (2) 57 to the sliding portion 57b of the cam for zooming (4) 59 and fixed with the bearing portion 27a of the front fixing frame 27 and the bearing portion 29a of the supporting fixing frame 29 provided to the rear fixing frame 28 as shown in FIG. 14, FIG. 15. The cam for zooming (3) 58 and the cam for zooming (4) 59 are pressed in a direction of approaching each other with the push pin 406 pressed by the coil spring 407 inserted into the bearing portion 27a of the front fixing frame 27. The cam for zooming (3) 58 slides on the sliding portion 56b and the cam for zooming (4) 59 slides on the sliding portion 57b. The first cam groove 40 is formed by one cam plane 40a and another cam plane 40b and the second cam groove 41 is formed by one cam plane 41a and another cam plane 41b. Accordingly, the formed cam grooves 40 and 41 become spiral cam grooves fit to moving of the first and second lens groups necessary for zooming.

The cam pin 21c which is projectingly formed on the boss 21b of the first lens group 21 as explained in FIG. 10 is inserted into the cam groove 40 and the cam pin 22c which is projectingly formed on the boss 22b of the second lens group 22 is inserted into the cam groove 41 as shown in FIG. 15. Since the cam for zooming (3) 58 and the cam for zooming (4) 59 are slid in a direction of departing from the cam for zooming (1) 56 and the cam for zooming (2) 57 by the insertion, the cam pin 21c is pressed to the cam plane 40b of the cam for zooming (4) 59 and the cam pin 22c is pressed to the cam plane 41b of the cam for zooming (3) 58. Therefore, these cam pin 21c and 22c contact the cam plane with a definite contact pressure over the whole region of the cam grooves 40 and 41. As a pressing force of the cam pin 21c, 22c to the cam planes can be determined by a pressing force of the coil spring 407, a pressing force of the cam pins 21c and 22c can be made most appropriate, if a coil spring having appropriate pressing force is chosen.

Thus, the cam for zooming (1) 56 can be rotated with a definite driving force for rotation and the driving for moving the first lens group and the second lens group 21, 22 can be performed smoothly. As a result, a small motor consuming a little electricity can be used as a motor for zooming for the cam for zooming 25 becomes a cam apparatus having a light load and a little fluctuation.

Since, in addition that the cam pins 21c, 22c become a cam for zooming 25 having a definite pressure over the whole region the cam grooves 40 and 41, the motor for zooming 26 is disposed coaxially to the cam for zooming 25, a width in a lateral direction of the image capturing unit 101 (L2 in FIG. 3) can be reduced. Further, since the first and the second lens groups 21, 22 for zooming and the third lens group 31 are supported and moved by the same guide shafts 23, 24, the lenses are difficult to fall or become eccentric.

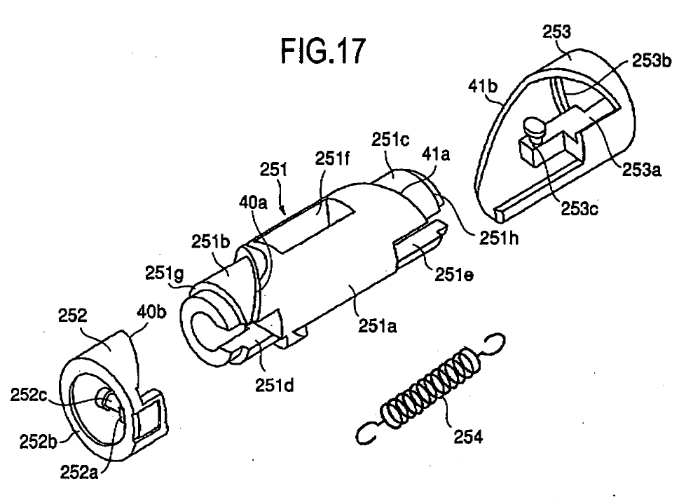

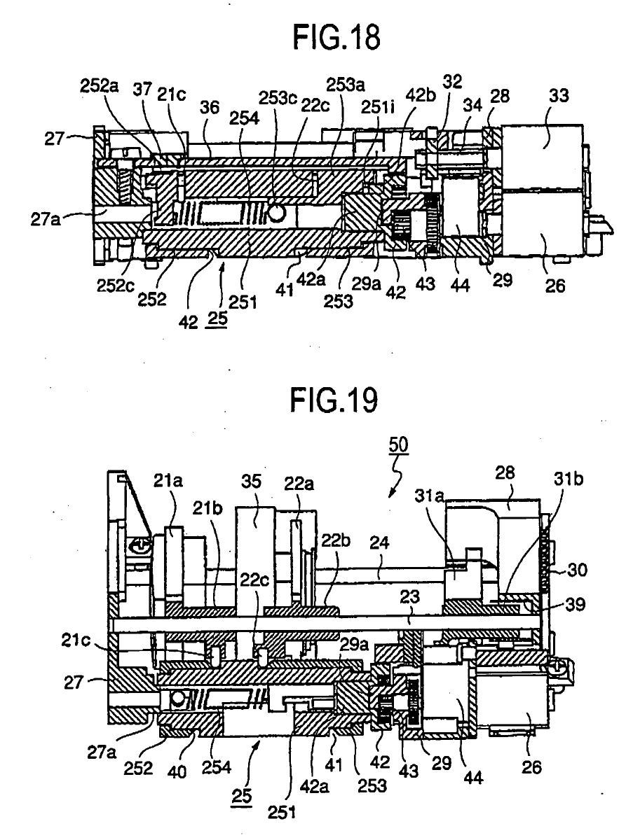

The above is a zoom mechanism of the lens unit 400 in the electronic camera 100 of this embodiment. A lot of methods are thought of as mechanisms for rotating the cam for zooming 25 by a definite driving force of a motor. First, FIG. 17 shows a second embodiment and FIG. 18 shows a sectional view of a driving mechanism using the cam for zooming 25. In the following explanation, a same number is attached to a same constituent element mentioned above.

A cam for zooming 25 of the second embodiment, shown in FIG. 17, comprises a cylindrical cam base body 251 having a first cam groove 40 and a second cam groove 41, a cylindrical cam frames 252, 253, fit to the both sides of the cam base body 251 so as to be able to slide and a coil spring 254 of tensile force for pressing these cam frame 252, 253 in a direction of approaching each other.

A cam base body 251 has a sliding portions 251b, 251C having a smaller portion at the both sides of the middle portion 251a. One cam plane 40a is formed for forming a first cam-groove 40 at a stepped portion between the middle portion 251a and the sliding portion 251b. One cam plane 41a is formed for forming a first cam groove 41 at a stepped portion between the middle portion 251a and the sliding portion 251c. The cam base body 251 has long holes 251d, 251e along an axial direction from the both ends, into which protruded portions 252a, 253a are fit so as to be able to slide, whereby the cam frames 252, 253 are rotated together with the cam base body 251. A hole portion 251f formed at the ends of sliding portion 251b, 251c is to attach a coil spring 254. Stepped portions 251g, 251h are to restrict the movement of said cam frame 252, 253.

Meanwhile, a cam frame 252 has another cam plane 40b for forming a first cam groove 40 at one end circumference portion and further has a pointing inner flange 252b. The cam frame 252 has a spring hooking portion 252c projected from the protruded portion 252a in the cylinder.

A cam frame 253 has another cam plane 41b for forming a first cam groove 41 at one end circumference portion and further has a pointing inner flange 253b. The cam frame 253 has a spring hooking portion 253c projected from the protruded portion 253a in the cylinder.

With regard to the cam base body 251, the cam frames 252, and 253, after the cam frame 252 is fit to the sliding portion 251b of the cam base body 251 and the cam frame 253 is fit to the sliding portion 251c, one end of coil spring 254 is hooked to the spring hooking portion 252c of the cam frame 252 and another end is hooked to the spring hooking portion 253c of the cam frame 253. Then the coil spring 254 presses the cam frame 252 and 253 in a direction of approaching each other so that the flange portion 252b advances until it strikes the stepped portion 251g as the cam frame 252 slides the sliding portion 251b. With this state, the first cam groove is formed by the one cam plane 40a and the other cam plane 40b. Likewise, the cam frame 253 slides the sliding portion 251c and the flange portion 253b advances until it strikes the stepped portion 251h so that the second cam groove is formed by the one cam plane 41a and the other cam plane 41b with this state. Thus formed cam grooves 40, 41 become spring shaped cam grooves matched with movement of the first and second lens groups 21, 22 necessary to zooming.

As explained in FIG. 15, as for the cam grooves 40, 41 of the cam for zooming 25, the cam pin 21c formed projectingly on the boss 21b of the first lens group 21 is inserted into the cam groove 40 and the cam pin 22c formed projectingly on the boss 22b of the second lens group 22 is inserted into the cam groove 41. By the insertion, the flange portion 252b of the cam frame 252 retreats a little from the stepped portion 251g and likewise, the flange portion 253b of the cam frame 253 retreats a little from the stepped portion 251h. Therefore, since the cam pin 21c is pressed to the cam plane 40b of the cam frame 252 and the cam pin 22c is pressed to the cam plane 41b of the cam frame 253, the cam pins 21c, 22c contact to the cam plane with a definite contact pressure over the whole region of the cam grooves 40, 41. A contact pressure of the cam pins 21c, 22c to the cam plane can be determined by a tensile force of the coil spring 254. A most appropriate contact pressure of the cam pins 21c, 22c is available when the coil spring 254 having an appropriate tensile force is chosen.

Thus, the cam for zooming 25 can be rotated with a definite motor driving force and the first and the second lens groups 21, 22 can be smoothly driven for moving. As a result, the cam for zooming 25 becomes a cam apparatus having a light load of small fluctuation so that a small and power saving motor can be used as a motor for zooming 26.

Next, referring to FIG. 18, a cam for zooming 25 of this second embodiment is explained. An inner gear 42 is provided at a rear end side of the cam for zooming 25. A protruded portion 42a of the inner gear is inserted into an inner hole of the cam base body 251. A key 42b provided at a circumferential portion of the protruded portion 42a fits in a key groove 251i formed in an inner hole portion of the cam base body 251. Accordingly, the cam for zooming 25 rotates together with the inner gear 42.

The inner gear 42 is rotatably supported by a bearing portion 29a provided on a supporting fixing frame 29 and further engages a small coupling gear 43. The small coupling gear 43, which is driven by the motor for zooming 26 through a rate reducing device 44, rotates the inner gear 42 to rotate the cam for zooming 25.

As a result, the cam pins 21c, 22c exert a definite contact pressure over the whole region of the first and second cam groove 40, 41; the width (L2 in FIG. 3) in a lateral direction of the image capturing unit 01 can be shortened in addition; and further the first and second lens groups 21, 22 for zooming and the third lens group 31 are movably supported with the same guide shafts 23, 24 so that the lens groups are difficult to fall or become eccentric.

FIG. 19 is a cross sectional drawing, which shows a driving mechanism using a cam for zooming 25 of an image capturing unit in a third embodiment. In the driving mechanism using the cam for zooming 25 of the third embodiment, an inner gear 42 is provided at a rear end side of the cam for zooming 25 as well as the second embodiment shown in FIG. 18; a protruded portion 42a of the inner gear 42 is inserted into an inner hole of a cam base body 251; and a key provided at the circumference portion of the protruded portion 42a fits in a key groove formed the inner hole portion of the cam base body 251. Accordingly, the cam for zooming 25 rotates together with the inner gear 42. The inner gear 42 is rotatably supported by a bearing portion 29a provided on a supporting fixing frame 29 and further engages a small coupling gear 43. The small coupling gear 43, which is driven by the motor for zooming 26 through a rate reducing device 44, rotates the inner gear 42 to rotate the cam for zooming 25.

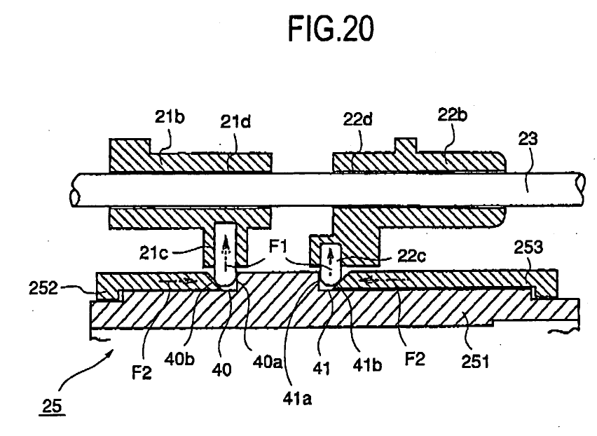

Meanwhile, other cam planes 40b, 41b formed on cam frames 252, 253 are slanted at a predetermined angle. This is shown in detail by a partially enlarged cross sectional drawing of the structural part of first and second cam grooves 40, 41 and cam pins 21c, 22c in FIG. 20. As seen in the drawing, the other cam planes of the first and second cam frames 252, 253 are formed as slanting cam planes having a rising gradient to the periphery of the frame.

The cam pins 21c, 22c receive a pushing force in a direction of F1 shown in the drawing because the other cam planes 40b, 41b are formed as slanting planes. That is, as a spring force in a direction of F2 shown in the drawing is exerted to the first and second can frames 252, 253 with the coil spring 254, the first and second cam frames receive a pressing force F1 in a direction orthogonal to the rotational axis of the cam groove in addition to the contact pressure of the cam pins 21c, 22c pressed by a slanting plane of the other cam planes 40b, 41b to the one cam plane 40a, 41a.

The above mentioned pressing force F1 which acts on the cam pins affects in such a manner that hole plane portions of supporting holes 21d, 22d of the bosses 21b, 22b contacts the guide shaft 23 so as to absorb mechanical play between the supporting shaft holes 21d, 22d and the guide shaft 23.

Therefore, in the cam for zooming 25, the cam pins 21c, 22c contact a whole region of the first and second cam grooves 40, 41 with a definite contact pressure and are driven to move in a direction of the rotational axis of the cam groove according to rotation of the cam for zooming 25 so that the first and second lens groups 21, 22 move along the guide shaft 23.

Further, since the bosses 21b, 22b slide the guide shaft 23 without mechanical play as mentioned above, the second lens groups 21, 22 do not become slanting or eccentric. As a result, the driving mechanism for zooming has a cam for zooming 25 (cam apparatus) capable of upgrading zooming accuracy.

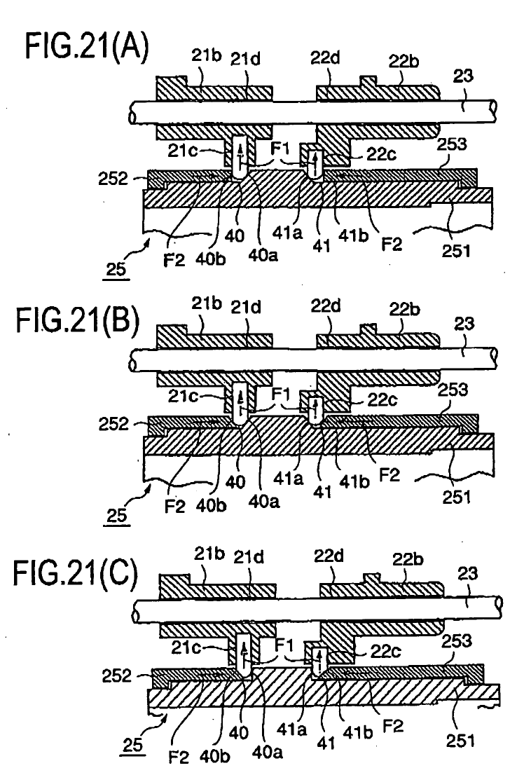

FIG. 21(A), (B), (C) are cross sectional drawings showing other embodiments similar to FIG. 20 wherein a slanted position of the cam plane of the first and second cam grooves 40, 41. FIG. 21 (A) is a cross sectional drawing showing one cam planes 40a, 41a of the first and second cam grooves 40, 41, which are formed slantingly. FIG. 21(B) is a cross sectional drawing showing one cam planes 40a, 41a and other cam planes 40b, 41b of the first and second cam grooves 40, 41, which are formed slantingly. FIG. 21(C) is a cross sectional drawing showing other cam planes 40b, 41b of the first and second cam grooves 40, 41 and cam pins 21c, 22c, which are formed slantingly.

Since a pressing force F1 acts to the cam pins 21c, 22c in the event of the above configuration, a play between the bosses 21b, 22b and the guide shaft 23 can be absorbed so that slant or eccentricity of the first and second lens groups ca be prevented. The contact portion of the cam pins 21c, 22c, which contact the cam plane may be formed slantingly.

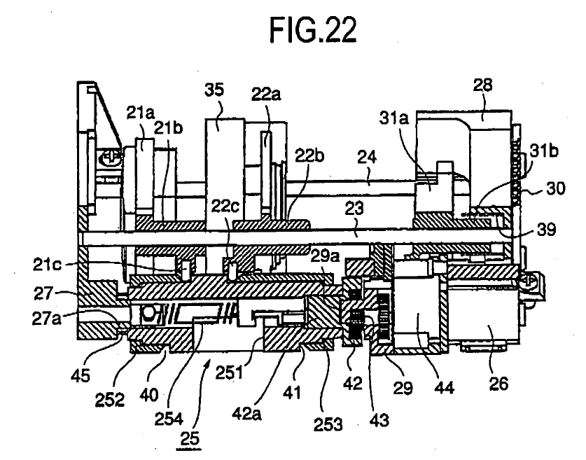

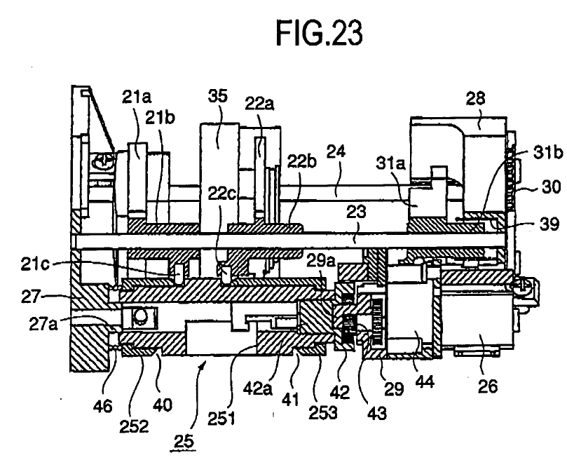

FIGS. 22 and 23 are another embodiment of a driving mechanism using a cam for zooming 25 of this third embodiment. FIG. 22 shows a driving mechanism in which a coil spring 45 is provided at a bearing portion 27a of a front fixing frame 27 in order to absorb a bearing play of the cam for zooming 25. The coil spring 45 enhances an accuracy of the moving position of the first and second lens groups 21, 22 preventing from movement of the cam for zooming 25 in a direction of the rotational axis by pressing the cam for zooming 25 in one direction.

Next FIG. 23 shows an embodiment wherein a bearing play of the cam for zooming 25 and first and second cam frames 252, 253 is pressed with a coil spring 46 by providing a coil spring 46 at a bearing part 27a of a front fixing frame 27. This embodiment is configured as such that a cam base body 251 is pressed through a cam pin 21c by pressing a first cam frame 252 and a second cam frame 253 is pressed in one direction through a cam pin 22c. With this configuration, a coil spring 254 hooked between the cam frames 252 and 253 becomes unnecessary.

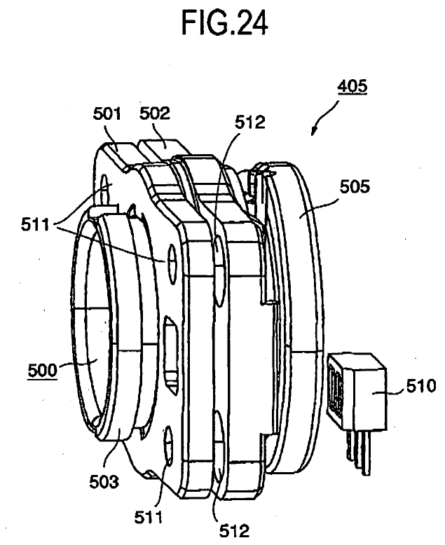

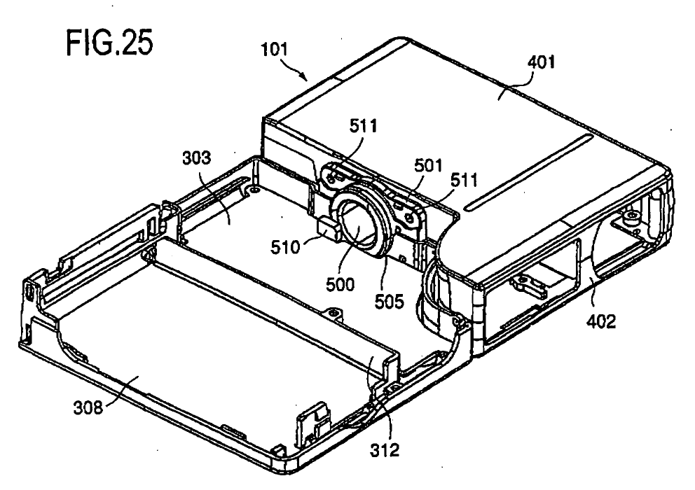

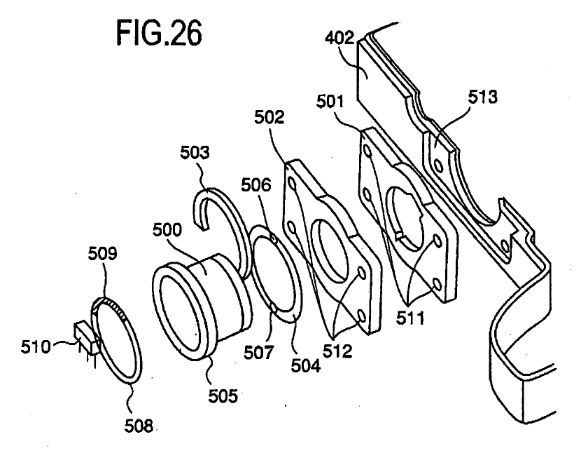

Next, a hinge mechanism shown in FIG. 9 as 405 with which an image capturing unit 101 is connected to an operation unit 102 of an electronic camera 100 in one embodiment of the present invention. FIG. 24 is a drawing showing a configuration of a hinge mechanism only with which an image capturing unit 101 is connected to an operation unit 102 of an electronic camera 100 according to the present invention. FIG. 25 is a perspective view of connecting portion wherein the hinge mechanism is mounted to the image capturing unit 101 and an upper cover 307 and inner component parts are removed to show the connecting portion. FIG. 26 is a perspective illustration of a decomposed hinge mechanism shown in FIG. 24.

In this drawing, 500 is a hinge shaft which rotates the image capturing unit 101 with respect to the operation unit 102; 501 is a hinge lens plate fixed on the image capturing unit 101 side and fixing a lens shaft 500; 502 is a hinge body plate as a bearing which enables to rotate the lens shaft 500 and is fixed to the operation unit side 102; 503 is a CE ring for fixing the shaft 500 at the hinge plate 501 side; 504 is an annular spring, which is inserted between a flange 505 of the shaft 500 and a hinge body plate 502, has click portions at two top portions, catches recessed portion (unshown) provided on a flange 505 of the shaft 500, and is fixed when the image capturing unit 101 rotates at an predetermined angle with respect to the operation unit 102; and 508 is a hinge marker having a reflecting pattern 509 on its one portion for detecting a rotational angle of the image capturing unit 101 with respect to the operation unit 102 with a photo-reflector 510 by sticking to the flange portion 505 of the shaft 500.

As shown in FIG. 25, the hinge mechanism 405 is fixed to a fixing portion 513 provided at an under cover 401 and an upper cover 307 of the image capturing unit 101 by screwing a screw through a screw hole 511 of a hinge lens plate 501. A hinge body plate 502 is likewise fixed to a fixing portion (unshown) of an upper cover 307 and an under cover 308 of the operation unit 102. The flange portion of the shaft 500 is stuck with the reflecting pattern 508 and the shaft is pierced in the annular spring 504, the hinge body plate 502 and the hinge lens plate 501 and fixed to the hinge lens plate 501 with CE ring at the lens system side of the hinge lens plate 501. The photo reflector 510 is fixed to the sub circuit board 303.

Because of the above configuration of the hinge mechanism, the image capturing unit 101 and the operation unit 102 can rotate with a appropriate friction with the annular spring 504; in addition, the annular spring 504 has the click portion with which it is fixed by the recessed portion (unshown) when it rotates by a predetermined angle so as to fix at a most appropriate position for photographing, for example, at a position of rotation by 90 degrees or −90 degrees. When the image capturing unit 101 rotates by −90 degrees, an image displayed on the display unit 105 is up side down. The image is correctly displayed as the photo reflector 510 detects the rotation to communicate the information of the reverse rotation to a control part of the electronic camera 100, whereby photographing can be performed without a sense of discomfort even if any rotation are given to the image capturing unit 101.

As stated above diversely, the camera is designed to restrict the lens outer diameter within the thickness of the sum of each thickness of the display unit, the memory, the battery and the control circuit board, which are indispensable to recognition and record of images in electronic camera. The lens frame is a case supporting plane and the lens frame is pierced by the guide shaft so as to move back and forth. The cam for moving lens of the zoom lens is disposed at a lateral side of the lens system. These components have a thickness less than the thickness of the liquid crystal, the memory, the battery and the control circuit board. An electronic camera having a thin thickness capable of shoving in a dress shirt breast pocket or a jeans hip pocket can be offered.

Since the image capturing unit is provided with a flash unit on the side of the operation unit of a photographic window, low part of the accepting part of the flash unit is made thin, the display unit of the operation unit is disposed on the side of the image capturing unit and operating buttons are disposed on the opposite side of the image capturing unit of the display unit, the operating buttons can be disposed within the range capable of operating with a thumb when the operation unit is held with a right hand, whereby a convenient electronic camera can be offered.

Further, as operating buttons of the operation unit are provided in a plane of the case, a camera which is taken in and out smoothly if it is shoved into a breast pocket of a dress shirt or a hip pocket of a jeans can be offered.

The cam for moving the lens having a spiral cam groove cam-drives the cam pin inserted into the cam groove. Its cam driving force moves the lens. The cam for moving the lens comprises one cam body which forms one cam plane of the cam groove, another cam body provided non-rotatably and so as to be able to slide to the cam body, which forms another cam plane confronting the one cam plane, and an elastic member contacting the cam pin to the cam plane by pressing the one cam body and/or the other cam body. Thus, the cam groove is formed with the cam plane of the one cam body and the cam plane of the other cam body, and the cam pin inserted into the cam groove contacts cam plane by the spring member pressing these cam body, whereby the electronic camera having the cam apparatus the cam pin of which contacts the cam plane with a definite contact pressure over the whole range of the cam groove can be made.

Further, the cam for moving the lens comprises the cam base body having the sliding portions with a smaller diameter at the both ends of a cylinder, the stepped portion between the one sliding portion and the middle portion of the cylinder as one cam plane of the first cam groove, and the stepped portion between the other sliding portion and the middle portion of the cylinder as one cam plane of the second cam groove; the first cam frame having the other cam plane confronting the one cam plane of the first cam-groove and provided non-rotatably to the one sliding portion so as to be able to slide; the second cam frame provided non-rotatably to the other sliding portion so as to be able to slide; and the elastic member which makes each cam pin inserted into the two cam grooves formed with the first and the second cam frame and the cam base body contact the cam plane by pressing the first and the second cam frames. Thus, the cam grooves are formed by the one cam plane of the one cam body and the other cam plane of the other cam body and the cam groove inserting member inserted into the cam groove presses the cam plane by spring force action of the spring member pressing the one cam body and/or the other cam body.

Further, the cam for moving the lens comprises the cam base body having the sliding portions with a smaller diameter at the both ends of a cylinder, the stepped portion between the one sliding portion and the middle portion of the cylinder as one cam plane of the first cam groove, and the stepped portion between the other sliding portion and the middle portion of the cylinder as one cam plane of the second cam groove; the first cam frame having the other cam plane confronting the one cam plane of the first cam groove and provided non-rotatably to the one sliding portion so as to be able to slide; the second cam frame provided non-rotatably to the other sliding portion so as to be able to slide; and the elastic member which makes each cam pin inserted into the two cam grooves formed with the first and the second cam frame and the cam base body contact the cam plane by pressing the first and the second cam frames. Thus, the cam grooves are formed by the one cam plane of the one cam body and the other cam plane of the other cam body and the cam groove inserting member inserted into the cam groove presses the cam plane by spring force action of the spring member pressing the one cam body and/or the other cam body.

Yet further, the cam for moving the lens comprises the first cylinder on which the sliding portion with a smaller diameter having one cam plane of the first cam groove is disposed, the second cylinder on which the sliding portion with a smaller diameter having one cam plane of the second cam groove is disposed non-rotatably to the first cylinder, the first cam frame which forms the other cam plane confronting the one cam plane of the first cam groove and is provided non-rotatably so as to be able to slide at the sliding portion of the first cylinder, the second cam frame which forms the other cam plane confronting the one cam plane of the second cam groove and is provided non-rotatably so as to be able to slide at the sliding portion of the second cylinder, and the elastic member which cause the each cam pin inserted into the two cam grooves formed by the first and the second cam frames and the cam base body to the cam plane by pressing these first and second cam frames, wherein the cam grove is formed by one cam plane of one cam body and another cam plane of another cam body, and the cam inserting member inserted into the cam groove contact the cam plane by the spring force of the spring member which presses the one cam body and/or the other cam body.

Therefore, the contact pressure of the cam groove inserting member against the cam plane is determined by the spring force of the spring member pushing the cam body so that there is an even contact pressure over whole region of the cam groove. As a result, the cam shaft does not shift to generate no fluctuation of the right moving position of the moving object. As the slanting portion is provided on the cam plane contacting the cam groove inserting member, the cam groove inserting member receives the cam driving force in a direction of the rotational axis of the cam groove together with the pushing force in a direction orthogonal to the rotational axis. More specifically, as the cam groove inserting member receives the above mentioned pushing force by rotation of the cam groove, the electronic camera having the cam apparatus in which the moving object closely contacts the guide shaft and mechanical play between the moving object and the guide shaft is absorbed can be offered.

The first and second cam frames can be pressed with one coil spring by providing the stretching coil spring one end of which is hooked to the first cam frame and the other end of which is hooked to the second cam frame as said elastic member.

As the slanting portion is provided on the cam plane contacting the cam groove inserting member, the cam groove inserting member receives the cam driving force in a direction of the rotational axis of the cam groove together with the pushing force in a direction orthogonal to the rotational axis. More specifically, as the cam groove inserting member receives the above mentioned pushing force by rotation of the cam groove, the moving object closely contacts the guide shaft and a mechanical play between the moving object and the guide shaft is absorbed.

The slanting portion provided on at least one of the one cam plane and the other cam plane preferably has a slanting plane which gives the cam groove inserting member a cam driving force in a direction of the rotational axis of the cam groove and a pressing force in a direction orthogonal to the rotational axis.

One spring member can press the first and second cam frames by the elastic member being the spring member pressing the first and second cam frames and the cam base body or the first cylinder and the second cylinder in one direction.

Since the tensile spring member one end of which is hooked to the first cam frame and the other end of which is hooked to the second cam frame, and the spring member pressing the first and second cam base body in one direction are provided as the elastic members, the cam pin is pressed to the cam plane and the whole cam apparatus is pressed in one direction by pressing the cam base body and the whole body of the first and second cam frame with the spring members, which leads to absorbing a mechanical play of the rotational shaft portion of the cam apparatus.

Thus, the camera is designed to restrict the lens outer diameter within the thickness of the sum of each thickness of the display unit, the memory, the battery and the control circuit board, which are indispensable to recognition and record of images in electronic camera The lens frame is a case supporting plane and the lens frame is pierced by the guide shaft so as to move back and forth. The cam for moving lens of the zoom lens is disposed at a lateral side of the lens system. These components have a thickness less than the thickness of the liquid crystal, the memory, the battery and the control circuit board. An electronic camera having a thin thickness capable of shoving in a dress shirt breast pocket or a jeans hip pocket can be offered.

Since the image capturing unit is provided with a flash unit on the side of the operation unit of a photographic window, low part of the accepting part of the flash unit is made thin, the display unit of the operation unit is disposed on the side of the image capturing unit and operating buttons are disposed on the opposite side of the image capturing unit of the display unit, the operating buttons can be disposed within the range capable of operating with a thumb when the operation unit is held with a right hand, whereby a convenient electronic camera can be offered.

Further, as operating buttons of the operation unit are provided in a plane of the case, a camera which is taken in and out smoothly if it is shoved into a breast pocket of a dress shirt or a hip pocket of a jeans can be offered.

In order to attain a thin optical system, the shutter provided in the optical system of the image capturing unit is preferably square shaped having the same height as that of the lens frame.

The cam for moving the lens having a spiral cam groove cam-drives the cam pin inserted into the cam groove. Its cam driving force moves the lens. The cam for moving the lens comprises one cam body which forms one cam plane of the cam groove, another cam body provided non-rotatably and so as to be able to slide to the cam body, which forms another cam plane confronting the one cam plane, and an elastic member contacting the cam pin to the cam plane by pressing the one cam body and/or the other cam body. Thus, the cam groove is formed with the cam plane of the one cam body and the cam plane of the other cam body, and the cam pin inserted into the cam groove contacts cam plane by the spring member pressing these cam body, whereby the electronic camera having the cam apparatus the cam pin of which contacts the cam plane with a definite contact pressure over the whole range of the cam groove can be made.

Further, the cam for moving the lens comprises the cam base body having the sliding portions with a smaller diameter at the both ends of a cylinder, the stepped portion between the one sliding portion and the middle portion of the cylinder as one cam plane of the first cam groove, and the stepped portion between the other sliding portion and the middle portion of the cylinder as one cam plane of the second cam groove; the first cam frame having the other cam plane confronting the one cam plane of the first cam groove and provided non-rotatably to the one sliding portion so as to be able to slide; the second cam frame provided non-rotatably to the other sliding portion so as to be able to slide; and the elastic member which makes each cam pin inserted into the two cam grooves formed with the first and the second cam frame and the cam base body contact the cam plane by pressing the first and the second cam frames. Thus, the cam grooves are formed by the one cam plane of the one cam body and the other cam plane of the other cam body and the cam groove inserting member inserted into the cam groove presses the cam plane by spring force action of the spring member pressing the one cam body and/or the other cam body.

Yet further, the cam for moving the lens comprises the first cylinder on which the sliding portion with a smaller diameter having one cam plane of the first cam groove is disposed, the second cylinder on which the sliding portion with a smaller diameter having one cam plane of the second cam groove is disposed non-rotatably to the first cylinder, the first cam frame which forms the other cam plane confronting the one cam plane of the first cam groove and is provided non-rotatably so as to be able to slide at the sliding portion of the first cylinder, the second cam frame which forms the other cam plane confronting the one cam plane of the second cam groove and is provided non-rotatably so as to be able to slide at the sliding portion of the second cylinder, and the elastic member which cause the each cam pin inserted into the two cam grooves formed by the first and the second cam frames and the cam base body to the cam plane by pressing these first and second cam frames, wherein the cam grove is formed by one cam plane of one cam body and another cam plane of another cam body, and the cam inserting member inserted into the cam groove contact the cam plane by the spring force of the spring member which presses the one cam body and/or the other cam body.

Therefore, the contact pressure of the cam groove inserting member against the cam plane is determined by the spring force of the spring member pushing the cam body so that there is an even contact pressure over whole region of the cam groove. As a result, the cam shaft does not shift to generate no fluctuation of the right moving position of the moving object. As the slanting portion is provided on the cam plane contacting the cam groove inserting member, the cam groove inserting member receives the cam driving force in a direction of the rotational axis of the cam groove together with the pushing force in a direction orthogonal to the rotational axis. More specifically, as the cam groove inserting member receives the above mentioned pushing force by rotation of the cam groove, the electronic camera having the cam apparatus in which the moving object closely contacts the guide shaft and a mechanical play between the moving object and the guide shaft is absorbed can be offered.

The first and second cam frames can be pressed with one coil spring by providing the stretching coil spring one end of which is hooked to the first cam frame and the other end of which is hooked to the second cam frame as said elastic member.

As the slanting portion is provided on the cam plane contacting the cam groove inserting member, the cam groove inserting member receives the cam driving force in a direction of the rotational axis of the cam groove together with the pushing force in a direction orthogonal to the rotational axis. More specifically, as the cam groove inserting member receives the above mentioned pushing force by rotation of the cam groove, the moving object closely contacts the guide shaft and a mechanical play between the moving object and the guide shaft is absorbed.

The slanting portion provided on at least one of the one cam plane and the other cam plane preferably has a slanting plane which gives the cam groove inserting member a cam driving force in a direction of the rotational axis of the cam groove and a pressing force in a direction orthogonal to the rotaional axis.

One spring member can press the first and second cam frames by the elastic member being the spring member pressing the first and second cam frames and the cam base body or the first cylinder and the second cylinder in one direction.

Since the tensile spring member one end of which is hooked to the first cam frame and the other end of which is hooked to the second cam frame, and the spring member pressing the first and second cam base body in one direction are provided as the elastic members, the cam pin is pressed to the cam plane and the whole cam apparatus is pressed in one direction by pressing the cam base body and the whole body of the first and second cam frame with the spring members, which leads to absorbing mechanical play of the rotational shaft portion of the cam apparatus.

Thus, according to this embodiment, the camera is designed to restrict the lens outer diameter within the thickness of the sum of each thickness of the display unit, the memory, the battery and the control circuit board, which are indispensable to recognition and record of images in electronic camera. The lens frame is a case supporting plane and the lens frame is pierced by the guide shaft so as to move back and forth. The cam for moving lens of the zoom lens is disposed at a lateral side of the lens system. These components have a thickness less than the thickness of the liquid crystal, the memory, the battery and the control circuit board. An electronic camera having a thin thickness capable of shoving in a dress shirt breast pocket or a jeans hip pocket can be offered.

### Second Embodiment

FIG. 1 is an over all view of an electronic camera in this embodiment. FIG. 2 is an illustration of an electronic camera in this embodiment, which shows a photographing state in case a lens is targeted to an object. FIG. 3 is an illustration of an electronic camera in this embodiment, which shows a photographing state in case a lens is targeted to a photographer, him or herself. FIG. 4 is an illustration of an electronic camera in this embodiment, which shows a held state in case a lens is targeted to an object.

In the drawings, 100 is an electronic camera in this embodiment. 101 is an image capturing unit, 102 is an operation unit, 103 is a photographic lens window, 104 is a flash unit window such as a strobe, 105 is a display unit using such as LCD, 106 is a shutter button, 107 is a power button, 108 is a selection and decision key for selecting a function or an item which is displayed on the display unit 105 comprising a cross key and a decision key, 109 is a zoom key which bids optical system zooming and a menu button which changes on and off of a camera mode menu respectively. 111 is a display button, which changes on and off of display contents and light, and 112 is a scene button, which changes a display content of the display unit 105 to a scene selecting screen page respectively. 113 is a mode selecting button which select modes such as an aperture priority mode, a shutter priority mode, sports mode for photographing rapidly moving objects, a macro mode for photographing near objects, strobe control of enforced flashing of strobe or flashing halt, movie shooting and movie play back. 114 is a speaker.

In an electronic camera 100 in this embodiment, as shown in FIG. 1-3, display unit 105, general operational buttons for photographing 106-113 are disposed on the operation unit 102 side to which the image capturing unit 101 is connected rotatably by a hinge mechanism. The photographic lens window 103 is disposed on one side of the image capturing unit 101 and the flash unit window 104 is disposed on the operation unit 102. The operational buttons for photographing 106-113 are provided on the operation unit so as no to project from the surface of the outer cover of the operation unit whereby making one no sense of discomfort or getting hooked when shoving in a breast pocket of a dress shirt or in a hip pocket of jeans. Further, the shutter button 106 is positioned so as to be operable with a pointing finger when the camera 100 is held with a right hand. Further, the shutter button 106 is positioned so as to be operable with a pointing finger when the camera 100 is held with a right hand. The zoom key 109, the selection and decision key 108, the menu button 110, and the mode selecting button 113 are likewise disposed within the reaching distance for a thumb finger when the camera 100 is held with a right hand whereby operationality is upgraded.

Further, in the electronic camera 100 of this embodiment, when a length L1 between the end of the photographic window 103 side and the end of the flash unit window 104 side of the image capturing unit 101 be, for example, a length between a tip of a forefinger of a left hand and near a second arthrosis of the finger, and a length of a reverse side of the photographic lens window be L2, a thickness L3 along a direction of an optical axis of a portion of the flash unit window 104 corresponding to the portion L1-L2 is a thickness of a forefinger and the portion is roundly flared to the operation unit 102 side (see FIG. 3). Thus, a space for disposing operational buttons at the right side of the display unit 105 of the operation unit 102 is secured, whereby the electronic camera can be made small and of a good operationality.

When the electronic camera 100 is used, a power button 107 is pushed to activate the power and each button is operated. Any mode is selected by the menu button 110 with the mode selecting button 113 such as a photographing condition of an aperture priority mode or of a shutter priority mode, a sports mode photographing a body moving rapidly, a macro mode which photographs near objects, a strobe control of enforced flashing or flashing halt, and a movie shooting or movie play back. An item is selected by the selection and decision key 108 comprising a cross key and decision key and decided by pushing a center decision button as needed after displaying a variety of menus such as a size of an image, a photographic sensitivity, and a photometry method on the display unit 105 by pushing the menu button 110.

When the photographic window is pointed at a object as shown in FIG. 2, the operation unit 102 is held with a right hand as shown in FIG. 4 and a portion of L3 (see FIG. 3) of the image capturing unit 101 having a length of L1 (see FIG. 3) is held with a fore finger and a middle finger and the photographic window 103 is pointed at the object. After a predetermined magnification is determined by operating the zoom key 109 of the image capturing unit 101 with a thumb of the right hand while seeing a object displayed on the display unit 105, the shutter button 106 is pushed with a forefinger of the right hand to automatically determine exposure and focus so that a captured image signal by a built-in image capturing element such as CCD is stored in a built-in memory. By photographing in this way, since a distance between the photographic lens window 103 of the image capturing unit 101 and the rotational center of the hinge mechanism is greater than a distance between the rotational center of the hinge mechanism and an end of a reverse side to the photographic window 103, a lens unit is largely rotated so that the image capturing unit can be rapidly pointed at an object and the camera 100 can be held tightly.

Further, in the electronic camera 100 of this embodiment, a self-portrait can be taken by pointing the photographic lens window 103 of the image capturing unit 101 is pointed at a camera operator not only at an object. In this case, since a distance between the photographic lens window 103 side of the image capturing unit 101 and a rotational center of the hinge mechanism is made greater than a distance of the reverse side, though the flared portion, where a window for the flash unit 104 of the image capturing unit 101 is disposed, covers a part of the display unit 105, photographing a self-portrait is possible while confirming an image on the screen by the display unit 105.

After thus photographing, when a mode is turned to a playback mode with a mode selecting button 113, an image signal stored in the memory is displayed on the display unit 105 and captured images can be sequentially displayed on the display unit by operating the cross key of the selection and decision key 108. In case of a movie shooting mode, a movie signal is stored in a memory and is played back together with sound at the same time from the speaker 114 by selecting a necessary scene with the scene button 112.

Thus, in the electronic camera 100 of this embodiment, since the opposite side of the photographic lens window 103 of the image capturing unit 101 can be made thin by the flash unit 104 window being disposed so that the photographic lens window 103 side of the image capturing unit 101 is flared to the operation unit 102 side, a whole camera size can be made the smaller. Further, since the lens can be pointed at an object with a little rotational action by a distance between the photographic lens window 103 side of the image capturing unit 101 and a rotational center of the hinge mechanism being made greater than a distance of the reverse side, a convenient electronic camera can be offered.

As a thickness of the flared portion of the image capturing unit 01 in a direction of the optical axis is approximately equal to a thickness of a finger and a distance between the end of the photographic lens window 103 side and the end of the flared portion side is approximately equal to a length between a tip of a finger and the second arthrosis of the finger, the flared part can be held with two fingers for rotating. Thus, since the operation unit 102 of the electronic camera in this embodiment can be held with the right hand and the flared portion is held with the fore finger and the middle finger of the left hand to point at an object, the camera can be held firmly in the event of photographing and a convenient electronic camera can be offered.

The distance between the photographic lens window 103 side of the image capturing unit 101 and rotational center of the hinge mechanism is such distance that visibility of the display unit 105 is not hindered by the flared portion. Thus, since visibility of the display unit 105 is not hindered even when a camera operator photographs him or herself, an electronic camera capable of easily shooting a self-portrait can be offered.

Further, The opposite side of the photographic lens window 103 in the image capturing unit 101 can be made narrow, by the window of the flash unit 104 being disposed in the flared portion of the image capturing unit 101 of the photographic lens window 103 side.

Thus, since the display unit of the operation unit is disposed at the image capturing unit side and the operating buttons can be disposed at the opposite side of the image capturing unit of the display unit, a convenient electronic camera 100 wherein the display unit can be seen while the operating buttons are operated can be offered.

Further according to this embodiment in an electronic camera comprising an operation unit having a display unit and an image capturing unit connected rotatably to the operation unit by a hinge mechanism and provided with a flash unit and a photographic zoom lens for communicating an image to the display unit, the photographic window side of the image capturing unit is flared to the operation side for disposing the flash unit and the distance between the photographic window side and the rotational center of the hinge mechanism is greater than that of the opposite side.

When the photographic window side of the image capturing unit is thus flared to the operation side and the flash unit is disposed, the side opposite to the photographic lens in the image capturing unit can be made thin so that the whole camera size becomes small. Further, because the distance between the photographic window side and the rotational center of the hinge mechanism is greater than that of the opposite side, the lens can be targeted at an object with a small rotational action in the image capturing unit so that a convenient electronic camera is provided.

A thickness of the flared portion of the image capturing unit in a direction of the optical axis is approximately equal to a thickness of a finger and a distance between the end of the photographic lens window side and the end of the flared portion side is approximately equal to a length between a tip of a finger and the second arthrosis of the finger so that the flared part can be held with two fingers for rotating. Thus, since the operation unit of the electronic camera in this embodiment can be held with the right hand and the flared portion is held with the fore finger and the middle finger of the left hand to point at an object, the camera can be held firmly in the event of photographing and a convenient electronic camera can be offered.

The distance between the photographic lens window side of the image capturing unit and rotational center of the hinge mechanism is such distance that visibility of the display unit is not hindered by the flared portion. Thus, since visibility of the display unit is not hindered even when a camera operator photographs him or herself, an electronic camera capable of easily shooting a self-portrait can be offered.

Further, The opposite side of the photographic lens window in the image capturing unit can be made narrow, by the window of the flash unit being disposed in the flared portion of the image capturing unit of the photographic lens window side. Thus, since the display unit of the operation unit is disposed at the image capturing unit side and the operating buttons can be disposed at the opposite side of the image capturing unit of the display unit, a convenient electronic camera wherein the display unit can be seen while the operating buttons are operated can be offered.

As described above, according to this embodiment, since the opposite side of the image capturing unit 101 to the photographic lens window 103 side can be made narrow by disposing the flash unit 104 at the flared to the operation unit 102 portion of the photographic lens window 103 side of the image capturing unit 101, the whole electronic camera 100 size can be made the smaller. In addition, since a distance between the photographic lens window 103 side and the rotational center of the hinge mechanism is made greater than that of the opposite side, the image capturing unit 101 can be pointed at an object by a little rotational action so that a convenient electronic camera can be offered.

### Third Embodiment

As a rate reducing device comprises an integrated gear configuration having a lot of rate reducing gears for a interlocking system of a power mechanism such as a cam or lead screw and a motor, the smaller or the thinner becomes a camera form, the more complicated becomes a gear configuration because of restriction of the space for mounting and disposing the rate reducing device.

Further, as rate reducing device becomes big when a lot of rate reducing gears are integrally disposed, a mounting space of the rate reducing device becomes a problem particularly when a camera is made thin, which leads to a limited miniaturisation of a camera.

The object of this embodiment is to propose a camera and an optical zoom mechanism provided with a rate reducing device capable of mounting even in a small or thin camera in view of the above mentioned actual situation.

Now, a third embodiment according to the present invention is explained referring to the drawings as follows.

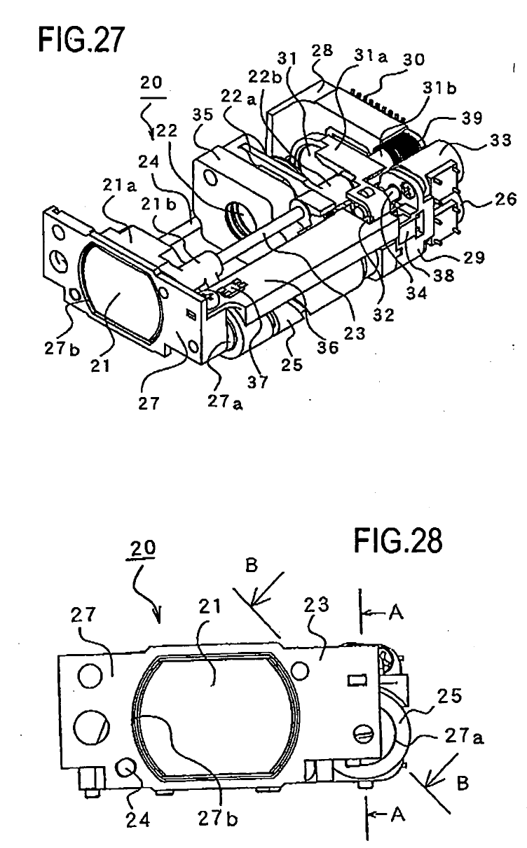

FIG. 27 is a perspective illustration showing one embodiment of a driving mechanism for zooming. FIG. 28 is a front elevational view of the above driving mechanism for zooming.

In the drawings, 21 is a first lens group and 22 is a second lens group. The first and second lens frames 21, 22 are supported by a guide shaft 23 which is pierced so as to be able to slide to a boss 21b provided on a lens frame 21a and to a boss 22b provided on a lens frame 22a.

Holes are provided at the opposite position to the bosses 21b, 22b on the lens frames 21a, 22a and a guide shaft 24 is pierced to these holes so as to be able to slide to prevent rotation of the lens groups 21, 22.

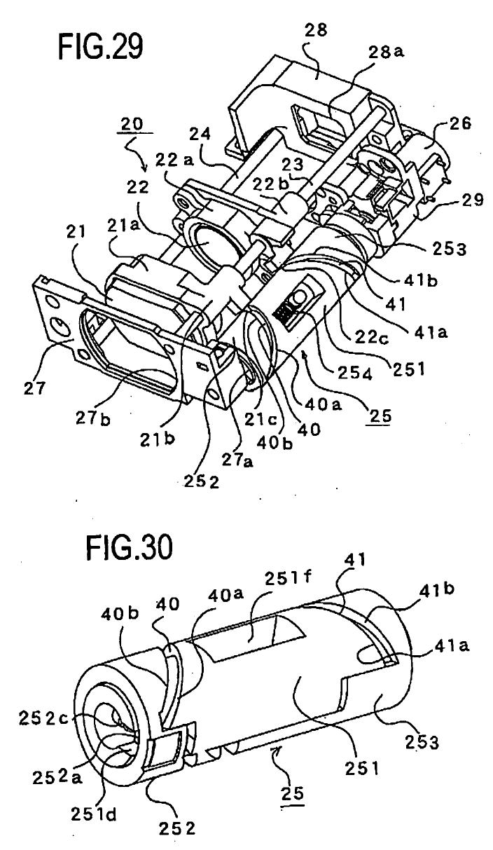

Further, a cam pin (a cam groove inserting member) 21c of the first lens group 21 formed projectingly on the above boss 21b and a cam pin (a cam groove inserting member) 22c of the second lens group 22 formed projectingly on the boss 22b are inserted into the cam groove of the cam for zooming 25 so that the first and second lens groups are cam driven along the optical axis according to rotation of the cam for zooming 25 (see FIG. 29). The cam for zooming 25 is rotatively driven by a motor for zooming 26

One end of the guide shaft 23, 24 is fixed to a front fixing frame 27 and another end is fixed to a rear fixing frame 28. The cam for zooming 25 is rotatably supported by a bearing portion 27a of the front fixing frame 27 and a bearing portion 29a (see FIG. 18) of a supporting fixing frame 29 fixed to the rear fixing frame 28.

Window holes 27b, 28a through which object image light passes are formed on the front fixing frame 27 and the rear fixing frame 28. Further, a CCD (an solid image forming element) is mounted in right after the window of the rear fixing frame 28 (see FIG. 27, 29).

While, a third lens group 31 shown in FIG. 27 is a lens for focusing and is supported by piercing the guide shaft 23 to a boss 31a provided on the lens frame 31a. The third lens group 31 is screw-driven by a lead screw 34 rotatively driven with a motor for focusing 33 to advance and retreat along the optical axis.

Besides, referring to FIG. 27, 35 is a shutter unit fixed to the lens frame 22a; 36 is a cover plate; 37 is a photo interrupter for zooming; 38 is a photo interrupter for focusing; and 39 is a spring for preventing a play of the third lens group 31, the spring which presses the boss in one direction to absorb the play between the lead screw 34 and a nut 32. The photo interrupter for zooming 37 detects an initial position for zooming and the photo interrupter for focusing detects an initial position for focusing.

In the above configured driving mechanism for zooming of the photographic lens, the first and second lens group 21, 22 moves for zooming by driving rotatively the cam for zooming 25 with the motor for zooming 26 and the third lens group 31 moves for focusing by driving rotatively the lead screw 34 to screw-drive the nut screw 32.

In addition, the third lens group 31 also moves at the time of zooming.

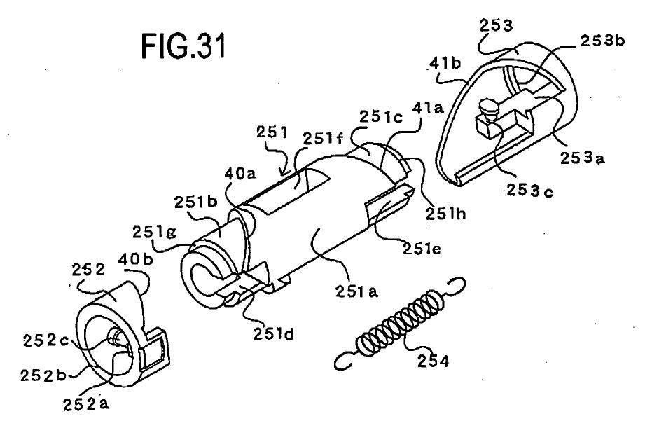

The cam 25 for zoom with which the above mentioned driving mechanism for zooming 20 is equipped as a cam apparatus on the other hand is explained with reference to FIG. 29, FIG. 30, and FIG. 31.

FIG. 31 is the same perspective illustration of a cam for zooming as FIG. 27 when the third lens group, the motor for focusing 33, the shutter unit 35, the cover plate 36 and so on are removed for showing. FIG. 30 is a perspective illustration of a cam for zooming 25. FIG. 31 is an exploded perspective illustration of a cam for zooming.

As shown in the drawing, the cam 25 for zooming is a cylindrical cam having a first cam groove 40 and a second cam groove 41 and comprises a cylindrical cam base body 251, cylindrical cam frames 252, 253 which fit the both sides of the cam base body 251 so as to be able to slide, and a tensile coil spring 254 pressing the cam frames 252, 253 in a direction for approaching each other.

A cam base body 251 has a sliding portions 251b, 251c having a smaller portion at the both sides of the middle portion 251a. One cam plane 40a is formed for forming a first cam groove 40 at a stepped portion between the middle portion 251a and the sliding portion 251b. One cam plane 41a is formed for forming a first cam groove 41 at a stepped portion between the middle portion 251a and the sliding portion 251c.

The cam base body 251 has long holes 251d, 251e along an axial direction from the both ends, into which protruded portions 252a, 253a are fit so as to be able to slide, whereby the cam frames 252, 253 are rotated together with the cam base body 251. A hole portion 251f formed at the ends of sliding portion 251b, 251c is to attach a coil spring 254. Stepped portions 251g, 251h are to restrict movement of a cam frame 252, 253.

Meanwhile, a cam frame 252 has another cam plane 40b for forming a first cam groove 40 at one end circumference portion and further has a pointing inner flange 252b. The cam frame 252 has a spring hooking portion 252c projected from the protruded portion 252a in the cylinder.

A cam frame 253 has another cam plane 41b for forming a first cam groove 41 at one end circumference portion and further has a pointing inner flange 253b. The cam frame 253 has a spring hooking portion 253c projected from the protruded portion 253a in the cylinder.

With regard to the cam base body 251, the cam frames 252, and 253, after the cam frame 252 is fit to the sliding portion 251b of the cam base body 251 and the cam frame 253 is fit to the sliding portion 251c, one end of coil spring 254 is hooked to the spring hooking portion 252c of the cam frame 252 and another end is hooked to the spring hooking portion 253c of the cam frame 253.

Then the coil spring 254 presses the cam frame 252 and 253 in a direction of approaching each other so that the flange portion 252b advances until it strikes the stepped portion 251g as the cam frame 252 slides the sliding portion 251b. With this state, the first cam groove is formed by the one cam plane 40a and the other cam plane 40b.

Likewise, the cam frame 253 slides the sliding portion 251c and the flange portion 253b advances until it strikes the stepped portion 251h so that the second cam groove is formed by the one cam plane 41a and the other cam plane 41b with this state.

Thus formed cam grooves 40, 41 become spring shaped cam grooves matched with movement of the first and second lens groups 21, 22 necessary to zooming.

As shown in FIG. 29, in the cam for zooming 25 configured as described above, the cam pin 21c of the first lens group 21 is inserted into the cam groove 40 and the cam pin 22c of the second lens group 22 is inserted into the cam groove 41. By the insertion of the cam pins 21c, 22c like this way, the flange portion 252b of the cam frame 252 retreats a little from the stepped portion 251g and likewise, the flange portion 253b of the cam frame 253 retreats a little from the stepped portion 251h.

Therefore, since the cam pin 21c is pressed to the cam plane 40b of the cam frame 252 and the cam pin 22c is pressed to the cam plane 41b of the cam frame 253, the cam pins 21c, 22c contact to the cam plane with a definite contact pressure over the whole region of the cam grooves 40, 41. A contact pressure of the cam pins 21c, 22c to the cam plane can be determined by a tensile force of the coil spring 254. A most appropriate contact pressure of the cam pins 21c, 22c is available when the coil spring 254 having an appropriate tensile force is chosen.

Thus, the cam for zooming 25 can be rotated with a definite motor driving force and the first and the second lens groups 21, 22 can be smoothly driven for moving. As a result, the cam for zooming 25 becomes a cam apparatus having a light load of small fluctuation so that a small and power-saving motor can be used as a motor for zooming 26.

FIG. 18 is a cross sectional drawing showing a cross section of the cam for zooming 25 and its driving system by cutting by the A-A line of FIG. 28.

As shown in the drawing, a cam for zooming 25 of this second embodiment is explained. An inner gear 42 is provided at a rear end side of the cam for zooming 25. A protruded portion 42a of the inner gear is inserted into an inner hole of the cam base body 251. A key 42b provided at a circumferential portion of the protruded portion 42a fits in a key groove 251i formed in an inner hole portion of the cam base body 251.

Accordingly, the cam for zooming 25 rotates together with the inner gear 42.

The inner gear 42 is rotatably supported by a bearing portion 29a provided on a supporting fixing frame 29 and further engages a small coupling gear 43.

The small coupling gear 43, which is driven by the motor for zooming 26 through a rate reducing device 44, rotates the inner gear 42 to rotate the cam for zooming 25.

In the driving mechanism for zooming 20 carried out as above, the cam pins 21c, 22c exert a definite contact pressure over the whole region of the first and second cam groove 40, 41; the width in a lateral direction of the camera (width in a direction of left and right in FIG. 28) can be shortened in addition; and further the first and second lens groups 21, 22 for zooming and the third lens group 31 are movably supported with the same guide shafts 23 so that the lens groups are difficult to fall or become eccentric.

FIG. 19 shows a driving mechanism for zooming 50 of the second embodiment.

The driving mechanism for zooming 50 is characterized in that the other cam planes 40b, 41b formed on the cam frames 252, 253 are slanted at an predetermined angle, though, other features are the same as the driving mechanism for zooming 20 shown in FIG. 27-28.

FIG. 19 corresponds to a cross sectional view by the b-b line in FIG. 28.

FIG. 20 is a FIG. 20 is a partially enlarged cross sectional drawing showing a configured portion formed by the first and second cam grooves 40, 41 together with the cam pins 21c, 22c. As seen in the drawing, the other cam planes of the first and second cam frames 252, 253 are formed as slanting cam planes having a rising gradient to the periphery of the frame.

The cam pins 21c, 22c receive a pushing force in a direction of F1 shown in the drawing because the other cam planes 40b, 41b are formed as slanting planes. That is, as a spring force in a direction of F2 shown in the drawing is exerted to the first and second cam frames 252, 253 with the coil spring 254, the first and second cam frames receive a pressing force F1 in a direction orthogonal to the rotational axis of the cam groove in addition to the contact pressure of the cam pins 21c, 22c pressed by a slanting plane of the other cam planes 40b, 41b to the one cam plane 40a, 41a.

The above mentioned pressing force F1 which acts on the cam pins affects in such a manner that hole plane portions of supporting holes 21d, 22d of the bosses 21b, 22b (see FIG. 20) contacts the guide shaft 23 so as to absorb mechanical play between the supporting shaft holes 21d, 22d and the guide shaft 23.

In the cam for zooming 25 as configured above, the cam pins 21c, 22c contact a whole region of the first and second cam grooves 40, 41 with a definite contact pressure and are driven to move in a direction of the rotational axis of the cam groove according to rotation of the cam for zooming 25 so that the first and second lens groups 21, 22 move along the guide shaft 23.

Further, since the bosses 21b, 22b slide the guide shaft 23 without mechanical play as mentioned above, the second lens groups 21, 22 do not become slanting or eccentric. As a result, the driving mechanism for zooming has a cam for zooming 25 (cam apparatus) capable of upgrading zooming accuracy.

FIG. 21(A), (B), (C) are cross sectional drawings showing other embodiments similar to FIG. 20 wherein a slanted position of the cam plane of the first and second cam grooves 40, 41. FIG. 21(A) is a cross sectional drawing showing one cam planes 40a, 41a of the first and second cam grooves 40, 41, which are formed slantingly. FIG. 21(B) is a cross sectional drawing showing one cam planes 40a, 41a and other cam planes 40b, 41b of the first and second cam grooves 40, 41, which are formed slantingly. FIG. 21(C) is a cross sectional drawing showing other cam planes 40b, 41b of the first and second cam grooves 40, 41 and cam pins 21c, 22c, which are formed slantingly.

Since a pressing force F1 acts to the cam pins 21c, 22c in the event of the above configuration, play between the bosses 21b, 22b and the guide shaft 23 can be absorbed similarly to the embodiment shown in FIG. 20 so that slant or eccentricity of the first and second lens groups 21, 22 can be prevented.

Further, when the both cam planes are formed slantingly as shown in FIG. 21(B), smoother zooming action can be realized compared to the one with one slanted cam plane.

Also in the embodiment shown in FIG. 20, FIG. 21(A), (B), the contact portion of the cam pins 21c, 22c, which contact the cam plane may be formed slantingly.

FIG. 22 shows another embodiment of a driving mechanism using a cam for zooming 25 of this third embodiment. FIG. 22 shows a driving mechanism in which a coil spring 45 is provided at a bearing portion 27a of a front fixing frame 27 in order to absorb a bearing play of the cam for zooming 25. The coil spring 45 enhances an accuracy of the moving position of the first and second lens groups 21, 22 preventing from movement of the cam for zooming 25 in a direction of the rotational axis by pressing the cam for zooming 25 in one direction.

FIG. 23 shows an embodiment wherein a bearing play of the cam for zooming 25 and first and second cam frames 252, 253 is pressed with a coil spring 46 by providing a coil spring 46 at a bearing part 27a of a front fixing frame 27.

This embodiment is configured in such a manner that a cam base body 251 is pressed through a cam pin 21c by pressing a first cam frame 252 and a second cam frame 253 is pressed in one direction through a cam pin 22c. With this configuration, a coil spring 254 hooked between the cam frames 252 and 253 becomes unnecessary.

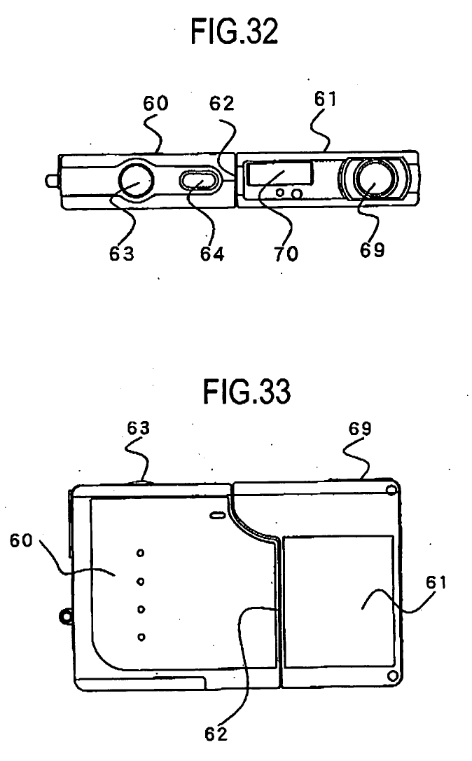

FIG. 32-34 show a zooming mechanism similar to the zooming mechanism 20 or 50 described above for a lens barrel less electronic camera (digital camera) having no lens barrel as an example.

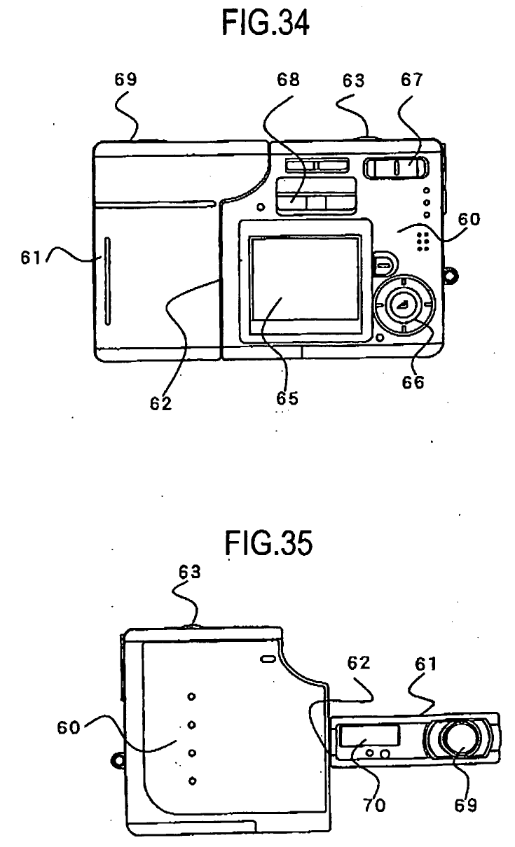

FIG. 32 is a camera plan view. FIG. 33 is a camera front elevational view. FIG. 34 is a camera rear elevation view of an electronic camera shown in FIG. 32.

As shown in the drawings, the electronic camera has a form having a big longitudinal and transversal width and a small depth in a front view so that the camera is thin.

The electronic camera has two separate box-like bodies as a camera main body 60 provided with a controller, a memory card, a computing part, a memory card slot and others and as an optical system installed part 61 provided with a photographic lens and others.

And the camera main body 60 is rotatably within reasonable bounds coupled with the optical system installed part 61 by a coupling part 62.

As shown in the drawing, on the upper plane of the camera main body 60, a shutter button and a power switch are provided; on the back plane of the camera main body 60, a liquid crystal monitor 65, selection and decision button 66, a zoom button 67, mode selecting button 68 and others are provided; further, various circuit boards including a CPU, a battery which supplies electric power, a memory card slot are installed in the camera main body 60 (unshown).

Further, a photographic lens window 69 and a flash window of a flash unit 70 are provided on the upper plane of the optical system installed part 61, and a zooming mechanism part 20, 50, 90 and a flash unit 80 stated later are installed by shielding light in the optical system installed part 61.

Thus, while disposing a display unit, an operation unit, a battery, a memory card slot, and a circuit board in the camera main body 60, thin shape of the whole camera is realized by integrating an optical mechanism and the flash unit 80 in the optical system installed part 61.

Since the above mentioned electronic camera is a very thin type of camera, it is convenient to carry.

On the other hand, when taking a photograph, as shown in FIG. 35 for example, the optical system installed part 61 is rotated so that the photographic lens window 69 points at the front.

Since the camera main body 60 is grasped by hand and the shutter can be released in this state, the camera shake scarcely occurs with this camera.

Moreover, as the optical system installed part 61 can be rotated to an opposite side to that shown in FIG. 35, it can be pointed at the same direction as the liquid crystal monitor 65 for photographing.

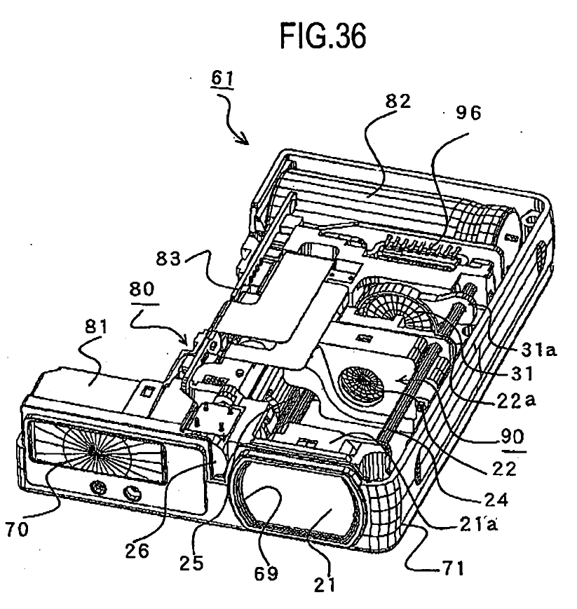

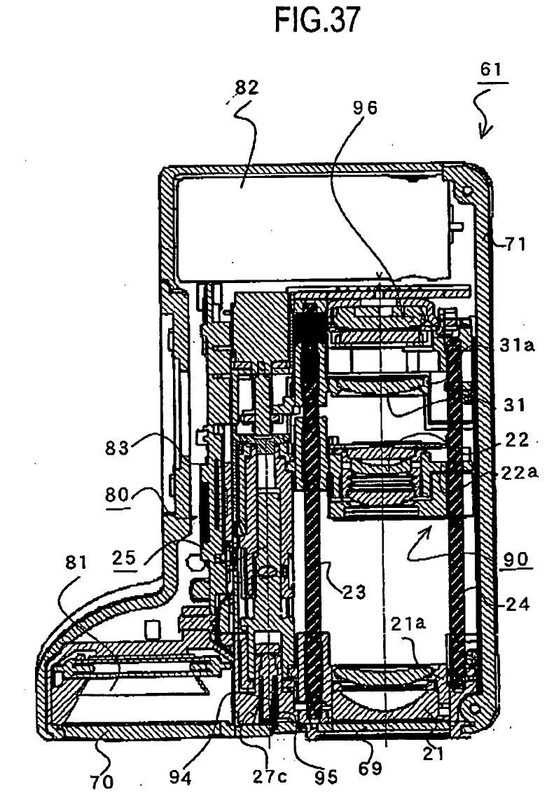

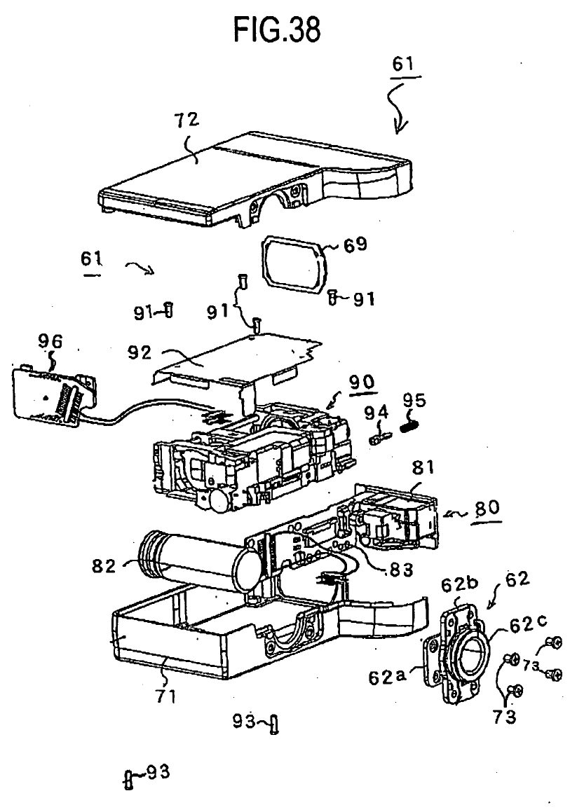

FIG. 36 is a perspective illustration of an optical system installed part 61 when a rear case is removed. FIG. 37 is a transverse sectional view of the above optical system installed part. FIG. 38 is an exploded perspective illustration of the above optical system installed part 61.

As seen in these drawings, the optical system installed part 61 has a flash unit 80 and a driving mechanism for zooming (a optical system unit) 90 of photographic lenses mounted in a box like front case (camera case) 71 so as to be a lens barrel less type having no lens barrel. The above units and others are installed by shielding light.

Therefore, the optical system installed part 61 is restricted to a thickness defined by a height of the optical unit which formed thin so that a thin type of camera is realized.

The flash unit 80 resides in the innermost portion of the flash part 81 and the front case 71 and has a main condenser 82 disposed adjacently at the rear of the optical system unit and a circuit board 83 at the side of the optical system unit in the front case 71.

The driving mechanism for zooming 90 is disposed in the frond case 71 by screwing with small screws 91. A photographing image light enters in an image capturing optical system consisting of the first, second and third lens groups 21, 22, 31 through the photographic lens window 69.

In addition, the cover 92 which prevents invasion of solder waste, dust, and others is provided on the driving mechanism for zooming 90.

As mentioned above, the rear case 72 is fixed with a screw to the front case 71 to which the flash unit 80 and driving mechanism for zooming 90 are mounted.

More particularly, as shown in FIG. 38, the rear case 72 is fixed to the front case 71 with the small screw 93 which is inserted into the one side of the rear case 72 from the front case 71. The other side of the rear case 72 is screwed with the one side of a tongue flange 62a of the coupling part 62.

That is, the one side of the tongue flange 62 of the coupling part 62 is fixed with a small screw 73 to the front case 71 and rear case 72 so as to unite together.

In addition, the other side of the tongue flange 62b of the coupling part 62 is screwed to the case of the camera main body 60, with a tubular portion 62c of which the camera main body 60 couples rotatably with the optical system installed part 61 and through the tubular portion, two parts are electrically connected with wire.

Further, 94 shown in FIG. 38 is a cam pushing pin; 95 is a cam spring; and 96 is a image capturing unit; these are described later.

The above optical system installed part 61 is unnecessary to provide a lenses barrel and can be made with a depth fit to the lens diameter so as to be appropriate to a very thin type electronic camera.

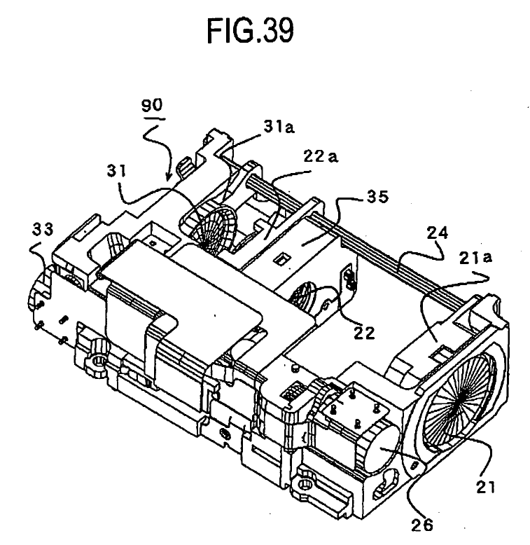

FIG. 39 is a perspective illustration of the driving mechanism for zooming 90.

This driving mechanism for zooming 90 has a configuration similar to the driving mechanism for zooming 20 or 50. Only what is different in this driving mechanism for zooming is that the cam for zooming 25 is disposed at the left side of the photographic lens groups and the motor for zooming 26 is disposed in front, the motor for focusing is disposed in rear.

A thinner camera than a camera in which two motors are disposed as overlapped can be obtained in this way by disposing the motor for zooming 26 and the motor for focusing 33 separately at front side and rear side. Further, electro magnetic interference between two motors can be avoided.

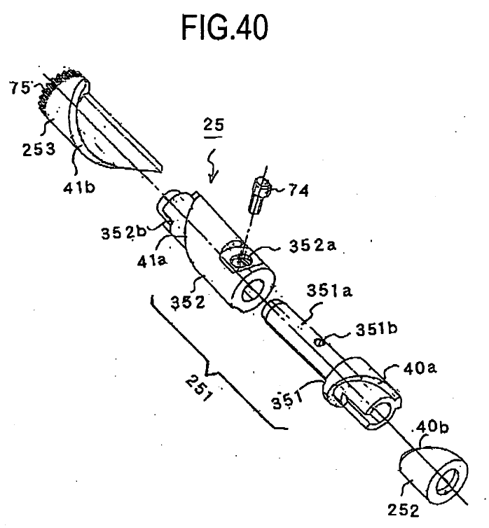

As for a cam for zooming 25, as shown in FIG. 40, a cam base body 251 is formed from two cylinder type base bodies 351, 352. More particularly, an inserting shaft portion 351a of the cylinder type base body 351 is inserted into a cylinder type base body 352 and an eccentric pin 74 is inserted through a hole portion 352a of the cylinder type base body 352 to fix to a pin hole of the inserting shaft portion 351a so that these cylinder type base bodies 351, 352 are combined together.

That is, the distance between the one cam plane 40a formed on the cylinder type base body 351 and the one cam plane 41a formed on the cylinder type base body 352 is finely adjusted by rotating the eccentric pin 74 for adjusting an inserted depth of the inserting shaft portion 351a.

In addition, as already stated above, the first and second cam groove 40, 41 are formed by the one cam planes 40a, 41a and the other cam planes 40b, 41b of the cam frame 252, 253.

Meanwhile, a pin receiving umbo 252e is projectingly formed toward the inner portion on the cam frame 252 of the cam for zooming 25 so as to slide in a long hole 351c of the cylinder type base body 351. The cam frame 252, 253 and the cam base body 251 are pressed in one direction by pressing the pin receiving umbo 252e with the cam pressing pin 94.

As shown in FIG. 37, the cam pressing pin 94 is inserted through a hole 27c of a front fixing frame 27 and its tip is contacted to the pin receiving umbo 252e. Pressing force is given to the cam pressing pin 94 by a cam spring 95 provided in the above hole 27c. The cam pressing pin 94 and the cam spring 95 are prevented to come off with a plate extended from the flash part 81.

In the cam for zooming 25, the cam frame 253 rotates together with the cylinder type base body 352 by fitting a protruded portion of a key provided in it to a key groove 352b.

Also provided is the cam frame 252 with an interlocking gear 75 which is driven through a rate reducing device 44 with a motor.

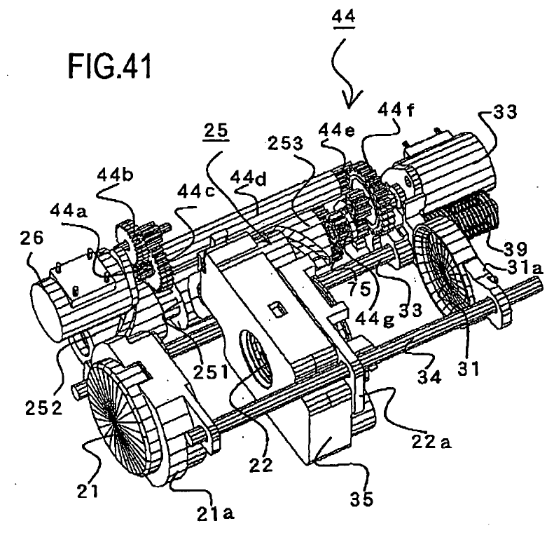

The rate reducing device 44 of the driving mechanism for zooming 90 is, as shown in FIG. 41, comprises a front gear group and a rear gear group. The front gear group comprises a gear 44b a large diameter gear portion of which is engaged with a pinion 44a of the motor for zooming 26 and a gear 44c which is engaged with a small diameter gear portion of the gear 44b.

In addition, a gear 44c is provided at the front end of a rotational axis rod 44d through which the rear gear group is interlocked.

The rear gear group comprises a gear 44e provided at the rear end of the rotational axis rod 44d, a gear 44f a large diameter gear portion of which engages the gear 44e, and a gear 44g a large diameter gear portion of which engages a small diameter gear portion of the gear 44f. An interlocking gear 75 of the cam frame 253 engages the small diameter gear portion of the gear 44g.

Since gear groups comprises the front gear group and the rear gear group, a place for the rate reducing gear is divided into two, the rate reducing device 44 can be fit with the photographic lens diameter so as to be appropriate for making a thin optical system absorption part 61.

To explain more particularly, in order to secure an enough rate reducing ratio for disposing a whole reducing gears in one place, a rate reducing gear group needs to be extendedly disposed in a direction of zooming of the mechanism for zooming, which leads to a long mechanism for zooming to prevent miniaturization.

Also in order to secure an enough rate reducing ratio without changing a length, the gear needs to be big in diameter so that a rate reducing device fit to a diameter of the lens can not be realized, which result in preventing miniaturization.

FIG. 11 is an exploded perspective view of an image capturing unit 96. The image capturing unit 96 comprises a holder 354, a mask 353, a filter (LPF) 352, a rubber 351, a CCD 320, a plate 355 and a circuit board 358. More particularly, the image capturing unit 96 is configured in such a manner that the mask 353, the filter 352, the rubber 351 and the CCD are disposed between the holder 354 and the plate 355, the holder 354 is fixed to the plate with a small screw 356 to form one unit, after that the CCD 320 is electrically connected to the circuit board 358, and the circuit board 358 is fixed.

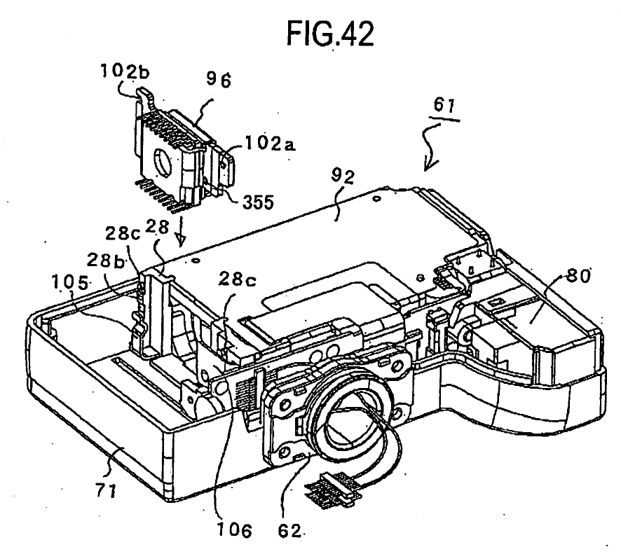

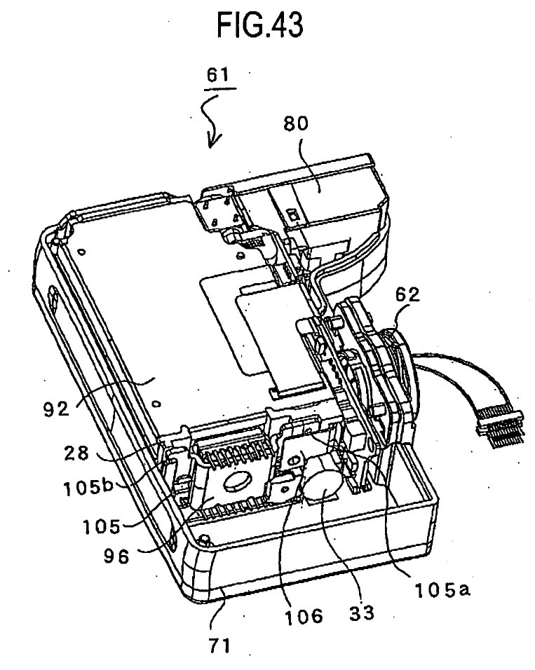

The image capturing unit 96 made in this way is fixed to the rear fixing frame 28 of the driving mechanism for zooming 90, as shown in FIG. 42 and FIG. 43.

More particularly, the rear fixing frame 28 has a standard plane 28b and a fixing prong 28c and leaf springs 105, 106 which hold the image capturing unit 96 are attached to the rear fixing frame 28.

Therefore, when flange portions of the plate 355 are inserted between the standard plane 258b and the leaf springs 105, 106, the one fixing prong 28c plunges in a fixing hole 102a of the plate 355 and the other fixing prong 28c catches the a fixing groove 102b of the plate 355 so that the image capturing unit 96 is fixed by the elastic holding force of the two leaf springs 105, 106.

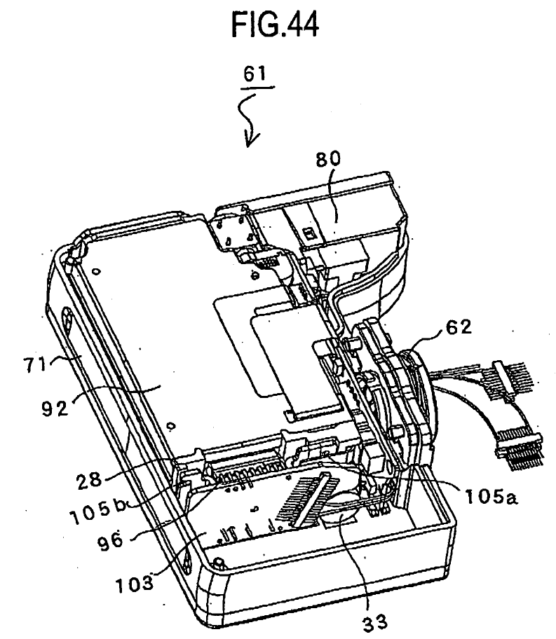

Though FIG. 42, 43 shows a state in which the circuit board 358 is taken off, the image capturing unit 96 is actually attached as shown in FIG. 44.

Though one embodiment of the present invention is explained above, the optical zoom mechanism of this embodiment can be executed on other optical instruments not limited to the camera. Further, this can also be executed a cam body comprising a cam base body 251 and one cam frame 252 (or 253). In this case, a gear is provided on the cam base body 251 or cam frame 252 to engage a first rate reducing gear. As another embodiment, the first rate reducing gear can be caused to mesh with an inner gear 42 provided to the cam for zooming 25 shown in FIG. 30.

Further, a rate reducing device 44 provided to the interlocking system between the cam for zooming 25 of the driving mechanism for zooming of the photographic lens and the motor for zooming 26 has been explained. It can carry out similarly as a rate reducing device of a cam for zooming which zooms a zooming lens of a finder or a flash unit or a lead screw which zooms.

Further, in the above mentioned optical zoom mechanism, the zoom lens is driven by inserting a cam groove inserting member provided on the holding frame into a spiral cam groove of the cam body, the cam body comprises one cam body which forms one cam plane and another cam body which forms another cam plane, which is provided non-rotatably so as to be able to slide and which forms another cam plane confronting the one cam plane, and the cam body further comprises a forcing device which contact the cam groove inserting member to the cam plane by pressing one cam body and/or another cam body.

Further, in this embodiment, an optical zoom mechanism is proposed, which drives the zoom lens by inserting the cam groove inserting member provided on the holding frame into the spiral cam groove of the cam body wherein the cam body comprises a cam base body having a first spiral cam groove, a second spiral cam groove, a sliding portion having a smaller diameter at both ends of a cylinder, one cam plane of the first cam groove which is provided at a stepped portion between one sliding portion and the middle portion of the cylinder, and one cam plane of the second cam groove which is provided at a stepped portion between another sliding portion and the middle portion of the cylinder; another cam plane confronting the one cam plane of the first cam groove; a first cam frame provided non-rotatably so as to be able to slide on the one sliding portion; another cam plane confronting the one cam plane of the second cam groove; a second cam frame provided non-rotatably so as to be able to slide on the other sliding portion; and further a forcing device which contact a cam groove inserting member to the cam plane by pressing the first cam frame and the second cam frame, the cam groove inserting member inserted into two cam grooves which formed with the first cam frame, the second cam frame and the cam base body.

Further, in this embodiment, an optical zoom mechanism is proposed, which drives the zoom lens by inserting the cam groove inserting member provided on the holding frame into the spiral cam groove of the cam body wherein the cam body comprises a cam base body which is constructed by connecting one base body part having a first spiral cam groove, a second spiral cam groove, a sliding portion having a smaller diameter at one end of a cylinder, and one cam plane of the first cam groove which is provided at a stepped portion between one sliding portion and the middle portion of the cylinder to another base body part having a sliding portion having a smaller diameter at one end of a cylinder, and one cam plane of the second cam groove which is provided at a stepped portion between one sliding portion and the middle portion of the cylinder; another cam plane confronting the one cam plane of the first cam groove; a first cam frame provided non-rotatably so as to be able to slide on the one sliding portion; another cam plane confronting the one cam plane of the second cam groove; a second cam frame provided non-rotatably so as to be able to slide on the other sliding portion; and further a forcing device which contact a cam groove inserting member to the cam plane by pressing the first cam frame and the second cam frame, the cam groove inserting member inserted into two cam grooves which formed with the first cam frame, the second cam frame and the cam base body.

Further, in this embodiment, a camera having an optical zoom mechanism is proposed, the optical zoom mechanism comprising a zoom lens, a holding frame which holds the zoom lens, a rotational axis rod having gears at the both end thereof, a first group of rate reducing gears which engage the gear at one end of the rotational axis rod, a second group of rate reducing gears which engage the gear at another end of the rotational axis rod, a cam body driven by the first rate reducing gears, and a motor which drives the second group of rate reducing gear, whereby zooming is performed by moving the holding frame with the cam body to focus a photographic image on the image capturing element

Further, in this embodiment, a camera is proposed, wherein, in the optical zoom mechanism, the zoom lens is driven by inserting a cam groove inserting member provided on the holding frame into a spiral cam groove of the cam body, the cam body comprising one cam body which forms one cam plane and another cam body which forms another cam plane, which is provided non-rotatably so as to be able to slide and which forms another cam plane confronting the one cam plane, and the cam body further comprising a forcing device which contact the cam groove inserting member to the cam plane by pressing one cam body and/or another cam body.

Further, in this embodiment, a camera is proposed, wherein, in the optical zoom mechanism, the zoom lens is driven by inserting a cam groove inserting member provided on the holding frame into a spiral cam groove of the cam body, the cam body comprising a cam base body having a first spiral cam groove, a second spiral cam groove, a sliding portion having a smaller diameter at both ends of a cylinder, one cam plane of the first cam groove which is provided at a stepped portion between one sliding portion and the middle portion of the cylinder, and one cam plane of the second cam groove which is provided at a stepped portion between another sliding portion and the middle portion of the cylinder; another cam plane confronting the one cam plane of the first cam groove; a first cam frame provided non-rotatably so as to be able to slide on the one sliding portion; another cam plane confronting the one cam plane of the second cam groove; a second cam frame provided non-rotatably so as to be able to slide on the other sliding portion; and further a forcing device which contact a cam groove inserting member to the cam plane by pressing the first cam frame and the second cam frame, the cam groove inserting member inserted into two cam grooves which formed with the first cam frame, the second cam frame and the cam base body.

Further, in this embodiment, a camera is proposed, wherein the cam body comprises a cam base body which is constructed by connecting one base body part having a first spiral cam groove, a second spiral cam groove, a sliding portion having a smaller diameter at one end of a cylinder, and one cam plane of the first cam groove which is provided at a stepped portion between one sliding portion and the middle portion of the cylinder to another base body part having a sliding portion having a smaller diameter at one end of a cylinder, and one cam plane of the second cam groove which is provided at a stepped portion between one sliding portion and the middle portion of the cylinder; another cam plane confronting the one cam plane of the first cam groove; a first cam frame provided non-rotatably so as to be able to slide on the one sliding portion; another cam plane confronting the one cam plane of the second cam groove; a second cam frame provided non-rotatably so as to be able to slide on the other sliding portion; and further a forcing device which contact a cam groove inserting member to the cam plane by pressing the first cam frame and the second cam frame, the cam groove inserting member inserted into two cam grooves which formed with the first cam frame, the second cam frame and the cam base body.

When the above mentioned optical zoom mechanism or the camera is activated with a motor, since the first rate reducing gear group is rotatively driven to communicate a rotational driving force to the rotational axis rod first of all, the second rate reducing gear group which interlocks with the rotational axis rod receives the rotational driving force. Therefore, a power mechanism is rotated by interlocking with the second rate reducing gear so as to zoom the optical system.

Regarding thus constructed optical zoom mechanism or camera, each gear construction of the first or second rate reducing gear does not become large because a rate reducing gear group of the first and second is divided into two gear groups. Therefore, two mounting spaces are necessary. However, each space can make small so that a thin or miniature type camera can bear. Further, since a lot of gears are dispersed to the first and second gear groups, the structure of the gears does not become complicated and is capable of variety of gear disposition.

As mentioned above, regarding the optical zoom mechanism or the camera of this embodiment, the first and second rate reducing gear groups can be mounted separately in narrow spaces since a lot of rate reducing gears are divided into the first and second rate reducing gear groups.

Further, since a gear structure is made as two gear groups of the first and second gear groups, the structure of the gears is capable of variety of gear disposition, which result in slimming or miniaturizing the camera.

### Fourth Embodiment

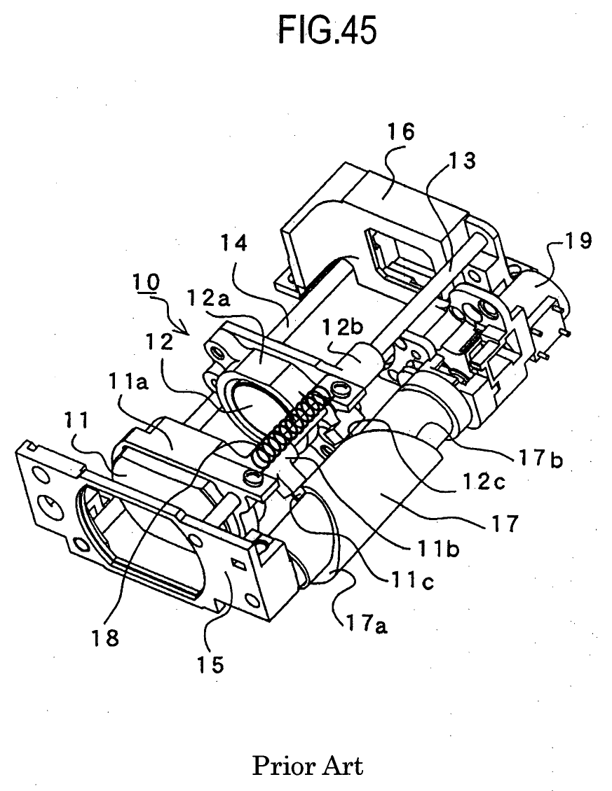

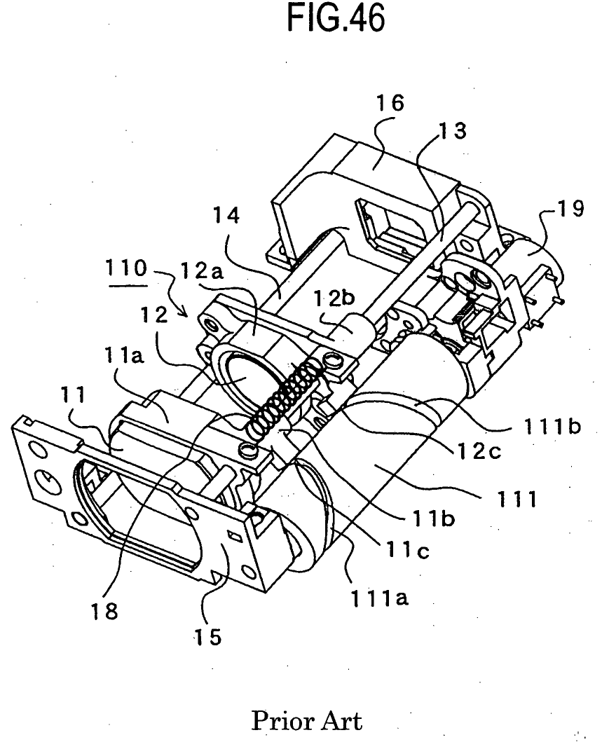

A driving mechanism for zooming 10 shown in FIG. 45 is configured in such a manner that cam pins 11c, 12c caused to be pressed to first and second cam planes 17a, 17b by giving pressing force in a direction approaching each other with a spring force of a coil spring 18 to a cam pin 11c of a first lens group 11 and a cam pin 12c of a second lens group 12.

Therefore, when the first lens group 11 and the second lens group 12 move along the optical axis, a distance between the first lens group 11 and the second lens group becomes large to increase a spring force of the coil spring 18 due to the cam form of a cam for zooming 25 so that contact pressure of the cam pin 11c, 12c to the cam plane increases.

When a distance between the first lens group 11 and the second lens group becomes small, on the contrary, contact pressure of the camp in 11c, 12c to the cam plane decreases because of decrease of a spring force of the coil spring 18.

In other words, as rotational driving force of the cam for zooming 17 for moving the lenses varies depending on each position for zooming the first and second lens group 11, 12, contact pressure of cam pins 11c, 12c increases most at the zooming position where a distance between the first and second lens groups 11, 12 is greatest to need the greatest rotational driving force.

Therefore, the conventional driving mechanism for zooming 10 needs a motor 19 capable of rotating smoothly the cam for zooming 17 even at the zooming position of the greatest contact pressure of the cam pins 11c, 12c. Accordingly, an expensive motor or a big motor is necessary as a motor 19. Further, as a high loading current flows through the motor 19 depending on zooming position, it is not favorable in terms of electricity consumption.

On the other hand, since a driving mechanism for zooming 110 shown in FIG. 46 is configured in such a manner that the cam pins 11c, 12c is pressed to a cam plane by giving a tensile force of the coil spring 18 to the lens frame 11a of the first lens group 11 and the lens frame 12a of the second lens group 12, there are such problems that the first and second lens groups become slanting or eccentric.

More particularly, since the first and second lens groups 11, 12 move in compliance with the rotation of the first and second cam grooves 111a, 111b and their cam grooves form, the greater a distance between the first and second lens group 11, 12 becomes, the greater a force of the coil spring 18 becomes.

Therefore, the greater a distance between the first and second lens groups becomes, the greater the lens frames 11a, 12a slant by a tensile force of the coil spring 18. Also, the slant of the first and second lens group 11, 12 causes the eccentricity of the lens.

The greater is the mechanical play of the axis holes of the bosses 11b, 12b to the guide shaft 13, the greater becomes thus generated slanting and eccentricity of the first and second lens groups. Hence, it is preferable to diminish the mechanical play as possible. However, since a definite mechanical play needs to be set in order to slide smoothly the bosses 11b, 12b, the above mentioned slanting and eccentricity generate.

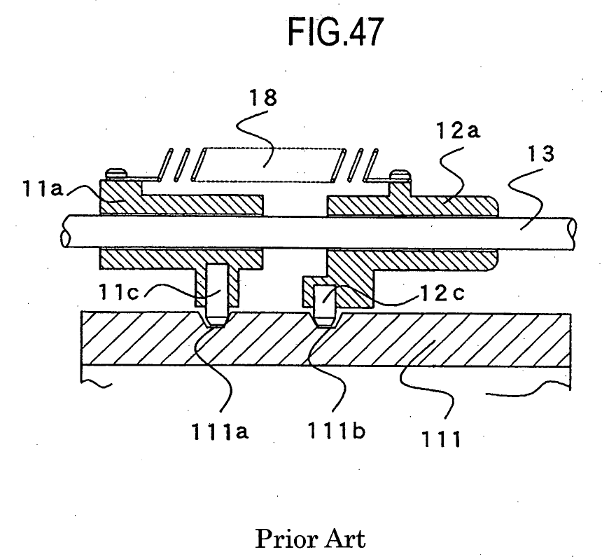

First and second cam grooves 111a, 111b of the above mentioned cam for zooming 111 are formed as cam grooves having an opening slant, as shown in FIG. 47 for example. Also taper is formed on the cam pins 11c, 12c.

Therefore, when a projecting direction of the cam pins 11c, 12c vary corresponding to the slant of the first and second lens groups 11, 12, contact points of the cam pin 11c, 12c to the cam plane shift so that fluctuation of a moving distance generates. That is, because a cam axis deviates, the normal position of the first and second lens groups shift so that a moving distance of the lens groups 11, 12 fluctuates depending on the zooming position, which leads to lowering of accuracy of zooming.

In view of the above mentioned situation, as an embodiment of the present invention, there are presented a cam apparatus having cam pins of an even pressing force to a cam plane so as to be able to diminish a rotational driving power of the cam at best, a cam apparatus that does not cause a moving object sliding on a guide shaft to generate slant, and a cam apparatus that does not cause a moving distance of a moving object to generate fluctuation. Further, a camera having said cam apparatus as a cam for zooming of an optical system is presented.

Now, referring to drawings, a fourth embodiment of the present invention of an electronic camera is explained as follows.

FIG. 27 is a perspective illustration showing a driving mechanism for zooming 20 of a photographic lens. FIG. 28 is a front elevational view of the above driving mechanism for zooming 20.

In the drawings, 21 is a first lens group; 22 is a second lens group; the first and second lens groups are made similarly to the conventional ones shown in FIG. 45, 46. A guide shaft is pierced through a boss 21b provided on a lens frame 21a and through a boss 22b provided on a lens frame 22a so as to be able to slide. The guide shaft 23 holds the first and second lens groups 21, 22.

Holes (unshown) are provided at the positions of the lens frame 21a, 22a opposite to the bosses 21b, 22b. The guide shaft 24 is pierced through these holes so as to be able to slide whereby the first and second lens groups do not rotate.

Further, a cam pin (a cam groove inserting member) 21c of the first lens group 21 formed projectingly on the boss 21b and a cam pin (a cam groove inserting member) 22c of the second lens group 22 formed projectingly on the boss 22b are inserted into a cam groove of a cam for zooming 25. The first and second lens groups are cam-driven along a direction of the optical axis by rotating the cam for zooming 25 (see FIG. 29). Additionally, the cam for zooming 25 is driven by a motor for zooming 26.

One ends of the guide shaft 23 and the guide shaft 24 are fixed to a front fixing frame 27 and another ends are fixed to a rear fixing frame 28. The cam for zooming 25 is rotatably supported with a bearing portion 27a of the front fixing frame 27 and a bearing portion 29a of a supporting fixing frame 29 fixed to the rear fixing frame 28 (see FIG. 18)

Window holes 27b, 28a through which object image light passes are formed on the front fixing frame 27 and the rear fixing frame 28. Further, a CCD (an solid image forming element) is mounted in right after the window of the rear fixing frame 28 (see FIG. 27, 29).

While, a third lens group 31 shown in FIG. 27 is a lens for focusing and is supported by piercing the guide shaft 23 to a boss 31a provided on the lens frame 31a. The third lens group 31 is screw-driven by a lead screw 34 rotatively driven with a motor for focusing 33 to advance and retreat along the optical axis.

Besides, referring to FIG. 27, 35 is a shutter unit fixed to the lens frame 22a; 36 is a cover plate; 37 is a photo interrupter for zooming; 38 is a photo interrupter for focusing; and 39 is a spring for preventing a play of the third lens group 31, the spring which presses the boss in one direction to absorb the play between the lead screw 34 and a nut 32. The photo interrupter for zooming 37 detects an initial position for zooming and the photo interrupter for focusing detects an initial position for focusing.

In the above configured driving mechanism for zooming of the photographic lens, the first and second lens group 21, 22 moves for zooming by driving rotatively the cam for zooming 25 with the motor for zooming 26 and the third lens group 31 moves for focusing by driving rotatively the lead screw 34 to screw-drive the nut screw 32.

In addition, the third lens group 31 moves also at the time of zooming.

The cam 25 for zoom with which the above-mentioned driving mechanism for zooming 20 is equipped as a cam apparatus on the other hand is explained with reference to FIG. 29, FIG. 30, and FIG. 31.

FIG. 29 is the same perspective illustration of a cam for zooming as FIG. 27 when the third lens group, the motor for focusing 33, the shutter unit 35, the cover plate 36 and so on are removed for showing. FIG. 30 is a perspective illustration of a cam for zooming 25. FIG. 31 is an exploded perspective illustration of a cam for zooming.

As shown in the drawing, the cam 25 for zooming is a cylindrical cam having a first cam groove 40 and a second cam groove 41 and comprises a cylindrical cam base body 251, cylindrical cam frames 252, 253 which fit the both sides of the cam base body 251 so as to be able to slide, and a tensile coil spring 254 pressing the cam frames 252, 253 in a direction for approaching each other.

A can base body 251 has a sliding portions 251b, 251c having a smaller portion at the both sides of the middle portion 251a. One cam plane 40a is formed for forming a first cam groove 40 at a stepped portion between the middle portion 251a and the sliding portion 251b. One cam plane 41a is formed for forming a first cam groove 41 at a stepped portion between the middle portion 251a and the sliding portion 251c. The cam base body 251 has long holes 251d, 251e along an axial direction from the both ends, into which protruded portions 252a, 253a are fit so as to be able to slide, whereby the cam frames 252, 253 are rotated together with the cam base body 251. A hole portion 251f formed at the ends of sliding portion 251b, 251c is to attach a coil spring 254. Stepped portions 251g, 251h are to restrict movement of a cam frame 252, 253.

Meanwhile, a cam frame 252 has another cam plane 40b for forming a first cam groove 40 at one end circumference portion and further has a pointing inner flange 252b. The cam frame 252 has a spring hooking portion 252c projected from the protruded portion 252a in the cylinder.

A cam frame 253 has another cam plane 41b for forming a first cam groove 41 at one end circumference portion and further has a pointing inner flange 253b. The cam frame 253 has a spring hooking portion 253c projected from the protruded portion 253a in the cylinder.

With regard to the cam base body 251, the cam frames 252, and 253, after the cam frame 252 is fit to the sliding portion 251b of the cam base body 251 and the cam frame 253 is fit to the sliding portion 251c, one end of coil spring 254 is hooked to the spring hooking portion 252c of the cam frame 252 and another end is hooked to the spring hooking portion 253c of the cam frame 253.

Then the coil spring 254 presses the cam frame 252 and 253 in a direction of aproaching each other so that the flange portion 252b advances until it strikes the stteped portion 251g as the cam frame 252 slides the sliding portion 251b. With this state, the first cam groove is formed by the one cam plane 40a and the other cam plane 40b.

Likewise, the cam frame 253 slides the sliding portion 251c and the flange portion 253b advances until it strikes the stteped portion 251h so that the second cam groove is formed by the one cam plane 41a and the other cam plane 41b with this state.

Thus formed cam grooves 40, 41 become spring shaped cam grooves matched with movement of the first and second lens groups 21, 22 necessary to zooming.

As shown in FIG. 29, in the cam for zooming 25 configured as described above, the cam pin 21c of the first lens group 21 is inserted into the cam groove 40 and the cam pin 22c of the second lens group 22 is inserted into the cam groove 41. By the insertion of the cam pins 21c, 22c like this way, the flange poriton 252b of the cam frame 252 retreats a little from the stepped portion 251g and likiwise, the flange poriton 253b of the cam frame 253 retreats a little from the stepped portion 251h.

Therefore, since the cam pin 21c is pressed to the cam plane 40b of the cam frame 252 and the cam pin 22c is pressed to the cam plane 41b of the cam frame 253, the cam pins 21c, 22c contact to the cam plane with a definite contact pressure over the whole region of the cam grooves 40, 41. A contact pressure of the cam pins 21c, 22c to the cam plane can be determined by a tensile force of the coil spring 254. A most appropriate contact pressure of the cam pins 21c, 22c is available when the coil spring 254 having an appropriate tensile force is chosen.

Thus, the cam for zooming 25 can be rotated with a definite motor driving force and the first and the second lens groups 21, 22 can be smoothly driven for moving. As a result, the cam for zooming 25 becomes a cam apparatus having a light load of small fluctuation so that a small and power-saving motor can be used as a motor for zooming 26.

FIG. 18 is a cross sectional drawing showing a cross section of the cam for zooming 25 and its driving system by cutting by the A-A line of FIG. 28.

As shown in the drawing, a cam for zooming 25 of this second embodiment is explained. An inner gear 42 is provided at a rear end side of the cam for zooming 25. A protruded portion 42a of the inner gear is inserted into an inner hole of the cam base body 251. A key 42b provided at a circumferential portion of the protruded portion 42a fits in a key groove 251i formed in an inner hole portion of the cam base body 251.

Accordingly, the cam for zooming 25 rotates together with the inner gear 42.

The inner gear 42 is rotatably supported by a bearing portion 29a provided on a supporting fixing frame 29 and further engages a small coupling gear 43.

The small coupling gear 43, which is driven by the motor for zooming 26 through a rate reducing device 44, rotates the inner gear 42 to rotate the cam for zooming 25.

In the driving mechanism for zooming 20 exerted as above, the cam pins 21c, 22c exert a definite contact pressure over the whole region of the first and second cam groove 40, 41; the width in a lateral direction of the camera (width in a direction of left and right in FIG. 28) can be shortened in addition; and further the first and second lens groups 21, 22 for zooming and the third lens group 31 are movably supported with the same guide shafts 23 so that the lens groups are difficult to fall or become eccentric.

FIG. 19 shows a driving mechanism for zooming 50 of the second embodiment.

The driving mechanism for zooming 50 is characterized in that the other cam planes 40b, 41b formed on the cam frames 252, 253 are slanted at an predetermined angle, though, other features are the same as the driving mechanism for zooming 20 shown in FIG. 27-28.

FIG. 19 corresponds to a cross sectional view by the b-b line in FIG. 28.

FIG. 20 is a FIG. 20 is a partially enlarged cross sectional drawing showing a configured portion formed by the first and second cam grooves 40, 41 together with the cam pins 21c, 22c As seen in the drawing, the other cam planes of the first and second cam frames 252, 253 are formed as slanting cam planes having a rising gradient to the periphery of the frame.

The cam pins 21c, 22c receive a pushing force in a direction of F1 shown in the drawing because the other cam planes 40b, 41b are formed as slanting planes. That is, as a spring force in a direction of F2 shown in the drawing is exerted to the first and second can frames 252, 253 with the coil spring 254, the first and second cam frames receive a pressing force F1 in a direction orthogonal to the rotational axis of the cam groove in addition to the contact pressure of the cam pins 21c, 22c pressed by a slanting plane of the other cam planes 40b, 41b to the one cam plane 40a, 41a.

The above mentioned pressing force F1 which acts on the cam pins affects in such a manner that hole plane portions of supporting holes 21d, 22d of the bosses 21b, 22b contacts the guide shaft 23 so as to absorb mechanical play between the supporting shaft holes 21d, 22d and the guide shaft 23.

In the cam for zooming 25 as configured above, the cam pins 21c, 22b contact a whole region of the first and second cam grooves 40, 41 with a definite contact pressure and are driven to move in a direction of the rotational axis of the cam groove according to rotation of the cam for zooming 25 so that the first and second lens groups 21, 22 move along the guide shaft 23.

Further, since the bosses 21b, 22b slide the guide shaft 23 without mechanical play as mentioned above, the second lens groups 21, 22 do not become slanting or eccentric. As a result, the driving mechanism for zooming has a cam for zooming 25 (cam apparatus) capable of upgrading zooming accuracy.

FIG. 21(A), (B), (C) are cross sectional drawings showing other embodiments similar to FIG. 20 wherein a slanted position of the cam plane of the first and second cam grooves 40, 41. FIG. 21 (A) is a cross sectional drawing showing one cam planes 40a, 41a of the first and second cam grooves 40, 41, which are formed slantingly. FIG. 21(B) is a cross sectional drawing showing one cam planes 40a, 41a and other cam planes 40b, 41b of the first and second cam grooves 40, 41, which are formed slantingly. FIG. 21(C) is a cross sectional drawing showing other cam planes 40b, 41b of the first and second cam grooves 40, 41 and cam pins 21c, 22c, which are formed slantingly.

Since a pressing force F1 acts to the cam pins 21c, 22c in the event of the above configuration, play between the bosses 21b, 22b and the guide shaft 23 can be absorbed similarly to the embodiment shown in FIG. 20 so that slant or eccentricity of the first and second lens groups 21, 22 ca be prevented.

Further, when the both cam planes are formed slantingly as shown in FIG. 21(B), smoother zooming action can be realized compared to the one with one slanted cam plane.

Also in the embodiment shown in FIG. 20, FIG. 21(A), (B), the contact portion of the cam pins 21c, 22c, which contact the cam plane may be formed slantingly.

FIG. 22 shows another embodiment of a driving mechanism using a cam for zooming 25 of this third embodiment. FIG. 22 shows a driving mechanism in which a coil spring 45 is provided at a bearing portion 27a of a front fixing frame 27 in order to absorb a bearing play of the cam for zooming 25. The coil spring 45 enhances an accuracy of the moving position of the first and second lens groups 21, 22 preventing from movement of the cam for zooming 25 in a direction of the rotational axis by pressing the cam for zooming 25 in one direction.

FIG. 23 shows an embodiment wherein a bearing play of the cam for zooming 25 and first and second cam frames 252, 253 is pressed with a coil spring 46 by providing a coil spring 46 at a bearing part 27a of a front fixing frame 27.

This embodiment is configured in such a manner that a cam base body 251 is pressed through a cam pin 21c by pressing a first cam frame 252 and a second cam frame 253 is pressed in one direction through a cam pin 22c. With this configuration, a coil spring 254 hooked between the cam frames. 252 and 253 becomes unnecessary.

FIG. 32-34 show a zooming mechanism similar to the zooming mechanism 20 or 50 described above for a lens barrel less electronic camera (digital camera) having no lens barrel as an example.

FIG. 32 is a camera plan view. FIG. 33 is a camera front elevational view. FIG. 34 is a camera rear elevation view of an electronic camera shown in FIG. 32.

As shown in the drawings, the electronic camera has a form having a big longitudinal and transversal width and a small depth in a front view so that the camera is thin.

The electronic camera has two separate box-like bodies as a camera main body 60 provided with a controller, a memory card, a computing part, a memory card slot and others and as an optical system installed part 61 provided with a photographic lens and others.

And the camera main body 60 is rotatably within reasonable bounds coupled with the optical system installed part 61 by a coupling pail 62.

As shown in the drawing, on the upper plane of the camera main body 60, a shutter button and a power switch are provided; on the back plane of the camera main body 60, a liquid crystal monitor 65, selection and decision button 66, a zoom button 67, mode selecting button 68 and others are provided; further, various circuit boards including a CPU, a battery which supplies electric power, a memory card slot are installed in the camera main body 60 (unshown).

Further, a photographic lens window 69 and a flash window of a flash unit 70 are provided on the upper plane of the optical system installed part 61, and a zooming mechanism part 20, 50, 90 and a flash unit 80 stated later are installed by shielding light in the optical system installed part 61.

Thus, while disposing a display unit, an operation unit, a battery, a memory card slot, and a circuit board in the camera main body 60, thin shape of the whole camera is realized by integrating an optical mechanism and the flash unit 80 in the optical system installed part 61.

Since the above mentioned electronic camera is a very thin type of camera, it is convenient to carry.

On the other hand, when taking a photograph, as shown in FIG. 35 for example, the optical system installed part 61 is rotated so that the photographic lens window 69 points at the front.

Since the camera main body 60 is grasped by hand and the shutter can be released in this state, the camera shake scarcely occurs with this camera.

Moreover, as the optical system installed part 61 can be rotated to an opposite side to that shown in FIG. 35, it can be pointed at the same direction as the liquid crystal monitor 65 for photographing.

FIG. 36 is a perspective illustration of an optical system installed part 61 when a rear case is removed. FIG. 37 is a transverse sectional view of the above optical system installed part. FIG. 38 is an exploded perspective illustration of the above optical system installed part 61.

As seen in these drawings, the optical system installed part 61 has a flash unit 80 and a-driving mechanism for zooming (a optical system unit) 90 of photographic lenses mounted in a box like front case (camera case) 71 so as to be a lens barrel less type having no lens barrel. The above units and others are installed by shielding light.

Therefore, the optical system installed part 61 is restricted to a thickness defined by a height of the optical unit which formed thin so that a thin type of camera is realized.

The flash unit 80 resides in the innermost portion of the flash part 81 and the front case 71 and has a main condenser 82 disposed adjacently at the rear of the optical system unit and a circuit board 83 at the side of the optical system unit in the front case 71.

The driving mechanism for zooming 90 is disposed in the frond case 71 by screwing with small screws 91. A photographing image light enters in an image capturing optical system consisting of the first, second and third lens groups through the photographic lens window 69.

In addition, the cover 92 which prevents invasion of solder waste, dust, and others is provided on the driving mechanism for zooming 90.

As mentioned above, the rear case 72 is fixed with a screw to the front case 71 to which the flash unit 80 and driving mechanism for zooming 90 are mounted.

More particularly, as shown in FIG. 38, the rear case 72 is fixed to the front case 71 with the small screw 93 which is inserted into the one side of the rear case 72 from the front case 71. The other side of the rear case 72 is screwed with the one side of a tongue flange 62a of the coupling part 62.

That is, the one side of the tongue flange 62 of the coupling part 62 is fixed with a small screw 73 to the front case 71 and rear case 72 so as to unite together.

In addition, the other side of the tongue flange 62b of the coupling part 62 is screwed to the case of the camera main body 60, with a tubular portion 62c of which the camera main body 60 couples rotatably with the optical system installed part 61 and through the tubular portion, two parts are electrically connected with wire.

Further, 94 shown in FIG. 38 is a cam pushing pin; 95 is a cam spring; and 96 is a image capturing unit; these are described later.

The above optical system installed part 61 is unnecessary to provide a lenses barrel and can be made with a depth fit to the lens diameter so as to be appropriate to a very thin type electronic camera.

FIG. 39 is a perspective illustration of the driving mechanism for zooming 90.

This driving mechanism for zooming 90 has a configuration similar to the driving mechanism for zooming 20 or 50. Only what is different in this driving mechanism for zooming is that the cam for zooming 25 is disposed at the left side of the photographic lens groups and the motor for zooming 26 is disposed in front, the motor for focusing is disposed in rear.

A thinner camera than a camera in which two motors are disposed as overlapped can be obtained in this way by disposing the motor for zooming 26 and the motor for focusing 33 separately at front side and rear side. Further, electro magnetic interference between two motors can be avoided.

As for a cam for zooming 25, as shown in FIG. 40, a cam base body 251 is formed from two cylinder type base bodies 351, 352. More particularly, an inserting shaft portion 351a of the cylinder type base body 351 is inserted into a cylinder type base body 352 and an eccentric pin 74 is inserted through a hole portion 352a of the cylinder type base body 352 to fix to a pin hole of the inserting shaft portion 351a so that these cylinder type base bodies 351, 352 are combined together.

That is, the distance between the one cam plane 40a formed on the cylinder type base body 351 and the one cam plane 41a formed on the cylinder type base body 352 is finely adjusted by rotating the eccentric pin 74 for adjusting an inserted depth of the inserting shaft portion 351a.

In addition, as already stated above, the first and second cam groove 40, 41 are formed by the one cam planes 40a, 41a and the other cam planes 40b, 41b of the cam frame 252, 253.

Meanwhile, a pin receiving umbo 252e is projectingly formed toward the inner portion on the cam frame 252 of the cam for zooming 25 so as to slide in a long hole 351c of the cylinder type base body 351. The cam frame 252, 253 and the cam base body 251 are pressed in one direction by pressing the pin receiving umbo 252e with the cam pressing pin 94.

As shown in FIG. 37, the cam pressing pin 94 is inserted through a hole 27c of a front fixing frame 27 and its tip is contacted to the pin receiving umbo 252e. Pressing force is given to the cam pressing pin 94 by a cam spring 95 provided in the above hole 27c. The cam pressing pin 94 and the cam spring 95 are prevented to come off with a plate extended from the flash part 81.

In the cam for zooming 25, the cam frame 253 rotates together with the cylinder type base body 352 by fitting a protruded portion of a key provided in it to a key groove 352b.

Also provided is the cam frame 252 with an interlocking gear 75 which is driven through a rate reducing device 44 with a motor.

The rate reducing device 44 of the driving mechanism for zooming 90 is, as shown in FIG. 41, comprises a front gear group and a rear gear group. The front gear group comprises a gear 44b a large diameter gear portion of which is engaged with a pinion 44a of the motor for zooming 26 and a gear 44c which is engaged with a small diameter gear portion of the gear 44b. In addition, a gear 44c is provided at the front end of a rotational axis rod 44d through which the rear gear group is interlocked.

The rear gear group comprises a gear 44e provided at the rear end of the rotational axis rod 44d, a gear 44f a large diameter gear portion of which engages the gear 44e, and a gear 44g a large diameter gear portion of which engages a small diameter gear portion of the gear 44f. An interlocking gear 75 of the cam frame 253 engages the small diameter gear portion of the gear 44g.

Since gear groups comprises the front gear group and the rear gear group, a place for the rate reducing gear is divided into two, the rate reducing device 44 can be fit with the photographic lens diameter so as to be appropriate for making a thin optical system absorption part 61.

To explain more particularly, in order to secure an enough rate reducing ratio for disposing a whole reducing gears in one place, a rate reducing gear group needs to be extendedly disposed in a direction of zooming of the mechanism for zooming, which leads to a long mechanism for zooming to prevent miniaturization.

Also in order to secure an enough rate reducing ratio without changing a length, the gear needs to be big in diameter so that a rate reducing device fit to a diameter of the lens can not be realized, which result in preventing miniaturization.

FIG. 11 is an exploded perspective view of an image capturing unit 96. The image capturing unit 96 comprises a holder 354, a mask 353, a filter (LPF) 352, a rubber 351, a CCD 320, a plate 355 and a circuit board 358. More particularly, the image capturing unit 96 is configured in such a manner that the mask 353, the filter 352, the rubber 351 and the CCD are disposed between the holder 354 and the plate 355, the holder 354 is fixed to the plate with a small screw 356 to form one unit, after that the CCD 320 is electrically connected to the circuit board 358, and the circuit board 358 is fixed.

The image capturing unit 96 made in this way is fixed to the rear fixing frame 28 of the driving mechanism for zooming 90.

More particularly, the rear fixing frame 28 has a standard plane 28b and a fixing prong 28c and leaf springs 105, 106 which hold the image capturing unit 96 are attached to the rear fixing frame 28.

Therefore, when flange portions of the plate 355 are inserted between the standard plane 258b and the leaf springs 105, 106, the one fixing prong 28c plunges in a fixing hole 102a of the plate 355 and the other fixing prong 28c catches a fixing groove 102b of the plate 355 so that the image capturing unit 96 is fixed by the elastic holding force of the two leaf springs 105, 106.

Though FIG. 42, 43 shows a state in which the circuit board 358 is taken off, the image capturing unit 96 is actually attached as shown in FIG. 44.

As described in the above embodiment, according to the present invention, in the cam apparatus, the cam groove inserting member receives a pressing force in a direction orthogonal to the rotational axis in addition to a cam driving force in a direction of the rotational axis of the cam groove by spring force of the spring member given to the cam frame because the slanting portion is provided on the cam plane.

Therefore, since a mechanical play between the moving object and the guide shaft is absorbed by the above mentioned pressing force which acts to the cam groove inserting member, the moving object slides on the guide shaft without any mechanical play.

Further in this embodiment, as the above mentioned cam apparatus is provided to a camera as a cam for zooming, the cam for zooming can be of even and light load. As a result, a camera having a small and low cost driving source for the cam for zooming can be realized.

Further, regarding the cam for zooming having the slanting portion on the cam plane, as a mechanical play between the bearing portion of the zoom lens and the guide shaft is absorbed, slant or eccentricity of the lens scarcely generates so that a camera having a high accuracy of zooming is obtained.

Particularly, regarding the cam for zooming of this embodiment, as a distance between the first cam groove and the second cam groove can be finely adjusted, such a camera is obtained that an error of back focus caused by fluctuation due to parts or assembling can be adjusted.

An embodiment provided with the cam apparatus of this embodiment as a cam for zooming of the driving mechanism for zooming of the photographic lens was explained. The cam apparatus of this embodiment can be used as a cam apparatus which zooms a zoom lens of a view finder or a flash unit.

The cam apparatus of this embodiment is not limitted to a camera but can be performed as a cam apparatus provided to other apparatuses. In addition, the cam apparatus can comprise a cam base body 251 and one cam frame 252 (or 253). In this case, a spring force in a contrary direction shall be given to the cam base body 251 and the cam frame 252, or a spring force pressing in one direction the cam base body 251 together with the cam frame 252 shall be given.

According to the cam apparatus of this embodiment, since a cam plane of one cam body and a cam plane of another cam body forms a cam groove and a cam groove inserting member inserted into the cam groove contacts the cam plane by a forcing device pressing the cam body, the cam groove inserting member contacts the cam plane with an even contact pressure over all region of the cam groove.

Since a contact pressure of the cam groove inserting member can be determined by a spring force of the forcing device which presses the cam body, the cam groove inserting member can be contact to the cam plane with the most appropriate contact pressure.

Thus, besides a moving object moves smoothly, it is advantageous in terms of miniaturization and power saving of driving source such as a motor which rotates the cam body.

This embodiment is a cam apparatus wherein two cam grooves are formed by one cam plane of the first and second cam grooves formed on the cam body and by the other cam plane formed on the first and second cam frames and the cam groove inserting member inserted into each cam groove contacts the cam plane by a spring force of the forcing device which presses the first and second cam frame.

Therefore, each cam groove inserting member contacts the cam plane with even contact pressure over all region of the cam groove. As a result, a driving force by the two cam grooves moves each moving object smoothly, which leads to advantage in terms of miniaturization and power saving of driving source of the cam apparatus.

According to this embodiment, in a cam apparatus having first and second spiral cam grooves for moving an object with a cam driving force which is generated by cam-driving a cam groove inserting member inserted in each cam groove, there is proposed a cam apparatus provided with one base body part having a stepped portion between a sliding portion and a middle portion of a cylinder as one cam plane of a first cam groove, the sliding portion being formed at one end of the cylinder as a smaller diameter form and another base body part having a stepped portion between a sliding portion and a middle portion of a cylinder as one cam plane of a second cam groove, the sliding portion being formed at one end of the cylinder as a smaller diameter form, comprising a cam base body formed by connecting the one base body part to the other base body part, a first cam frame forming another cam plane confronting one cam plane of the first cam groove and provided non-rotatably at the sliding portion of the one base body part so as to be able to slide, a second cam frame forming another cam plane confronting one cam plane of the second cam groove and provided non-rotatably at the sliding portion of the other base body part so as to be able to slide, and a forcing device, which contacts each cam groove inserting member inserted into the two cam grooves formed by the first and second cam frames and the cam base body to the cam plane.

According to this embodiment, a distance between the one cam planes of the first and second cam grooves can be adjusted. That is, the cam groove inserting member inserted into the first and second cam groove is moved to adjust in a rotational axis direction of the cam groove by adjusting the connecting portion of the cam base body so that an error of focus back caused by fluctuation due to parts or assembling can be adjusted.

According to this embodiment, in the aforementioned cam apparatus, a cam apparatus provided with an adjusting mechanism, which adjusts a distance between one cam planes of the first and second cam grooves is proposed.

According to this embodiment, in any one of the above cam apparatuses, a cam apparatus provided with a slanting portion on the cam plane of at least one cam plane of one cam plane and another cam lane is proposed.

According to this embodiment, since the slanting portion is provided on the cam plane on which the cam groove inserting member contacts, the cam groove inserting member receives a cam driving force in a direction of the rotational axis of the cam groove together with a pressing force in a direction orthogonal to the rotational axis.

More specifically, since the cam groove inserting member receives the above mentioned pressing force, in case a cam apparatus is made in such a manner that a moving object slides the guide shaft, the moving object contacts the guide shaft and a mechanical play between the moving object and the guide shaft is absorbed so that clatter movement of the moving object disappears.

According to this embodiment, a cam apparatus is proposed wherein a slanting portion provided on the at least one cam plane of the one cam plane and the other cam plane has a slanting plane which gives a cam driving force in a rotational axis direction of the cam groove and a pressing force in a direction orthogonal to the rotational axis direction in the above mentioned cam apparatus.

Further, according to this embodiment, a cam apparatus is proposed wherein a forcing device for fastening to tighten one end of the forcing device to the first cam frame and another end to the second cam frame and a forcing device for pressing the first and the second cam frame to the cam base body along one direction in any one of the above mentioned cam apparatus.

Thus, the first and second cam frames can be pressed with one forcing device.

Further, according to this embodiment, a cam apparatus is proposed wherein a forcing device pressing the first and second cam frame and the cam base body in one direction is provided in any one of the above mentioned cam apparatus.

According to this embodiment, since the cam groove inserting member caused to contact the cam plane by the cam base body and whole of the first and second cam frame being pressed by the forcing device, and the whole cam apparatus is pressed in one direction, a mechanical play of the rotational axis portion of the cam apparatus is absorbed.

Further, according to this embodiment, a cam apparatus is proposed wherein a forcing device for fastening to tighten one end of the forcing device to the first cam frame and another end to the second cam frame and a forcing device for pressing the first and the second cam frame to the cam base body along one direction in any one of the above invention of a cam apparatus.

The apparatus of this invention has a structure of the previous invention plus a forcing device.

Further, according to this embodiment, there is proposed a camera comprising a zoom lens, a holding frame which holds the zoom lens, a cam groove inserting member provided on the holding frame, a cam apparatus which drives the zoom lens by inserting the cam groove inserting member into a spiral cam groove, a motor which supplies the cam apparatus a driving force, the cam apparatus further comprising one cam body which forms one cam plane of the cam groove, another cam body which is provided non-rotatably on the cam body so as to slide and forms another cam plane confronting the one cam plane, and forcing device contacting the cam groove inserting member to the cam plane by pressing the one cam body and/or the other com body wherein optical zooming is performed by the cam apparatus.

Further, according to this embodiment, there is proposed a camera comprising a zoom lens, a holding frame which holds the zoom lens, a cam groove inserting member provided on the holding frame, a cam apparatus which drives the zoom lens by inserting the cam groove inserting member into a spiral cam groove, a motor which supplies the cam apparatus a driving force, the cam apparatus further comprising, a cam body having a first spiral cam groove, a second spiral cam groove, a sliding portion with a smaller diameter provided at the both ends of a cylinder, one cam plane of the first cam groove provided on a stepped portion between the one sliding portion and a middle portion of the cylinder, one cam plane of the second cam groove provided on a stepped portion between the other sliding portion and a middle portion of the cylinder, another cam plane formed by confronting the one cam plane of the first cam groove, a first cam frame provided non-rotatably on the one sliding portion so as to be able to slide, another cam plane formed by confronting the one cam plane of the second cam groove, a second cam frame provided non-rotatably on the other sliding portion so as to be able to slide, and a forcing device contacting the cam groove inserting member inserted into the two cam grooves formed by the first cam frame, the second cam frame and the cam base body on the cam plane, wherein optical zooming is performed by the cam apparatus.

Thus, as the cam pin presses the cam plane over whole region of the cam groove with even pressure, rotational driving force is approximately even regardless of the zooming position of the lens.

Therefore, a motor for driving a cam for zooming does not become large, which is appropriate for producing a low cost and miniaturized camera.

Further, according to this embodiment, there is proposed a camera comprising a zoom lens, a holding frame which holds the zoom lens, a cam groove inserting member provided on the holding frame, a cam apparatus which drives the zoom lens by inserting the cam groove inserting member into a spiral cam groove, a motor which supplies the cam apparatus a driving force, the cam apparatus further comprising, one base body part having a first spiral cam groove, a second spiral cam groove, a sliding portion with smaller diameter provided at one end of a cylinder, and one cam plane of the first cam groove at a stepped portion provided between a sliding portion and a middle portion of the cylinder, another base body part having a sliding portion with smaller diameter provided at one end of the cylinder, and one cam plane of the second cam groove at a stepped portion provided between a sliding portion and the middle portion of the cylinder, a cam base body formed by connecting the one base body part and the other base body part, another cam plane formed by confronting the one cam plane of the first cam groove, a first cam frame provided non-rotatably on the one sliding portion so as to be able to slide, another cam plane formed by confronting the one cam plane of the second cam groove, a second cam frame provided non-rotatably on the other sliding potion so as to be able to slide, a forcing member, pressing the first cam frame and the second cam frame and contacting the cam groove inserting member inserted into two cam grooves formed by the first cam frame, the second cam frame and the cam base body on the cam plane wherein optical zooming is performed by the cam apparatus.

With regard to the camera that is made in this way, a distance between the first cam groove and the second cam groove can be adjusted so that an error of back focus caused by fluctuation due to parts or assembling can be adjusted.

According to this embodiment as described above, a cam apparatus or a camera wherein contact pressure of the cam groove inserting member can be made even over whole region of the spiral cam groove and cam driving force can be make small as a most appropriate contact pressure of the cam groove inserting member is obtained.

### Fifth Embodiment

A conventional camera in which a lens barrel advances and retreats becomes difficult to configure the lens barrel as a camera form becomes smaller.

Particularly when camera form is made thin, there is a limit to designing a thin camera owing to a diameter of the lens barrel.

In view of the above situation, an object of this embodiment is also to make a camera having a zooming function as thin as possible.

With reference to accompanying drawings, a fifth embodiment according to the present invention when executed in an electronic camera is described as follows.

FIG. 27 is a perspective illustration showing a driving mechanism for zooming 20 of a photographic lens. FIG. 28 is a front elevational view of the above driving mechanism for zooming 20.

In the drawings, 21 is a first lens group, 22 is a second lens group. The first and second lens groups are supported by a guide shaft 23 which is pierced so as to be able to slide to a boss 21b provided on a lens frame 21a and boss 22b provided on a lens frame 22a.

Holes are provided at the opposite position to the bosses 21b, 22b on the lens frames 21a, 22a and a guide shaft 24 is pierced to these holes so as to be able to slide to prevent rotation of the lens groups 21, 22.

Further, a cam pin (a cam groove inserting member) 21c of the first lens group 21 formed projectingly on the above boss 21b and a cam pin (a cam groove inserting member) 22c of the second lens group 22 formed projectingly on the boss 22b are inserted into the cam groove of the cam for zooming 25 so that the first and second lens groups are cam-driven along the optical axis according to rotation of the cam for zooming 25 (see FIG. 29). The cam for zooming 25 is rotatively driven by a motor for zooming 26

One end of the guide shaft 23, 24 is fixed to a front fixing frame 27 and another end is fixed to a rear fixing frame 28. The cam for zooming 25 is rotatably supported by a bearing portion 27a of the front fixing frame 27 and a bearing portion 29a (see FIG. 18) of a supporting fixing frame 29 fixed to the rear fixing frame 28.

Window holes 27b, 28a through which object image light passes are formed on the front fixing frame 27 and the rear fixing frame 28. Further, a CCD (an solid image forming element) is mounted in right after the window of the rear fixing frame 28 (see FIG. 27, 29).

While, a third lens group 31 shown in FIG. 27 is a lens for focusing and is supported by piercing the guide shaft 23 to a boss 31a provided on the lens frame 31a. The third lens group 31 is screw-driven by a lead screw 34 rotatively driven with a motor for focusing 33 to advance and retreat along the optical axis.

Besides, referring to FIG. 27, 35 is a shutter unit fixed to the lens frame 22a; 36 is a cover plate; 37 is a photo interrupter for zooming; 38 is a photo interrupter for focusing; and 39 is a spring for preventing a play of the third lens group 31, the spring which presses the boss in one direction to absorb the play between the lead screw 34 and a nut 32. The photo interrupter for zooming 37 detects an initial position for zooming and the photo interrupter for focusing detects an initial position for focusing.

In the above configured driving mechanism for zooming of the photographic lens, the first and second lens group 21, 22 moves for zooming by driving rotatively the cam for zooming 25 with the motor for zooming 26 and the third lens group 31 moves for focusing by driving rotatively the lead screw 34 to screw-drive the nut screw 32.

In addition, the third lens group 31 moves also at the time of zooming.

The cam 25 for zoom with which the above mentioned driving mechanism for zooming 20 is equipped as a cam apparatus on the other hand is explained with reference to FIG. 29, FIG. 30, and FIG. 31.

FIG. 31 is the same perspective illustration of a cam for zooming as FIG. 27 when the third lens group, the motor for focusing 33, the shutter unit 35, the cover plate 36 and so on are removed for showing. FIG. 30 is a perspective illustration of a cam for zooming 25. FIG. 31 is an exploded perspective illustration of a cam for zooming.

As shown in the drawing, the cam 25 for zooming is a cylindrical cam having a first cam groove 40 and a second cam groove 41 and comprises a cylindrical cam base body 251, cylindrical cam frames 252, 253 which fit the both sides of the cam base body 251 so as to be able to slide, and a tensile coil spring 254 pressing the cam frames 252, 253 in a direction for approaching each other.

A cam base body 251 has a sliding portions 251b, 251c having a smaller portion at the both sides of the middle portion 251a. One cam plane 40a is formed for forming a first cam groove 40 at a stepped portion between the middle portion 251a and the sliding portion 251b. One cam plane 41a is formed for forming a first cam groove 41 at a stepped portion between the middle portion 251a and the sliding portion 251c.

The cam base body 251 has long holes 251d, 251e along an axial direction from the both ends, into which protruded portions 252a, 253a are fit so as to be able to slide, whereby the cam frames 252, 253 are rotated together with the cam base body 251. A hole portion 251f formed at the ends of sliding portion 251b, 251c is to attach a coil spring 254. Stepped portions 251g, 251h are to restrict movement of a cam frame 252, 253.

Meanwhile, a cam frame 252 has another cam plane 40b for forming a first cam groove 40 at one end circumference portion and further has a pointing inner flange 252b. The cam frame 252 has a spring hooking portion 252c projected from the protruded portion 252a in the cylinder.

A cam frame 253 has another cam plane 41b for forming a first cam groove 41 at one end circumference portion and further has a pointing inner flange 253b. The cam frame 253 has a spring hooking portion 253c projected from the protruded portion 253a in the cylinder.

With regard to the cam base body 251, the cam frames 252, and 253, after the cam frame 252 is fit to the sliding portion 251b of the cam base body 251 and the cam frame 253 is fit to the sliding portion 251c, one end of coil spring 254 is hooked to the spring hooking portion 252c of the cam frame 252 and another end is hooked to the spring hooking portion 253c of the cam frame 253.

Then the coil spring 254 presses the cam frame 252 and 253 in a direction of approaching each other so that the flange portion 252b advances until it strikes the stepped portion 251g as the cam frame 252 slides the sliding portion 251b. With this state, the first cam groove is formed by the one cam plane 40a and the other cam plane 40b.

Likewise, the cam frame 253 slides the sliding portion 251C and the flange portion 253b advances until it strikes the stepped portion 251h so that the second cam groove is formed by the one cam plane 41a and the other cam plane 41b with this state.

Thus formed cam grooves 40, 41 become spring shaped cam grooves matched with movement of the first and second lens groups 21, 22 necessary to zooming.

As shown in FIG. 29, in the cam for zooming 25 configured as described above, the cam pin 21c of the first lens group 21 is inserted into the cam groove 40 and the cam pin 22c of the second lens group 22 is inserted into the cam groove 41. By the insertion of the cam pins 21c, 22c like this way, the flange portion 252b of the cam frame 252 retreats a little from the stepped portion 251g and likewise, the flange portion 253b of the cam frame 253 retreats a little from the stepped portion 251h.

Therefore, since the cam pin 21c is pressed to the cam plane 40b of the cam frame 252 and the cam pin 22c is pressed to the cam plane 41b of the cam frame 253, the cam pins 21c, 22c contact to the cam plane with a definite contact pressure over the whole region of the cam grooves 40, 41. A contact pressure of the cam pins 21c, 22e to the cam plane can be determined by a tensile force of the coil spring 254. A most appropriate contact pressure of the cam pins 21c, 22c is available when the coil spring 254 having an appropriate tensile force is chosen.

Thus, the cam for zooming 25 can be rotated with a definite motor driving force and the first and the second lens groups 21, 22 can be smoothly driven for moving. As a result, the cam for zooming 25 becomes a cam apparatus having a light load of small fluctuation so that a small and power-saving motor can be used as a motor for zooming 26.

FIG. 18 is a cross sectional drawing showing a cross section of the cam for zooming 25 and its driving system by cutting by the A-A line of FIG. 28.

As shown in the drawing, a cam for zooming 25 of this second embodiment is explained. An inner gear 42 is provided at a rear end side of the cam for zooming 25. A protruded portion 42a of the inner gear is inserted into an inner hole of the cam base body 251. A key 42b provided at a circumferential portion of the protruded portion 42a fits in a key groove 251i formed in a inner hole portion of the cam base body 251.

Accordingly, the cam for zooming 25 rotates together with the inner gear 42.

The inner gear 42 is rotatably supported by a bearing portion 29a provided on a supporting fixing frame 29 and further engages a small coupling gear 43.

The small coupling gear 43, which is driven by the motor for zooming 26 through a rate reducing device 44, rotates the inner gear 42 to rotate the cam for zooming 25.

In the driving mechanism for zooming 20 exerted as above, the cam pins 21c, 22c exert a definite contact pressure over the whole region of the first and second cam groove 40, 41; the width in a lateral direction of the camera (width in a direction of left and right in FIG. 28) can be shortened in addition; and further the first and second lens groups 21, 22 for zooming and the third lens group 31 are movably supported with the same guide shafts 23 so that the lens groups are difficult to fall or become eccentric.

FIG. 19 shows a driving mechanism for zooming 50 of the second embodiment.

The driving mechanism for zooming 50 is characterized in that the other cam planes 40b, 41b formed on the cam frames 252, 253 are slanted at an predetermined angle, though, other features are the same as the driving mechanism for zooming 20 shown in FIG. 27-28.

FIG. 19 corresponds to a cross sectional view by the b-b line in FIG. 28.

FIG. 20 is a partially enlarged cross sectional drawing showing a configured portion formed by the first and second cam grooves 40, 41 together with the cam pins 21c, 22c. As seen in the drawing, the other cam planes of the first and second cam frames 252, 253 are formed as slanting cam planes having a rising gradient to the periphery of the frame.

The cam pins 21c, 22c receive a pushing force in a direction of F1 shown in the drawing because the other cam planes 40b, 41b are formed as slanting planes. That is, as a spring force in a direction of F2 shown in the drawing is exerted to the first and second cam frames 252, 253 with the coil spring 254, the first and second can frames receive a pressing force F1 in a direction orthogonal to the rotational axis of the cam groove in addition to the contact pressure of the cam pins 21c, 22c pressed by a slanting plane of the other cam planes 40b, 41b to the one cam plane 40a, 41a.

The above mentioned pressing force F1 which acts on the cam pins affects in such a manner that hole plane portions of supporting holes 21d, 22d of the bosses 21b, 22b contacts the guide shaft 23 so as to absorb mechanical play between the supporting shaft holes 21d, 22d and the guide shaft 23.

In the cam for zooming 25 as configured above, the cam pins 21c, 22c contact a whole region of the first and second cam grooves 40, 41 with a definite contact pressure and are driven to move in a direction of the rotational axis of the cam groove according to rotation of the cam for zooming 25 so that the first and second lens groups 21, 22 move along the guide shaft 23.

Further, since the bosses 21b, 22b slide the guide shaft 23 without mechanical play as mentioned above, the second lens groups 21, 22 do not become slanting or eccentric. As a result, the driving mechanism for zooming has a cam for zooming 25 (cam apparatus) capable of upgrading zooming accuracy.

FIG. 21(A), (B), (C) are cross sectional drawings showing other embodiments similar to FIG. 20 wherein a slanted position of the cam plane of the first and second cam grooves 40, 41. FIG. 21 (A) is a cross sectional drawing showing one cam planes 40a, 41a of the first and second cam grooves 40, 41, which are formed slantingly. FIG. 21(B) is a cross sectional drawing showing one cam planes 40a, 41a and other cam planes 40b, 41b of the first and second cam grooves 40, 41, which are formed slantingly. FIG. 21(C) is a cross sectional drawing showing other cam planes 40b, 41b of the first and second cam grooves 40, 41 and cam pins 21c, 22c, which are formed slantingly.

Since a pressing force F1 acts to the cam pins 21c, 22 in the event of the above configuration, play between the bosses 21b, 22b and the guide shaft 23 can be absorbed similarly to the embodiment shown in FIG. 20 so that slant or eccentricity of the first and second lens groups 21, 22 can be prevented.

Further, when the both cam planes are formed slantingly as shown in FIG. 21(B), smoother zooming action can be realized compared to the one with one slanted cam plane.

Also in the embodiment shown in FIG. 20, FIG. 21(A), (B), the contact portion of the cam pins 21c, 22c, which contact the cam plane may be formed slantingly.

FIG. 22 shows another embodiment of a driving mechanism using a cam for zooming 25 of this third embodiment. FIG. 22 shows a driving mechanism in which a coil spring 45 is provided at a bearing portion 27a of a front fixing frame 27 in order to absorb a bearing play of the cam for zooming 25. The coil spring 45 enhances an accuracy of the moving position of the first and second lens groups 21, 22 preventing from movement of the cam for zooming 25 in a direction of the rotational axis by pressing the cam for zooming 25 in one direction.

FIG. 23 shows an embodiment wherein a bearing play of the cam for zooming 25 and first and second cam frames 252, 253 is pressed with a coil spring 46 by providing a coil spring 46 at a bearing part 27a of a front fixing frame 27.

This embodiment is configured in such a manner that a cam base body 251 is pressed through a cam pin 21c by pressing a first cam frame 252 and a second cam frame 253 is pressed in one direction through a cam pin 22c. With this configuration, a coil spring 254 hooked between the cam frames 252 and 253 becomes unnecessary.

FIG. 32-34 show a zooming mechanism similar to the zooming mechanism 20 or 50 described above for a lens barrel less electronic camera (digital camera) having no lens barrel as an example.

FIG. 32 is a camera plan view. FIG. 33 is a camera front elevational view. FIG. 34 is a camera rear elevation view of an electronic camera shown in FIG. 32.

As shown in the drawings, the electronic camera has a form having a big longitudinal and transversal width and a small depth in a front view so that the camera is thin.

The electronic camera has two separate box-like bodies as a camera main body 60 provided with a controller, a memory card, a computing part, a memory card slot and others and as an optical system installed part 61 provided with a photographic lens and others.

And the camera main body 60 is rotatably within reasonable bounds coupled with the optical system installed part 61 by a coupling part 62.

As shown in the drawing, on the upper plane of the camera main body 60, a shutter button and a power switch are provided; on the back plane of the camera main body 60, a liquid crystal monitor 65, selection and decision button 66, a zoom button 67, mode selecting button 68 and others are provided; further, various circuit boards including a CPU, a battery which supplies electric power, a memory card slot are installed in the camera main body 60 (unshown).

Further, a photographic lens window 69 and a flash window of a flash unit 70 are provided on the upper plane of the optical system installed part 61, and a zooming mechanism part 20, 50, 90 and a flash unit 80 stated later are installed by shielding light in the optical system installed part 61.

Thus, while disposing a display unit, an operation unit, a battery, a memory card slot, and a circuit board in the camera main body 60, thin shape of the whole camera is realized by integrating an optical mechanism and the flash unit 80 in the optical system installed part 61.

Since the above mentioned electronic camera is a very thin type of camera, it is convenient to carry.

On the other hand, when taking a photograph, as shown in FIG. 35 for example, the optical system installed part 61 is rotated so that the photographic lens window 69 points at the front.

Since the camera main body 60 is grasped by hand and the shutter can be released in this state, the camera shake scarcely occurs with this camera.

Moreover, as the optical system installed part 61 can be rotated to an opposite side to that shown in FIG. 35, it can be pointed at the same direction as the liquid crystal monitor 65 for photographing.

FIG. 36 is a perspective illustration of an optical system installed part 61 when a rear case is removed. FIG. 37 is a transverse sectional view of the above optical system installed part. FIG. 38 is an exploded perspective illustration of the above optical system installed part 61.

As seen in these drawings, the optical system installed part 61 has a flash unit 80 and a driving mechanism for zooming (a optical system unit) 90 of photographic lenses mounted in a box like front case (camera case) 71 so as to be a lens barrel less type having no lens barrel. The above units and others are installed by shielding light

Therefore, the optical system installed part 61 is restricted to a thickness defined by a height of the optical unit which formed thin so that a thin type of camera is realized.

The flash unit 80 resides in the innermost portion of the flash part 81 and the front case 71 and has a main condenser 82 disposed adjacently at the rear of the optical system unit and a circuit board 83 at the side of the optical system unit in the front case 71.

The driving mechanism for zooming 90 is disposed in the frond case 71 by screwing with small screws 91. A photographing image light enters in an image capturing optical system consisting of the first, second and third lens groups 21, 22, 31 through the photographic lens window 69.

In addition, the cover 92 which prevents invasion of solder waste, dust, and others is provided on the driving mechanism for zooming 90.

As mentioned above, the rear case 72 is fixed with a screw to the front case 71 to which the flash unit 80 and driving mechanism for zooming 90 are mounted.

More particularly, as shown in FIG. 38, the rear case 72 is fixed to the front case 71 with the small screw 93 which is inserted into the one side of the rear case 72 from the front case 71. The other side of the rear case 72 is screwed with the one side of a tongue flange 62a of the coupling part 62.

That is, the one side of the tongue flange 62 of the coupling part 62 is fixed with a small screw 73 to the front case 71 and rear case 72 so as to unite together.

In addition, the other side of the tongue flange 62b of the coupling part 62 is screwed to the case of the camera main body 60, with a tubular portion 62c of which the camera main body 60 couples rotatably with the optical system installed part 61 and through the tubular portion, two parts are electrically connected with wire.

Further, 94 shown in FIG. 38 is a cam pushing pin; 95 is a cam spring; and 96 is a image capturing unit; these are described later.

The above optical system installed part 61 is unnecessary to provide a lense barrel and can be made with a depth fit to the lens diameter so as to be appropriate to a very thin type electronic camera.

FIG. 39 is a perspective illustration of the driving mechanism for zooming 90.

This driving mechanism for zooming 90 has a configuration similar to the driving mechanism for zooming 20 or 50. Only what is different in this driving mechanism for zooming is that the cam for zooming 25 is disposed at the left side of the photographic lens groups and the motor for zooming 26 is disposed in front, the motor for focusing is disposed in rear.

A thinner camera than a camera in which two motors are disposed as overlapped can be obtained in this way by disposing the motor for zooming 26 and the motor for focusing 33 separately at front side and rear side. Further, electro magnetic interference between two motors can be avoided.

As for a cam for zooming 25, as shown in FIG. 40, a cam base body 251 is formed from two cylinder type base bodies 351, 352. More particularly, an inserting shaft portion 351a of the cylinder type base body 351 is inserted into a cylinder type base body 352 and an eccentric pin 74 is inserted through a hole portion 352a of the cylinder type base body 352 to fix to a pin hole of the inserting shaft portion 351a so that these cylinder type base bodies 351, 352 are combined together. That is, the distance between the one cam plane 40a formed on the cylinder type base body 351 and the one cam plane 41a formed on the cylinder type base body 352 is finely adjusted by rotating the eccentric pin 74 for adjusting an inserted depth of the inserting shaft portion 351a.

In addition, as already stated above, the first and second cam groove 40, 41 are formed by the one cam planes 40a, 41a and the other cam planes 40b, 41b of the cam frame 252, 253.

Meanwhile, a pin receiving umbo 252e is projectingly formed toward the inner portion on the cam frame 252 of the cam for zooming 25 so as to slide in a long hole 351c of the cylinder type base body 351. The cam frame 252, 253 and the cam base body 251 are pressed in one direction by pressing the pin receiving umbo 252e with the cam pressing pin 94.

As shown in FIG. 37, the cam pressing pin 94 is inserted through a hole 27c of a front fixing frame 27 and its tip is contacted to the pin receiving umbo 252e. Pressing force is given to the cam pressing pin 94 by a cam spring 95 provided in the above hole 27c. The cam pressing pin 94 and the cam spring 95 are prevented to come off with a plate extended from the flash part 81.

In the cam for zooming 25, the cam frame 253 rotates together with the cylinder type base body 352 by fitting a protruded portion of a key provided in it to a key groove 352b.

Also provided is the cam frame 252 with an interlocking gear 75 which is driven through a rate reducing device 44 with a motor.

The rate reducing device 44 of the driving mechanism for zooming 90 is, as shown in FIG. 41, comprises a front gear group and a rear gear group. The front gear group comprises a gear 44b a large diameter gear portion of which is engaged with a pinion 44a of the motor for zooming 26 and a gear 44c which is engaged with a small diameter gear portion of the gear 44b. In addition, a gear 44c is provided at the front end of a rotational axis rod 44d through which the rear gear group is interlocked.

The rear gear group comprises a gear 44e provided at the rear end of the rotational axis rod 44d, a gear 44f a large diameter gear portion of which engages the gear 44e, and a gear 44g a large diameter gear portion of which engages a small diameter gear portion of the gear 44f. An interlocking gear 75 of the cam frame 253 engages the small diameter gear portion of the gear 44g.

Since gear groups comprises the front gear group and the rear gear group, a place for the rate reducing gear is divided into two, the rate reducing device 44 can be fit with the photographic lens diameter so as to be appropriate for making a thin optical system absorption part 61.

To explain more particularly, in order to secure an enough rate reducing ratio for disposing a whole reducing gears in one place, a rate reducing gear group needs to be extendedly disposed in a direction of zooming of the mechanism for zooming, which leads to a long mechanism for zooming to prevent miniaturization.

Also in order to secure an enough rate reducing ratio without changing a length, the gear needs to be big in diameter so that a rate reducing device fit to a diameter of the lens can not be realized, which result in preventing miniaturization.

FIG. 11 is an exploded perspective view of an image capturing unit 96. The image capturing unit 96 comprises a holder 354, a mask 353, a filter (LPF) 352, a rubber 351, a CCD 320, a plate 355 and a circuit board 358. More particularly, the image capturing unit 96 is configured in such a manner that the mask 353, the filter 352, the rubber 351 and the CCD are disposed between the holder 354 and the plate 355, the holder 354 is fixed to the plate with a small screw 356 to form one unit, after that the CCD 320 is electrically connected to the circuit board 358, and the circuit board 358 is fixed.

The image capturing unit 96 made in this way is fixed to the rear fixing frame 28 of the driving mechanism for zooming 90 as shown in FIG. 42, 43.

More particularly, the rear fixing frame 28 has a standard plane 28b and a fixing prong 28c and leaf springs 105, 106 which hold the image capturing unit 96 are attached to the rear fixing frame 28.

Therefore, when flange portions of the plate 355 are inserted between the standard plane 258b and the leaf springs 105, 106, the one fixing prong 28c plunges in a fixing hole 102a of the plate 355 and the other fixing prong 28c catches a fixing groove 102b of the plate 355 so that the image capturing unit 96 is fixed by the elastic holding force of the two leaf springs 105, 106.

Though FIG. 42, 43 shows a state in which the circuit board 358 is taken off, the image capturing unit 96 is actually attached as shown in FIG. 44.

According to this embodiment, there is proposed a camera having a zooming function comprising a camera main body part provided with a display unit and an operation unit, an optical system unit having

a lens barrel less lens mechanism part with a zoom lens and a focus lens, and a driving mechanism part in which a zoom lens driving mechanism and a focus lens driving mechanism are built integrally, an optical system installed part by shielding light, and an coupling part which rotataboly couples the camera main body with the optical system installed part, wherein the camera main body part and the operation unit are formed as thin box-like bodies of the approximately same thickness.

Further, according to this embodiment, a camera is proposed wherein a thickness of the camera main body and a thickness of the optical system installed part are restricted to a height of the optical system unit.

Further, according to this embodiment, a camera is proposed wherein a flash unit comprising a main condenser, a circuit board and flash part is installed in the optical system installed part.

Further, according to this embodiment, a camera is proposed wherein a circuit board is disposed adjacently to a side of the optical system unit and a main condenser is disposed adjacently to a back of the optical system unit.

Further according to this embodiment a camera is proposed, which comprises a lens frame of the zooming lens and a lens frame of the focusing lens wherein the camera the guide shaft guides the lens frame of the zooming lens together with the lens frame of the focusing lens the in any one of the above cameras.

Further according to this embodiment, a camera is proposed wherein a image capturing unit having an image capturing element and a rear fixing frame are provided thereto and the image capturing unit is directly attached to the rear fixing frame in the aforementioned camera.

As described above, since the camera according to this embodiment is provided with an optical unit comprising integrally a lens mechanism part having at least a zooming lens and a focusing lens together with a driving mechanism part of the zooming lens and focusing lens wherein the optical unit is installed in a camera case provided with a photographic lens window, a camera form can be made thin so as to fit with a lens diameter. As a result, it is possible to offer a very thin camera having a zooming function.

### Sixth Embodiment

Though it is advantageous to fix an image capturing element with a screw in terms of sure fixing, deflection by screw fixing generates in case of a miniaturized lens barrel, which affects a mechanical structure and an optical system.

In view of the above situation, according to this embodiment, an image capturing apparatus and a camera are proposed wherein fixing problem does not affect mechanically and optically even in the event of an optical system unit of a thin electronic camera or a miniaturized lens barrel.

With reference to accompanying drawings, a fifth embodiment according to the present invention when executed in an electronic camera is described as follows.

FIG. 27 is a perspective illustration showing a driving mechanism for zooming 20 of a photographic lens. FIG. 28 is a front elevational view of the above driving mechanism for zooming 20.

In the drawings, 21 is a first lens group, 22 is a second lens group. The first and second lens groups are supported by a guide shaft 23 which is pierced so as to be able to slide to a boss 21b provided on a lens frame 21a and boss 22b provided on a lens frame 22a.

Holes are provided at the opposite position to the bosses 21b, 22b on the lens frames 21a, 22a and a guide shaft 24 is pierced to these holes so as to be able to slide to prevent rotation of the lens groups 21, 22.

Further, a cam pin (a cam groove inserting member) 21c of the first lens group 21 formed projectingly on the above boss 21b and a cam pin (a cam groove inserting member) 22c of the second lens group 22 formed projectingly on the boss 22b are inserted into the cam groove of the cam for zooming 25 so that the first and second lens groups are cam-driven along the optical axis according to rotation of the cam for zooming 25 (see FIG. 29). The cam for zooming 25 is rotatively driven by a motor for zooming 26

One end of the guide shaft 23, 24 is fixed to a front fixing frame 27 and another end is fixed to a rear fixing frame 28. The cam for zooming 25 is rotatably supported by a bearing portion 27a of the front fixing frame 27 and a bearing portion 29a (see FIG. 18) of a supporting fixing frame 29 fixed to the rear fixing frame 28.

Window holes 27b, 28a through which object image light passes are formed on the front fixing frame 27 and the rear fixing frame 28. Further, a CCD (an solid image forming element) is mounted in right after the window of the rear fixing frame 28 (see FIG. 27, 29).

While, a third lens group 31 shown in FIG. 27 is a lens for focusing and is supported by piercing the guide shaft 23 to a boss 31a provided on the lens frame 31a. The third lens group 31 is screw-driven by a lead screw 34 rotatively driven with a motor for focusing 33 to advance and retreat along the optical axis.

Besides, referring to FIG. 27, 35 is a shutter unit fixed to the lens frame 22a; 36 is a cover plate; 37 is a photo interrupter for zooming; 38 is a photo interrupter for focusing; and 39 is a spring for preventing a play of the third lens group 31, the spring which presses the boss in one direction to absorb the play between the lead screw 34 and a nut 32. The photo interrupter for zooming 37 detects an initial position for zooming and the photo interrupter for focusing detects an initial position for focusing.

In the above configured driving mechanism for zooming of the photographic lens, the first and second lens group 21, 22 moves for zooming by driving rotatively the cam for zooming 25 with the motor for zooming 26 and the third lens group 31 moves for focusing by driving rotatively the lead screw 34 to screw-drive the nut screw 32.

In addition, the third lens group 31 moves also at the time of zooming.

The cam 25 for zoom with which the above mentioned driving mechanism for zooming 20 is equipped as a cam apparatus on the other hand is explained with reference to FIG. 29, FIG. 30, and FIG. 31.

FIG. 29 is the same perspective illustration of a cam for zooming as FIG. 1 when the third lens group, the motor for focusing 33, the shutter unit 35, the cover plate 36 and so on are removed for showing. FIG. 30 is a perspective illustration of a cam for zooming 25. FIG. 31 is an exploded perspective illustration of a cam for zooming.

As shown in the drawing, the cam 25 for zooming is a cylindrical cam having a first cam groove 40 and a second cam groove 41 and comprises a cylindrical cam base body 251, cylindrical cam frames 252, 253 which fit the both sides of the cam base body 251 so as to be able to slide, and a tensile coil spring 254 pressing the cam frames 252, 253 in a direction for approaching each other.

A cam base body 251 has a sliding portions 251b, 251c having a smaller portion at the both sides of the middle portion 251a. One cam plane 40a is formed for forming a first cam groove 40 at a stepped portion between the middle portion 251a and the sliding portion 251b. One cam plane 41a is formed for forming a first cam groove 41 at a stepped portion between the middle portion 251a and the sliding portion 251c.

The cam base body 251 has long holes 251d, 251e along an axial direction from the both ends, into which protruded portions 252a, 253a are fit so as to be able to slide, whereby the cam frames 252, 253 are rotated together with the cam base body 251. A hole portion 251f formed at the ends of sliding portion 251b, 251c is to attach a coil spring 254. Stepped portions 251g, 251h are to restrict movement of a cam frame 252, 253.

Meanwhile, a cam frame 252 has another cam plane 40b for forming a first cam groove 40 at one end circumference portion and further has a pointing inner flange 252b. The cam frame 252 has a spring hooking portion 252c projected from the protruded portion 252a in the cylinder.

A cam frame 253 has another cam plane 41b for forming a first cam groove 41 at one end circumference portion and further has a pointing inner flange 253b. The cam frame 253 has a spring hooking portion 253c projected from the protruded portion 253a in the cylinder.

With regard to the cam base body 251, the cam frames 252, and 253, after the cam frame 252 is fit to the sliding portion 251b of the cam base body 251 and the cam frame 253 is fit to the sliding portion 251c, one end of coil spring 254 is hooked to the spring hooking portion 252c of the cam frame 252 and another end is hooked to the spring hooking portion 253c of the cam frame 253.

Then the coil spring 254 presses the cam frame 252 and 253 in a direction of approaching each other so that the flange portion 252b advances until it strikes the stepped portion 251g as the cam frame 252 slides the sliding portion 251b. With this state, the first cam groove is formed by the one cam plane 40a and the other cam plane 40b.

Likewise, the cam frame 253 slides the sliding portion 251c and the flange portion 253b advances until it strikes the stepped portion 251h so that the second cam groove is formed by the one cam plane 41a and the other cam plane 41b with this state.

Thus formed cam grooves 40, 41 become spring shaped cam grooves matched with movement of the first and second lens groups 21, 22 necessary to zooming.

As shown in FIG. 29, in the cam for zooming 25 configured as described above, the cam pin 21c of the first lens group 21 is inserted into the cam groove 40 and the cam pin 22c of the second lens group 22 is inserted into the cam groove 41. By the insertion of the cam pins 21c, 22c like this way, the flange portion 252b of the cam frame 252 retreats a little from the stepped portion 251g and likewise, the flange portion 253b of the cam frame 253 retreats a little from the stepped portion 251h.

Therefore, since the cam pin 21c is pressed to the cam plane 40b of the cam frame 252 and the cam pin 22c is pressed to the cam plane 41b of the cam frame 253, the cam pins 21c, 22c contact to the cam plane with a definite contact pressure over the whole region of the cam grooves 40, 41. A contact pressure of the cam pins 21c, 22c to the cam plane can be determined by a tensile force of the coil spring 254. A most appropriate contact pressure of the cam pins 21c, 22c is available when the coil spring 254 having an appropriate tensile force is chosen.

Thus, the cam for zooming 25 can be rotated with a definite motor driving force and the first and the second lens groups 21, 22 can be smoothly driven for moving. As a result, the cam for zooming 25 becomes a cam apparatus having a light load of small fluctuation so that a small and power-saving motor can be used as a motor for zooming 26.

FIG. 18 is a cross sectional drawing showing a cross section of the cam for zooming 25 and its driving system by cutting by the A-A line of FIG. 28.

As shown in the drawing, a cam for zooming 25 of this second embodiment is explained. An inner gear 42 is provided at a rear end side of the cam for zooming 25. A protruded portion 42a of the inner gear is inserted into an inner hole of the cam base body 251. A key 42b provided at a circumferential portion of the protruded portion 42a fits in a key groove 251i formed in a inner hole portion of the cam base body 251.

Accordingly, the cam for zooming 25 rotates together with the inner gear 42.

The inner gear 42 is rotatably supported by a bearing portion 29a provided on a supporting fixing frame 29 and further engages a small coupling gear 43.

The small coupling gear 43, which is driven by the motor for zooming 26 through a rate reducing device 44, rotates the inner gear 42 to rotate the cam for zooming 25.

In the driving mechanism for zooming 20 exerted as above, the cam pins 21c, 22c exert a definite contact pressure over the whole region of the first and second cam groove 40, 41; the width in a lateral direction of the camera (width in a direction of left and right in FIG. 28) can be shortened in addition; and further the first and second lens groups 21, 22 for zooming and the third lens group 31 are movably supported with the same guide shafts 23 so that the lens groups are difficult to fall or become eccentric.

FIG. 19 shows a driving mechanism for zooming 50 of the second embodiment.

The driving mechanism for zooming 50 is characterized in that the other cam planes 40b, 41b formed on the cam frames 252, 253 are slanted at an predetermined angle, though, other features are the same as the driving mechanism for zooming 20 shown in FIG. 27-28.

FIG. 19 corresponds to a cross sectional view by the b-b line in FIG. 28.

FIG. 20 is a partially enlarged cross sectional drawing showing a configured portion formed by the first and second cam grooves 40, 41 together with the cam pins 21c, 22c. As seen in the drawing, the other cam planes of the first and second cam frames 252, 253 are formed as slanting cam planes having a rising gradient to the periphery of the frame.

The cam pins 21c, 22c receive a pushing force in a direction of F1 shown in the drawing because the other cam planes 40b, 41b are formed as slanting planes. That is, as a spring force in a direction of F2 shown in the drawing is exerted to the first and second cam frames 252, 253 with the coil spring 254, the first and second cam frames receive a pressing force F1 in a direction orthogonal to the rotational axis of the cam groove in addition to the contact pressure of the cam pins 21c, 22c pressed by a slanting plane of the other cam planes 40b, 41b to the one cam plane 40a, 41a.

The above mentioned pressing force F1 which acts on the cam pins affects in such a manner that hole plane portions of supporting holes 21d, 22d of the bosses 21b, 22b contacts the guide shaft 23 so as to absorb mechanical play between the supporting shaft holes 21d, 22d and the guide shaft 23.

In the cam for zooming 25 as configured above, the cam pins 21c, 22c contact a whole region of the first and second cam grooves 40, 41 with a definite contact pressure and are driven to move in a direction of the rotational axis of the cam groove according to rotation of the cam for zooming 25 so that the first and second lens groups 21, 22 move along the guide shaft 23.

Further, since the bosses 21b, 22b slide the guide shaft 23 without mechanical play as mentioned above, the second lens groups 21, 22 do not become slanting or eccentric. As a result, the driving mechanism for zooming has a cam for zooming 25 (cam apparatus) capable of upgrading zooming accuracy.

FIG. 21(A), (B), (C) are cross sectional drawings showing other embodiments similar to FIG. 20 wherein a slanted position of the cam plane of the first and second cam grooves 40, 41. FIG. 21 (A) is a cross sectional drawing showing one cam planes 40a, 41a of the first and second cam grooves 40, 41, which are formed slantingly. FIG. 21(B) is a cross sectional drawing showing one cam planes 40a, 41a and other can planes 40b, 41b of the first and second cam grooves 40, 41, which are formed slantingly. FIG. 21(C) is a cross sectional drawing showing other cam planes 40b, 41b of the first and second cam grooves 40, 41 and cam pins 21c, 22c, which are formed slantingly.

Since a pressing force F1 acts to the cam pins 21c, 22c in the event of the above configuration, play between the bosses 21b, 22b and the guide shaft 23 can be absorbed similarly to the embodiment shown in FIG. 20 so that slant or eccentricity of the first and second lens groups 21, 22 can be prevented.

Further, when the both cam planes are formed slantingly as shown in FIG. 21(B), smoother zooming action can be realized compared to the one with one slanted cam plane.

Also in the embodiment shown in FIG. 20, FIG. 21(A), (B), the contact portion of the cam pins 21c, 22c, which contact the cam plane may be formed slantingly.

FIG. 22 shows another embodiment of a driving mechanism using a cam for zooming 25 of this third embodiment. FIG. 22 shows a driving mechanism in which a coil spring 45 is provided at a bearing portion 27a of a front fixing frame 27 in order to absorb a bearing play of the cam for zooming 25. The coil spring 45 enhances an accuracy of the moving position of the first and second lens groups 21, 22 preventing from movement of the cam for zooming 25 in a direction of the rotational axis by pressing the cam for zooming 25 in one direction.

FIG. 23 shows an embodiment wherein a bearing play of the cam for zooming 25 and first and second cam frames 252, 253 is pressed with a coil spring 46 by providing a coil spring 46 at a bearing part 27a of a front fixing frame 27.

This embodiment is configured in such a manner that a cam base body 251 is pressed through a cam pin 21c by pressing a first cam frame 252 and a second cam frame 253 is pressed in one direction through a cam pin 22c. With this configuration, a coil spring 254 hooked between the cam frames 252 and 253 becomes unnecessary.

FIG. 32-34 show a zooming mechanism similar to the zooming mechanism 20 or 50 described above for a lens-barrel-less electronic camera (digital camera) having no lens barrel as an example.

FIG. 32 is a camera plan view. FIG. 33 is a camera front elevational view. FIG. 34 is a camera rear elevation view of an electronic camera shown in FIG. 32.

As shown in the drawings, the electronic camera has a form having a big longitudinal and transversal width and a small depth in a front view so that the camera is thin.

The electronic camera has two separate box-like bodies as a camera main body 60 provided with a controller, a memory card, a computing part, a memory card slot and others and as an optical system installed part 61 provided with a photographic lens and others.

And the camera main body 60 is rotatably within reasonable bounds coupled with the optical system installed part 61 by a coupling part 62.

As shown in the drawing, on the upper plane of the camera main body 60, a shutter button and a power switch are provided; on the back plane of the camera main body 60, a liquid crystal monitor 65, selection and decision button 66, a zoom button 67, mode selecting button 68 and others are provided; further, various circuit boards including a CPU, a battery which supplies electric power, a memory card slot are installed in the camera main body-60 (unshown).

Further, a photographic lens window 69 and a flash window of a flash unit 70 are provided on the upper plane of the optical system installed part 61, and a zooming mechanism part 20, 50, 90 and a flash unit 80 stated later are installed by shielding light in the optical system installed part 61.

Thus, while disposing a display unit, an operation unit, a battery, a memory card slot, and a circuit board in the camera main body 60, thin shape of the whole camera is realized by integrating an optical mechanism and the flash unit 80 in the optical system installed part 61.

Since the above mentioned electronic camera is a very thin type of camera, it is convenient to carry.

On the other hand, when taking a photograph, as shown in FIG. 35 for example, the optical system installed part 61 is rotated so that the photographic lens window 69 points at the front.

Since the camera main body 60 is grasped by hand and the shutter can be released in this state, the camera shake scarcely occurs with this camera.

Moreover, as the optical system installed part 61 can be rotated to an opposite side to that shown in FIG. 35, it can be pointed at the same direction as the liquid crystal monitor 65 for photographing.

FIG. 36 is a perspective illustration of an optical system installed part 61 when a rear case is removed. FIG. 37 is a transverse sectional view of the above optical system installed part. FIG. 38 is an exploded perspective illustration of the above optical system installed part 61.

As seen in these drawings, the optical system installed part 61 has a flash unit 80 and a driving mechanism for zooming (a optical system unit) 90 of photographic lenses mounted in a box like front case (camera case) 71 so as to be a lens barrel less type having no lens barrel. The above units and others are installed by shielding light.

Therefore, the optical system installed part 61 is restricted to a thickness defined by a height of the optical unit which formed thin so that a thin type of camera is realized.

The flash unit 80 resides in the innermost portion of the flash part 81 and the front case 71 and has a main condenser 82 disposed adjacently at the rear of the optical system unit and a circuit board 83 at the side of the optical system unit in the front case 71.

The driving mechanism for zooming 90 is disposed in the frond case 71 by screwing with small screws 91. A photographing image light enters in an image capturing optical system consisting of the first, second and third lens groups 21, 22, 31 through the photographic lens window 69.

In addition, the cover 92 which prevents invasion of solder waste, dust, and others is provided on the driving mechanism for zooming 90.

As mentioned above, the rear case 72 is fixed with a screw to the front case 71 to which the flash unit 80 and driving mechanism for zooming 90 are mounted.

More particularly, as shown in FIG. 38, the rear case 72 is fixed to the front case 71 with the small screw 93 which is inserted into the one side of the rear case 72 from the front case 71. The other side of the rear case 72 is screwed with the one side of a tongue flange 62a of the coupling part 62.

That is, the one side of the tongue flange 62 of the coupling part 62 is fixed with a small screw 73 to the front case 71 and rear case 72 so as to unite together.

In addition, the other side of the tongue flange 62b of the coupling part 62 is screwed to the case of the camera main body 60, with a tubular portion 62c of which the camera main body 60 couples rotatably with the optical system installed part 61 and through the tubular portion, two parts are electrically connected with wire.

Further, 94 shown in FIG. 38 is a cam pushing pin; 95 is a cam spring; and 96 is a image capturing unit; these are described later.

The above optical system installed part 61 is unnecessary to provide a lenses barrel and can be made with a depth fit to the lens diameter so as to be appropriate to a very thin type electronic camera.

FIG. 39 is a perspective illustration of the driving mechanism for zooming 90.

This driving mechanism for zooming 90 has a configuration similar to the driving mechanism for zooming 20 or 50. Only what is different in this driving mechanism for zooming is that the cam for zooming 25 is disposed at the left side of the photographic lens groups and the motor for zooming 26 is disposed in front, the motor for focusing is disposed in rear.

A thinner camera than a camera in which two motors are disposed as overlapped can be obtained in this way by disposing the motor for zooming 26 and the motor for focusing 33 separately at front side and rear side. Further, electro magnetic interference between two motors can be avoided.

As for a cam for zooming 25, as shown in FIG. 40, a cam base body 251 is formed from two cylinder type base bodies 351, 352. More particularly, an inserting shaft portion 351a of the cylinder type base body 351 is inserted into a cylinder type base body 352 and an eccentric pin 74 is inserted through a hole portion 352a of the cylinder type base body 352 to fix to a pin hole of the inserting shaft portion 351a so that these cylinder type base bodies 351, 352 are combined together. In addition, as already stated above, the first and second cam groove 40, 41 are formed by the one cam planes 40a, 41a and the other cam planes 40b, 41b of the cam frame 252, 253.

Meanwhile, a pin receiving umbo 252e is projectingly formed toward the inner portion on the cam frame 252 of the cam for zooming 25 so as to slide in a long hole 351c of the cylinder type base body 351. The cam frame 252, 253 and the cam base body 251 are pressed in one direction by pressing the pin receiving umbo 252e with the cam pressing pin 94.

As shown in FIG. 37, the cam pressing pin 94 is inserted through a hole 27c of a front fixing frame 27 and its tip is contacted to the pin receiving umbo 252e. Pressing force is given to the cam pressing pin 94 by a cam spring 95 provided in the above hole 27c. The cam pressing pin 94 and the cam spring 95 are prevented to come off with a plate extended from the flash part 81.

In the cam for zooming 25, the cam frame 253 rotates together with the cylinder type base body 352 by fitting a protruded portion of a key provided in it to a key groove 352b.

Also provided is the cam frame 252 with an interlocking gear 75 which is driven through a rate reducing device 44 with a motor.

The rate reducing device 44 of the driving mechanism for zooming 90 is, as shown in FIG. 41, comprises a front gear group and a rear gear group. The front gear group comprises a gear 44b a large diameter gear portion of which is engaged with a pinion 44a of the motor for zooming 26 and a gear 44c which is engaged with a small diameter gear portion of the gear 44b. In addition, a gear 44c is provided at the front end of a rotational axis rod 44d through which the rear gear group is interlocked.

The rear gear group comprises a gear 44e provided at the rear end of the rotational axis rod 44d, a gear 44f a large diameter gear portion of which engages the gear 44e, and a gear 44g a large diameter gear portion of which engages a small diameter gear portion of the gear 44f. An interlocking gear 75 of the cam frame 253 engages the small diameter gear portion of the gear 44g.

Since gear groups comprises the front gear group and the rear gear group, a place for the rate reducing gear is divided into two, the rate reducing device 44 can be fit with the photographic lens diameter so as to be appropriate for making a thin optical system absorption part 61.

To explain more particularly, in order to secure an enough rate reducing ratio for disposing a whole reducing gears in one place, a rate reducing gear group needs to be extendedly disposed in a direction of zooming of the mechanism for zooming, which leads to a long mechanism for zooming to prevent miniaturization.

Also in order to secure an enough rate reducing ratio without changing a length, the gear needs to be big in diameter so that a rate reducing device fit to a diameter of the lens can not be realized, which result in preventing miniaturization.

FIG. 11 is an exploded perspective view of an image capturing unit 96. The image capturing unit 96 comprises a holder 354, a mask 353, a filter (LPF) 352, a rubber 351, a CCD 320, a plate 355 and a circuit board 358. More particularly, the image capturing unit 96 is configured in such a manner that the mask 353, the filter 352, the rubber 351 and the CCD are disposed between the holder 354 and the plate 355, the holder 354 is fixed to the plate with a small screw 356 to form one unit, after that the CCD 320 is electrically connected to the circuit board 358, and the circuit board 358 is fixed.

The image capturing unit 96 made in this way is fixed to the rear fixing frame 28 of the driving mechanism for zooming 90 as shown in FIG. 42, 43.

More particularly, the rear fixing frame 28 has a standard plane 28b and a fixing prong 28c and leaf springs 105, 106 which hold the image capturing unit 96 are attached to the rear fixing frame 28.

The standard plane 28b is formed on a fixing frame portion of an image focus location peripheral of photographic lenses (the first, second and third lens groups). The leaf springs 105, 106 can also be provided on the front case 71.

Therefore, when flange portions of the plate 355 are inserted between the standard plane 258b and the leaf springs 105, 106, the one fixing prong 28c plunges in a fixing hole 102a of the plate 355 and the other fixing prong 28c catches a fixing groove 102b of the plate 355 so that the image capturing unit 96 is fixed by the extended flange portion of the plate 355 pressing the standard plane 28b with the elastic pressure of the two leaf springs 105, 106.

Though FIG. 42, 43 shows a state in which the circuit board 358 is taken off, the image capturing unit 96 is actually attached as shown in FIG. 44.

A photographing unit 96 is fixed by holding elastically with the leaf plates 105, 106 so that distortion due to fixing with a screw to a fixing frame does not generate. Therefore, the CCD 101 (the image capturing element) can be attached without affecting mechanically or optically the driving mechanism for zooming.

When the CCD 101 is positioned by plunging one fixing prong 28c of the rear fixing frame 28 in a fixing hole 102a of the plate 355 and fitting the other fixing prong 28c in a fixing groove 102b of the plate 355, it can be fixed appropriately, coping with fluctuation of parts and assembling since the fixing groove 102b which catches the other fixing prong 28c is formed as a cut groove.

Further, the photographing unit 96 is configured as such that a mask 353, a filter 352, a rubber 351 and a CCD 320 are held by fixing a holder 354 together with a plate 355 with screws. Therefore, these members are tightly contacted each other with elasticity of the rubber 351 so that dust invading in a light acceptance surface of the CCD 320 can be perfectly prevented.

As a result, the photographing unit 96 is easily stored in control and easily treated in case of assembly.

According to this embodiment an image capturing apparatus is proposed, which comprises an image capturing element, a holding member which holds the image capturing element, a fixing frame having a standard plane to position the holding member, an elastic member disposed on the fixing frame, wherein the image capturing element is positioned to the fixing frame by pressing the holding member on the standard plane with the elastic member.

In this image capturing apparatus, the holding member of the image capturing element is pressed with elasticity of the elastic member and the holding member contacts the standard plane by receiving its pressing force. As a result, the holding member of the image capturing element is sandwiched and held with the standard plane and the elastic member so that the image capturing element is rightly attached to a light acceptance position of the photographic lens.

According to this embodiment, in the above described image capturing apparatus, an image capturing apparatus is proposed, which further comprises a holder, a mask, a filter having an optical property of LPF and a rubber having elasticity wherein the image capturing element is held with the holding member by pinching the image capturing element, the rubber, the filter and the mask with the holding member and the holder.

In this image capturing apparatus, as the image capturing element is held with the rubber, the image capturing element, the filter and the mask are tightly contacted so that dust invasion to the light acceptance surface is prevented.

According to this embodiment, in the above described image capturing apparatus, an image capturing apparatus is proposed, which further comprises a circuit board which performs electrical connection with the image capturing element wherein the circuit board is combined with the holding member by disposing the circuit board in the rear of the holding member and soldering the circuit board to the image capturing element.

The image capturing apparatus is attached with a circuit board so as to become an image capturing unit.

According to this embodiment, in any one of the above described image capturing apparatuses, an image capturing apparatus is proposed, which further comprises flange portions provided at both ends of the holding member, each flange portion having a fixing hole for positioning, and a fixing prong corresponding to the fixing hole provided in the vicinity of the standard plane, wherein the elastic member is a leaf spring provided corresponding to the fixing prong and the image capturing element is positioned and fixed on the fixing frame by fixing the fixing prong to the fixing hole and by pressing and fixing the flanged portion with the leaf spring.

The image capturing element of the image capturing apparatus of this embodiment is positioned by plunging the fixing prong provided on the fixing frame to the fixing hole provided on the extended flange portion of the holding member and the extended flange portion is fixed by pressing the leaf springs.

According to this embodiment a camera is proposed, which comprises a photographic lens, a frame part which holds the photographic lens, an image capturing element, a holding member which holds the image capturing element, a fixing frame disposed at the rear end portion of the frame part having a standard plane on which the holding member is positioned, and the elastic member disposed on the fixing frame, wherein the image capturing element is positioned and fixed on the fixing frame by pressing the holding member on the standard plane with the elastic member.

The camera of this embodiment have no mechanical or optical problem which arises by fixing with screw, because the holding member of the image capturing element is not fixed with screw.

According to this embodiment, in the above described camera, a camera is proposed, which further comprises a holder, a mask, a filter having an optical property of LPF and a rubber having elasticity wherein the image capturing element is held with the holding member by pinching the image capturing element, the rubber, the filter and the mask with the holding member and the holder.

According to this embodiment, in the above described camera, a camera is proposed, which further comprises a circuit board which performs electrical connection with the image capturing element wherein the circuit board is combined with the holding member by disposing the circuit board in the rear of the holding member and soldering the circuit board to the image capturing element.

According to this embodiment, in any one of the above described camera, a camera is proposed, which further comprises flange portions provided at both ends of the holding member, each flange portion having a fixing hole for positioning, and a fixing prong corresponding to the fixing hole provided in the vicinity of the standard plane, wherein the elastic member is a leaf spring provided corresponding to the fixing prong and the image capturing element is positioned and fixed on the fixing frame by fixing the fixing prong to the fixing hole and by pressing and fixing the flanged portion with the leaf spring.

As described above, since an image capturing apparatus or a camera of this embodiment is configured in such a manner that a pressing force of the elastic member is given to the holding member of the image capturing element to press the holding member to the standard plane with the pressing force, the image capturing element is fixed by pinching the holding member with the standard plane and the elastic member.

As a result, the image capturing element can be fixed without mechanically or optically affecting the optical unit.

What is claimed is:

1. In an electronic camera comprising an operation unit having a display unit and an image capturing unit provided with a flash unit and a photographic zoom lens, the image capturing unit connected rotatably by a hinge mechanism and transmitting an image signal to the display unit, an image capturing apparatus which is characterized in that an outer diameter of the lens is defined to a thickness of the display unit disposed on the operation unit, a memory, a battery and a control circuit board, a casing is supported on a lens frame through which a guide shaft is pierced so as to move the lens back and forth, and a cam for moving the zoom lens is disposed at the side of a lens system so that camera is made thinner.

2. An image capturing apparatus according to claim 1, wherein the image capturing unit is provided with a flash unit on the side of the operation unit of a photographic window, the low part of the accepting portion of the flash unit is made thinner than the side of said photographic window, the display unit of the operation unit is disposed on the side of the image capturing unit and operating buttons are disposed on the opposite side of the image capturing unit of the display unit.

3. An image capturing apparatus according to claim 1, wherein a thickness of the image capturing unit along a direction of lens optical axis at the portion where the flash unit is disposed is approximately a thickness of a finger, and a distance between the side end of the photographic window and the side end of the portion where the flash unit is disposed is a distance between a tip of a finger and near a second arthrosis of the finger so as to be able to rotate by holding a flared portion with two fingers.

4. An image capturing apparatus according to claim 1, wherein a distance between a side of the photographic window and the center of rotation of the hinge mechanism in the image capturing unit is such that visibility of the display unit is not hindered by the portion where the flash unit is disposed when the side of the photographic window of the image capturing unit is rotated to the side of the display unit.

5. An image capturing apparatus according to claim 1, wherein the image capturing unit comprises an optical system unit having a lens barrelless lens mechanism part with a zoom lens and a focus lens and a driving mechanism part in which a zoom lens driving mechanism and a focus lens driving mechanism are built integrally, and an optical system installed part in which the optical system unit is installed by shielding light, wherein the operation unit and the image capturing unit are formed as thin box-like bodies of the approximately same thickness.

6. An image capturing apparatus according to claim 1, wherein the image capturing unit comprises an optical system unit having a lens barrel less lens mechanism part with a zoom lens and a focus lens and a driving mechanism part in which a zoom lens driving mechanism and a focus lens driving mechanism are built integrally, and an optical system installed part in which the optical system unit is installed by shielding light wherein a circuit board is disposed adjacently to a side of the optical system unit and a main condenser is disposed adjacently to a back of the optical system unit.

7. An image capturing apparatus according to claim 1, wherein the image capturing unit comprises an optical system unit having a lens mechanism unit with a zoom lens and a focus lens and a driving mechanism unit in which a zoom lens driving mechanism and a focus lens driving mechanism are built integrally, the optical system unit being provided with a lens frame of the zoom lens, a lens frame of the focus lens and a guide shaft, wherein the guide shaft guides both of the lens frame of the zoom lens and the lens frame of the focus lens.

8. An image capturing apparatus according to claim 1, wherein the image capturing unit comprises an image capturing element, a holding member which holds the image capturing element, a fixing frame having a standard plane to position the holding member and an elastic member disposed on the fixing frame wherein the image capturing element is positioned and fixed on the fixing frame by pressing the holding member on to the standard plane with the elastic member.

9. An image capturing apparatus according to claim 1, wherein the image capturing unit further comprises an image capturing element, a holding member which holds the image capturing element, a fixing frame having a standard plane to position the holding member, an elastic member disposed on the fixing frame, a holder, a mask, a filter having an optical property of LPF and a rubber having elasticity wherein the image capturing element is held with the holding member by pinching the image capturing element, the rubber, the filter and the mask with the holding member and the holder.

10. An image capturing apparatus according to claim 1, wherein the image capturing unit further comprises an image capturing element, a holding member which holds the image capturing element, a fixing frame having a standard plane to position the holding member, an elastic member disposed on the fixing frame, a holder, a mask, a filter having an optical property of LPF, a rubber having elasticity, flange portions provided at both ends of the holding member, each flange portion having a fixing hole for positioning, and a fixing prong corresponding to the fixing hole provided in the vicinity of the standard plane, wherein the elastic member is a leaf spring provided corresponding to the fixing prong and the image capturing element is positioned and fixed on the fixing frame by fixing the fixing prong to the fixing hole and by pressing and fixing the flanged portion with the leaf spring.

11. In a cam apparatus having first and second spiral cam grooves for moving an object with a cam-driving force which is generated by cam-driving a cam groove inserting member inserted in each cam groove, a cam apparatus comprising:
a cam base body in which sliding portions having a smaller diameter than that of a middle portion of a cylinder are formed at both ends of the cylinder, an approximately vertical plane of a stepped portion between one sliding portion and the middle portion of the cylinder is defined as one cam plane of the first cam groove and an approximately vertical plane of a stepped portion between the other sliding portion and the middle portion of the cylinder is defined as one cam plane of the second cam groove;
a first cam frame having another cam plane confronting the one cam plane of the first cam groove and provided non-rotatably so as to be able to slide on one sliding portion;
a second cam frame having another cam plane confronting the one cam plane of the second cam groove and provided on the other sliding portion non-rotatably so as to be able to slide; and
a forcing device which contacts a cam groove inserting member which is inserted to the cam groove formed by the first and the second cam frames and the cam base body on to the cam plane by pressing the first and the second cam frames.

12. A cam apparatus according to claim 11, further comprising an adjusting mechanism which adjusts a distance between the one side planes of the first and the second cam grooves.

13. A cam apparatus according to claim 11, wherein a slope is provided on at least one cam plane of the one cam plane and the other cam plane, the slope is a slope which gives a cam driving force along a direction of the rotational axis of the cam groove and pushing force along a direction orthogonal to the direction of the rotational axis of the cam groove to the cam groove inserting member.

14. A cam apparatus according to claim 11, wherein a forcing device for fastening to tighten one end of the forcing device to the first cam frame and another end to the second cam frame and a forcing device for pressing the first and the second cam frame to the cam base body along one direction.

15. An optical zoom mechanism comprising:
a zoom lens;
a holding frame which holds the zoom lens;
a rotational axis rod having gears at the both end thereof;
a first group of rate reducing gears which engage the gear at one end of the rotational axis rod;
a second group of rate reducing gears which engage the gear at another end of the rotational axis rod;
a motor which drives the second group of rate reducing gear; and
a cam body driven by the first rate reducing gears,
wherein the zoom lens is driven by inserting a cam groove inserting member provided on the holding frame into a spiral cam groove of the cam body, the cam body comprises one cam body which forms one cam plane and another cam body which forms another cam plane, which is provided non-rotatably so as to be able to slide and which forms another cam plane confronting the one cam plane, and the cam body further comprises a forcing device which contact the cam groove inserting member to the cam plane by pressing one cam body and/or another cam body, whereby zooming is performed by moving the holding frame with the cam body.

16. An optical zoom mechanism according to claim 15, wherein the cam body comprises:
a cam base body having a first spiral cam groove, a second spiral cam groove, a sliding portion having a smaller diameter at both ends of a cylinder, one cam plane of the first cam groove which is provided at a stepped portion between one sliding portion and the middle portion of the cylinder, and one cam plane of the second cam groove which is provided at a stepped portion between another sliding portion and the middle portion of the cylinder;
another cam plane confronting the one cam plane of the first cam groove;
a first cam frame provided non-rotatably so as to be able to slide on the one sliding portion;
another cam plane confronting the one cam plane of the second cam groove;
a second cam frame provided non-rotatably so as to be able to slide on the other sliding portion; and further
a forcing device which contact a cam groove inserting member to the cam plane by pressing the first cam frame and the second cam frame, the cam groove inserting member inserted into two cam grooves which formed with the first cam frame, the second cam frame and the cam base body.
